(19) United States
(12) Patent Application Publication
(10) Pub. No.: US 2026/0217189 A1
(43) Pub. Date: Jul. 30, 2026

(54) SIDE MIRROR ASSEMBLY FOR VEHICLE

(71) Applicant: SL Mirrortech Corporation, Siheung-si (KR)

(72) Inventors: Yonghwan KIM, Siheung-si (KR); Yonghei KIM, Siheung-si (KR); Yeongkook CHO, Siheung-si (KR)

(21) Appl. No.: 19/390,362

(22) Filed: Nov. 14, 2025

(30) Foreign Application Priority Data
Nov. 19, 2024 (KR) 10-2024-0165154
Nov. 19, 2024 (KR) 10-2024-0165184
Dec. 20, 2024 (KR) 10-2024-0192731
Sep. 5, 2025 (KR) 10-2025-0126638
Sep. 5, 2025 (KR) 10-2025-0126642
Sep. 5, 2025 (KR) 10-2025-0126643

(51) Int. Cl. B60R 1/074; B60R 1/12; H02K 7/116; H02K 11/23; H02K 11/35; H02K 11/38; H02P 5/68

(52) U.S. Cl. CPC B60R 1/074; B60R 1/1207; H02K 7/1166; H02K 11/23; H02K 11/35; H02K 11/38; H02P 5/68; H02K 2211/03

(57) ABSTRACT

A side mirror assembly for a vehicle includes: a controller configured to receive power and a control signal from the vehicle; and a control module configured to, in response to the control signal from the controller, drive a first drive unit to fold-rotate about a first rotation axis arranged vertically, or to drive a second drive unit to tilt-rotate about a second rotation axis arranged horizontally. The control module includes a first potentiometer that detects rotation of the first drive unit, a second potentiometer that detects rotation of the second drive unit, and a board on which the first and second potentiometers are mounted. The board supplies, to the first or second drive unit, power or a control signal provided by the controller, and the first and second potentiometers provide measured voltages to the controller.

### CROSS-REFERENCE TO RELATED APPLICATIONS

This application claims priority from Korean Patent Application Nos. 10-2024-0165154 filed on Nov. 19, 2024; 10-2024-0165184 filed on Nov. 19, 2024; 10-2024-0192731 filed on Dec. 20, 2024; 10-2025-0126638 filed on Sep. 5, 2025; 10-2025-0126642 filed on Sep. 5, 2025; and 10-2025-0126643 filed on Sep. 5, 2025. The aforementioned applications are incorporated herein by reference in their entireties.

### BACKGROUND

### 1. Technical Field

The present disclosure relates to a side mirror assembly for a vehicle, and more particularly, to a side mirror assembly for a vehicle with an improved folding and tilting structure of a side mirror.

### 2. Description of the Related Art

In general, an inside mirror is installed within a vehicle so that the driver can more easily perceive the rearward situation of the vehicle, and outside mirrors are installed on both sides of the exterior of the vehicle so that the driver can recognize side and rearward situations of the vehicle. Through a field of view secured by the inside mirror or the outside mirrors, the driver can recognize surrounding vehicles or pedestrians and perform backing, overtaking, and lane changes.

Recently, in order to reduce air resistance while the vehicle is traveling and to decrease the possibility of damage caused by external impact, camera mirrors including cameras are being adopted instead of outside mirrors. Since images of the surroundings of the vehicle acquired by the camera mirrors are displayed on a display device provided inside the vehicle, the driver can easily recognize the surroundings of the vehicle.

Meanwhile, while the vehicle is traveling, the outside mirrors or the camera mirrors are deployed so that the driver can recognize the surroundings of the vehicle. However, when the vehicle is parked or passes through a narrow space, it is necessary to fold the outside mirrors or the camera mirrors toward the respective sides of the vehicle in order to prevent damage thereto and to secure surrounding space around the vehicle. In this case, the driver may rotate the outside mirrors or the camera mirrors manually or by using actuators.

### SUMMARY

An objective of the present disclosure is to provide a side mirror assembly for a vehicle with an improved folding and tilting structure of a side mirror.

The objectives of the present disclosure are not limited to those mentioned above, and other objectives not explicitly stated will be clearly understood by those skilled in the art based on the following description.

According to an aspect of the present disclosure, a side mirror assembly for a vehicle may include a reflection member; a controller configured to receive power and a control signal from the vehicle; and a control module configured to, in response to the control signal from the controller, drive a first drive unit to fold-rotate the reflection member about a first rotation axis arranged vertically, or to drive a second drive unit to tilt-rotate the reflection member about a second rotation axis arranged horizontally. The control module may include a first potentiometer that detects rotation of the first drive unit, a second potentiometer that detects rotation of the second drive unit, and a board on which the first potentiometer and the second potentiometer are mounted. The board may supply, to the first drive unit and the second drive unit, power or a control signal provided by the controller, and the first potentiometer and the second potentiometer may provide measured voltages to the controller.

The board may include: a sequence controller configured to determine a drive sequence of the first drive unit and the second drive unit; a speed controller configured to control a speed of a first motor provided in the first drive unit or a second motor provided in the second drive unit; and a memory configured to store a rotational position of the reflection member based on information provided by the first potentiometer and/or the second potentiometer.

The speed controller may be configured to rotate the reflection member at a slower speed during fine tilting about the first rotation axis from a first position, which is an unfolded position, to a position between the first position and a second position, which is a folded position, compared with a speed at which the speed controller rotates the reflection member from the first position to the second position.

The speed controller may be configured to control a rotation speed associated with folding or unfolding to gradually decrease before completion of folding rotation from the first position, which is the unfolded position, to the second position, which is the folded position, or before completion of unfolding rotation from the second position to the first position.

The sequence controller may be configured to limit tilting rotation about the second rotation axis in a state that the reflection member is at the second position, which is the fully folded position.

The sequence controller may be configured to restore the reflection member from a tilted state to a neutral state with respect to the second rotation axis prior to fold-rotating the reflection member about the first rotation axis to the second position, which is the fully folded position.

Scan information may be obtained by fully rotating the reflection member in one direction among a folding direction and an unfolding direction and subsequently fully rotating the reflection member in an opposite direction while recording time required for said rotation or changes in voltage during said rotation of the reflection member. The scan information may be stored in the memory. Based on the scan information, a first position, which corresponds to a predetermined unfolded position of the reflection member, and a second position, which corresponds to a fully folded position may be stored in the memory.

A reference temperature range and reference electric current value information may be stored in the memory, and in response to a current temperature deviating from the reference temperature range, the speed controller may be configured to variably supply a voltage to the first drive unit or the second drive unit based on a temperature change around the vehicle.

The board may control to selectively supply power to at least one of a blind-spot collision warning (BCW) lamp, a heater for the reflection member, a puddle light, or a turn signal.

According to another aspect of the present disclosure, a side mirror assembly for a vehicle may include a base having a first side connected to the vehicle and including a fixing part at a second side thereof with a folding rotation axis provided at a center of the fixing part; a motor housing including a lower case and an upper case, the motor housing being configured to rotate relative to the fixing part; a tilting-rotation unit configured to rotate relative to the motor housing about a tilting rotation axis provided at a lower side of the motor housing; a motor installation unit including, at a first side thereof, a first drive unit that enables a fold-rotation of the motor housing with respect to the fixing part, and at a second side thereof, a second drive unit that enables a tilt-rotation of the tilting-rotation unit with respect to the motor housing; a control module configured to detect the fold-rotation of the motor housing and/or the tilt-rotation of the tilting-rotation unit and to set respective initial positions for the fold-rotation and/or the tilt-rotation; a mirror housing including a reflection part, the mirror housing accommodating the motor housing therein; and a fixing frame coupled to the mirror housing and the tilting-rotation unit.

The control module may include: a board detachably mounted to the motor installation unit; a first potentiometer that is disposed on the board and detects relative rotation of the motor housing with respect to the fixing part during the fold-rotation via the first drive unit; and a second potentiometer that is disposed on the board and detects relative rotation of the tilting-rotation unit with respect to the motor housing during the tilt-rotation via the second drive unit.

The motor installation unit may include: a first stopper that limits, via the first potentiometer, a first reference range for the fold-rotation; and a second stopper that limits, via the second potentiometer, a second reference range for the tilt-rotation.

The first potentiometer may include: a first gear that detects the fold-rotation when the motor housing rotates relative to the fixing part about the folding rotation axis and transmits the fold-rotation to the first potentiometer; and a first position-setting portion disposed on the first gear and configured to rotate together with the first gear until the first position-setting portion abuts the first stopper.

The first position-setting portion may include: a first rotor arranged to be rotatable about a same rotation axis as the first gear; a first contact portion that protrudes adjacent to a rotation axis of the first rotor and configured to selectively contact the first stopper within the first reference range as the first rotor rotates; first leg portions that extend along an outer circumferential surface of the first rotor on both sides of a cutout formed in the outer circumferential surface and face toward the cutout; and first contact pieces that protrude radially outward from distal ends of the first leg portions to slidably contact a tooth pattern formed on an inner circumferential surface of the first gear.

The first position-setting portion may be configured such that the first gear and the first rotor rotate together until the first contact portion abuts the first stopper, and in response to the first contact portion abutting the first stopper, rotation of the first rotor may be restricted, and only the first gear may continue rotating to a set position, thereby allowing to set the first reference range.

The first stopper may include: a first contact surface configured to be contacted by a first surface of the first contact portion; and a second contact surface configured to be contacted by a second surface of the first contact portion. An interior angle between the first contact surface and the second contact surface may be an acute angle.

A sub gear may be provided on the fixing part to mesh with the first gear and provide an amount of the fold-rotation while rotating relative thereto, and chamfers may be formed at tips of gear teeth of the sub gear in a direction in which the first gear is engaged.

The second potentiometer may include: a second gear that detects the tilt-rotation when the tilting-rotation unit rotates relative to the motor housing about the tilting rotation axis and transmits the tilt-rotation to the second potentiometer; and a second position-setting portion disposed on the second gear and configured to rotate together with the second gear until the second position-setting portion abuts the second stopper.

The second stopper may include: a projection member that protrudes toward a second contact portion along a rotation-axis direction of a second rotor arranged to be rotatable about a same axis as the second gear, the projection member guiding an operating position of a second contact piece that protrudes to contact a second internal gear formed on an inner circumferential surface of the second gear; and a guide member configured to define a second reference range corresponding to a radius of rotation of the second contact portion, as the second contact portion is assembled through the projection member.

The projection member may include: a tip portion arranged convexly toward a center of rotation of the second rotor; a first guide portion configured to guide from the tip portion toward the guide member when the second rotor rotates in a first direction about its central axis; and a second guide portion configured to guide from the tip portion toward the guide member when the second rotor rotates in a second direction.

The aforementioned and other embodiments of the present disclosure provide the following advantages. First, since a mirror and a mirror housing are rotated together in accordance with folding or tilting, the bezel line around the outer edge of the mirror can be minimized. Second, by simplifying the configuration of a first drive unit that folds the mirror housing and a second drive unit that tilts the mirror housing, cost can be reduced. Third, freedom of design can be secured through optimization of components of a drive module and improvement of mirror design. Fourth, during assembly of a control module, a reference position of a first potentiometer or a second potentiometer can be corrected. Fifth, assemblability of the control module can be improved. Sixth, applicability to stopper structures of various shapes and rotation ranges can be facilitated.

It is to be understood that the effects of the present disclosure are not limited to those described above, and other effects of the present disclosure will be apparent from the following description.

### BRIEF DESCRIPTION OF THE DRAWINGS

The above and other aspects and features of the present disclosure will become more apparent by describing exemplary embodiments thereof in detail with reference to the attached drawings, in which:

FIG. 1 is a plan view illustrating a vehicle in which a side mirror assembly for a vehicle according to an embodiment of the present disclosure is mounted;

FIG. 2 is a plan view illustrating a state in which the side mirror assembly is folded in the vehicle illustrated in FIG. 1;

FIG. 3 is a perspective view illustrating the side mirror assembly illustrated in FIG. 2;

FIG. 4 shows perspective views illustrating a state in which the side mirror assembly illustrated in FIG. 3 is folded;

FIG. 5 shows perspective views illustrating a state in which the side mirror assembly illustrated in FIG. 3 is tilted;

FIGS. 6 and 7 are exploded perspective views illustrating the side mirror assembly illustrated in FIG. 3 in a disassembled state;

FIG. 8 is a cross-sectional view illustrating the internal structure of the side mirror assembly illustrated in FIG. 3;

FIG. 9 is a perspective view illustrating a drive device for a side mirror assembly for a vehicle according to a first embodiment of the present disclosure;

FIG. 10 is an exploded perspective view illustrating the drive device illustrated in FIG. 9 in a disassembled state;

FIGS. 11 and 12 are perspective views illustrating a state in which a motor housing of the drive device illustrated in FIG. 10 is removed;

FIG. 13 is a reference view illustrating a coupled position of a tilting-rotation unit of the drive device illustrated in FIG. 10;

FIG. 14 shows reference views illustrating a process in which the tilting-rotation unit of the drive device illustrated in FIG. 10 is tilted;

FIGS. 15 and 16 are reference views illustrating a folding or tilting state of the drive device illustrated in FIG. 10;

FIG. 17 is a perspective view illustrating a drive device for a side mirror assembly for a vehicle according to a second embodiment of the present disclosure;

FIG. 18 is an exploded perspective view illustrating the drive device illustrated in FIG. 17 in a disassembled state;

FIG. 19 is a longitudinal cross-sectional view illustrating the drive device illustrated in FIG. 17;

FIGS. 20 and 21 are perspective views illustrating a state in which a tilting-rotation unit of the drive device illustrated in FIG. 17 rotates;

FIG. 22 is a perspective side view illustrating a state in which the tilting-rotation unit rotates with respect to a motor housing of the drive device illustrated in FIG. 17;

FIG. 23 is a reference view illustrating a coupled state between a lower case and the tilting-rotation unit at a second support of the drive device illustrated in FIG. 17;

FIG. 24 is a reference view illustrating a state in which an upper case of the drive device illustrated in FIG. 17 is removed;

FIG. 25 is an exploded perspective view illustrating a first drive unit and a second drive unit of the drive device illustrated in FIG. 24;

FIG. 26 is an enlarged perspective view illustrating the first drive unit of the drive device illustrated in FIG. 24;

FIG. 27 is an enlarged perspective view illustrating the second drive unit of the drive device illustrated in FIG. 25;

FIG. 28 is a perspective view illustrating a drive device for a side mirror assembly for a vehicle according to a third embodiment of the present disclosure.

FIG. 29 is an exploded perspective view illustrating the drive device illustrated in FIG. 28 in a disassembled state;

FIG. 30 is a longitudinal cross-sectional view illustrating an A-A′ section of the drive device illustrated in FIG. 28;

FIGS. 31 and 32 are longitudinal cross-sectional views illustrating a B-B′ section of the drive device illustrated in FIG. 28;

FIG. 33 is a perspective side view illustrating a state in which a tilting-rotation unit rotates with respect to a motor housing of the drive device illustrated in FIG. 28;

FIG. 34 is a reference view illustrating a coupled state between a lower case and the tilting-rotation unit at a second support of the drive device illustrated in FIG. 28;

FIG. 35 is a reference view illustrating a state in which an upper case of the drive device illustrated in FIG. 28 is removed;

FIG. 36 is an exploded perspective view illustrating a first drive unit and a second drive unit of the drive device illustrated in FIG. 35;

FIG. 37 is an enlarged perspective view illustrating the first drive unit of the drive device illustrated in FIG. 36;

FIG. 38 is an enlarged perspective view illustrating the second drive unit of the drive device illustrated in FIG. 36;

FIG. 39 is a perspective view illustrating a coupled state between a sub gear and a driven gear of the drive device illustrated in FIG. 36;

FIG. 40 is a perspective view illustrating another embodiment of a lower case and a driven gear of the drive device illustrated in FIG. 29;

FIG. 41 is a partially cutaway perspective view illustrating the lower case and the driven gear of the drive device illustrated in FIG. 40;

FIG. 42 is a cross-sectional perspective view illustrating a transverse section of the drive device illustrated in FIG. 28;

FIG. 43 is a cross-sectional view illustrating a C-C′ section of the drive device illustrated in FIG. 42;

FIG. 44 is a reference view illustrating a first potentiometer of the drive device illustrated in FIG. 42;

FIG. 45 is a reference view illustrating a process in which the first potentiometer of the drive device illustrated in FIG. 44 senses an initial position;

FIG. 46 is a reference view illustrating a state before a second potentiometer and a second stopper of the drive device illustrated in FIG. 41 are assembled;

FIG. 47 is a reference view illustrating a process in which the second potentiometer illustrated in FIG. 46 senses an initial position;

FIG. 48 shows reference views illustrating exemplary side mirror assemblies according to the present disclosure;

FIG. 49 is an exploded perspective view illustrating a drive device for a side mirror assembly for a vehicle according to a fourth embodiment of the present disclosure in a disassembled state;

FIG. 50 is a longitudinal cross-sectional view illustrating the drive device illustrated in FIG. 49;

FIG. 51 is a reference view illustrating a coupled state between a lower case and a tilting-rotation unit at a second support of the drive device illustrated in FIG. 49;

FIG. 52 is a reference view illustrating a state in which an upper case of the drive device illustrated in FIG. 49 is removed;

FIG. 53 is an exploded perspective view illustrating a first drive unit and a second drive unit of the drive device illustrated in FIG. 52;

FIGS. 54 and 55 are exploded perspective views illustrating a clutch unit of the drive device illustrated in FIG. 53;

FIG. 56 is a front view illustrating the clutch unit of the drive device illustrated in FIG. 54 as viewed from the front;

FIGS. 57 and 58 are reference views illustrating a state in which the clutch unit of the drive device illustrated in FIG. 54 operates;

FIG. 59 is a perspective view illustrating a drive device for a frameless mirror assembly for a vehicle according to a fifth embodiment of the present disclosure;

FIG. 60 is an exploded perspective view illustrating the drive device illustrated in FIG. 59 in a disassembled state;

FIG. 61 is a reference view illustrating a state in which an upper case of the drive device illustrated in FIG. 59 is removed;

FIG. 62 is an exploded perspective view illustrating a first drive unit and a second drive unit of the drive device illustrated in FIG. 61;

FIG. 63 is a block diagram illustrating a control device for a frameless mirror assembly for a vehicle according to an embodiment of the present disclosure;

FIG. 64 is a block diagram illustrating the configuration of a control module of the control device illustrated in FIG. 63;

FIG. 65 is a reference view illustrating a first rotation axis and a second rotation axis of a frameless mirror of FIG. 3;

FIG. 66 is a reference view illustrating a frameless mirror switch provided on a driver's side door of a vehicle;

FIG. 67 shows graphs illustrating a difference in rotation time according to folding or fine tilting about the first rotation axis through the control device illustrated in FIG. 63;

FIG. 68 shows reference views illustrating a state in which the frameless mirror rotates to an unfolded or folded state through the control device of FIG. 65;

FIG. 69 shows reference views illustrating a stopper of FIG. 62 that limits rotation of the frameless mirror in a folding or unfolding direction; and

FIG. 70 is a block diagram illustrating a control device for a side mirror assembly for a vehicle, according to an embodiment of the present disclosure.

### DETAILED DESCRIPTION

The present disclosure can encompass various modifications and may have various embodiments, and specific embodiments will be illustrated in the drawings and described below.

However, this is not intended to limit the present disclosure to the particular forms disclosed, and it is to be understood that the present disclosure includes all modifications, equivalents, and alternatives within the spirit and scope of the present disclosure.

Terms including ordinals such as first and second may be used to describe various elements, but the elements are not limited by the terms. The terms are used only to distinguish one element from another. For example, without departing from the scope of the present disclosure, a second element may be referred to as a first element, and similarly the first element may be referred to as the second element.

The term “and/or” includes a combination of a plurality of listed items or any of the plurality of listed items.

When an element is referred to as being “connected to” or “coupled to” another element, it may be directly connected or coupled to the other element, but it is to be understood that another element may be present in between. In contrast, when an element is referred to as being “directly connected to” or “directly coupled to” another element, it is to be understood that there is no other element present in between.

The terms used in this specification are used merely to describe specific embodiments and are not intended to limit the present disclosure.

Singular expressions include plural expressions unless the context clearly indicates otherwise.

In this application, terms such as “include” or “have” are intended to specify the presence of features, numbers, steps, operations, elements, components, or combinations thereof described in the specification, and are not intended to preclude the possibility of the presence or addition of one or more other features, numbers, steps, operations, elements, components, or combinations thereof.

Hereinafter, embodiments will be described in detail with reference to the accompanying drawings. Like reference numerals denote like or corresponding components, and repeated descriptions will be omitted.

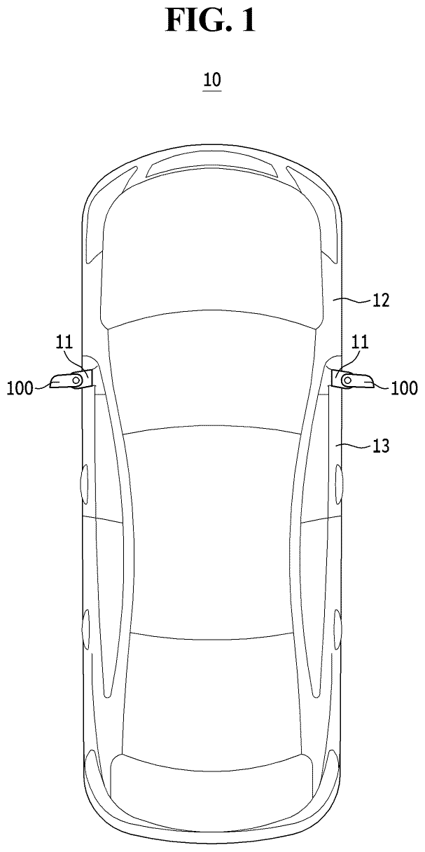

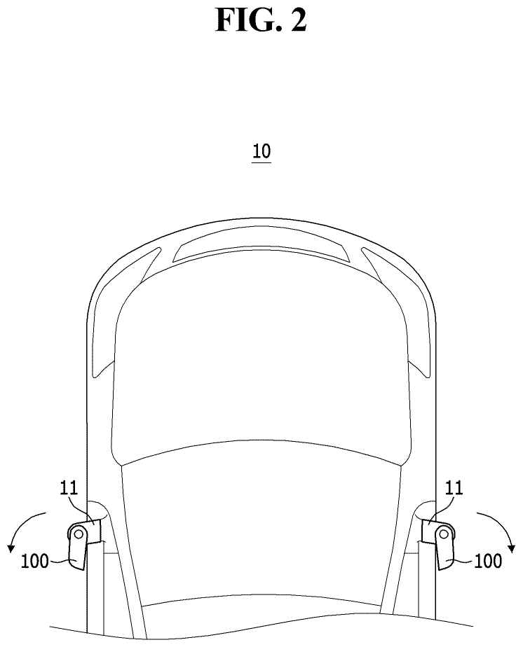

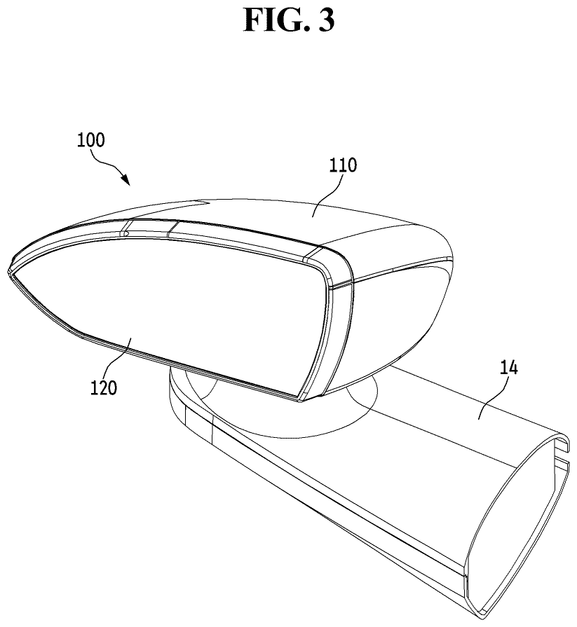

FIG. 1 is a plan view illustrating a vehicle in which a side mirror assembly for a vehicle according to an embodiment of the present disclosure is mounted, FIG. 2 is a plan view illustrating a state in which the side mirror assembly is folded in the vehicle illustrated in FIG. 1, and FIG. 3 is a perspective view illustrating the side mirror assembly illustrated in FIG. 2.

Referring to FIGS. 1 to 3, a side mirror assembly 100 for a vehicle 10 according to an embodiment of the present disclosure may correspond to part of a side mirror installed on an exterior of the vehicle 10.

The side mirror assembly 100 may allow a driver to more easily check the field of view of a side or the rear of the vehicle 10 being reflected by a reflection part 120 provided in a mirror housing 110.

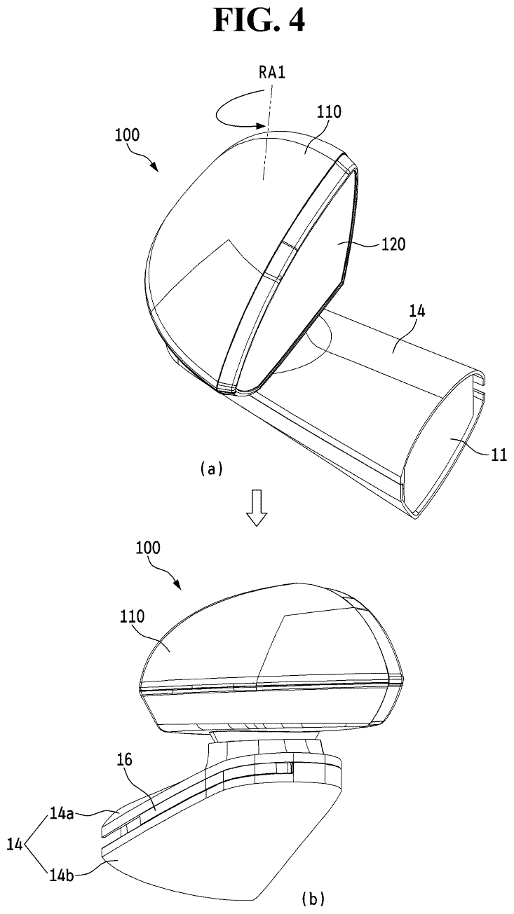

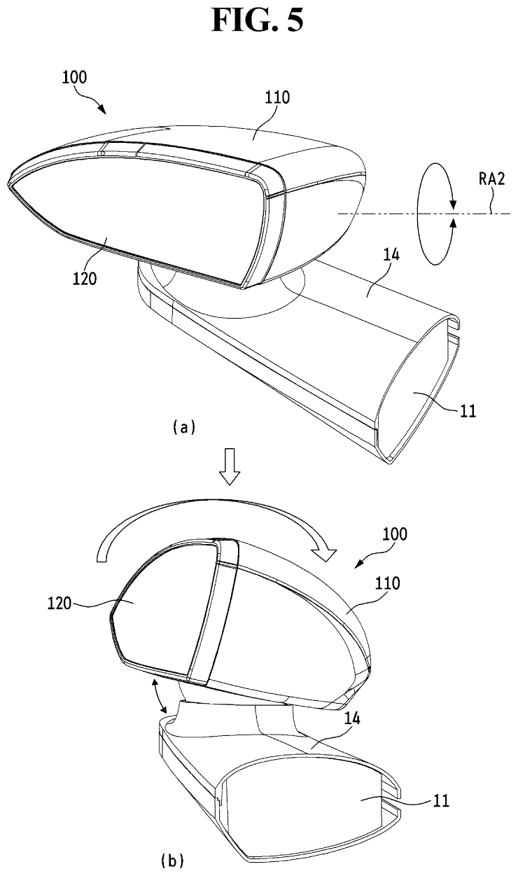

A base 11 may be provided on both side of the vehicle 10, and a base cover 14 that covers the exterior of the base 11 may be coupled to the base 11. The mirror housing 110 of the side mirror assembly 100 may rotate about a first rotation axis RA1 (see FIG. 4), which is arranged vertically on the base 11, to perform folding, or may rotate about a second rotation axis RA2 (see FIG. 5), which is arranged horizontally, to perform tilting.

A drive device 200 to be described later may be provided inside the side mirror assembly 100 to supply a driving force for folding rotation or tilting rotation of the side mirror assembly 100 with respect to the base 11.

The base 11 may be arranged on the body or a door of the vehicle 10 and may support relative rotation of the mirror housing 110. The base 11 may be formed of a metal or a synthetic resin material so as to firmly support the side mirror assembly 100, and the exterior of the base 11 may be provided with the base cover 14 that surrounds the base 11.

In addition, the side mirror assembly 100 may generate a driving force through the drive device 200 to enable rotation of the mirror housing 110 relative to the base 11. The side mirror drive device 200 may be provided on the base 11 or in the mirror housing 110. In this embodiment, by way of example, the side mirror drive device 200 is provided in the mirror housing 110.

FIG. 4 shows perspective views illustrating a state in which the side mirror assembly illustrated in FIG. 3 is folded. Referring to FIG. 4, the mirror housing 110 may be folded or unfolded with respect to the base 11.

The mirror housing 110 being folded may mean that, as illustrated in panel (a) of FIG. 4, the mirror housing 110 is folded while rotating about the first rotation axis RA1 so that an outer distal end of the mirror housing 110 or the reflection part 120 approaches a body 12 or a door 13 of the vehicle 10. For example, when the mirror housing 110 is folded, the overall width of the vehicle 10 may be decreased, so the side space of the vehicle 10 may be secured to allow parking to be completed or allow the vehicle 10 to pass through a narrow roadway.

The mirror housing 110 being unfolded may mean that, as illustrated in panel (b) of FIG. 4, the mirror housing 110 is unfolded while rotating so that the outer distal end of the mirror housing 110 or the reflection part 120 moves away from the body 12 or the door 13 of the vehicle 10. That is, during ordinary operation of the vehicle 10, the mirror housing 110 is unfolded to provide the driver with a reflected field of view of the side and rear of the vehicle 10.

The base cover 14 may include a first cover 14a arranged on the upper side of the base cover 14 and a second cover 14b coupled on a side opposite to the first cover 14a with respect to the base 11. The first and second covers 14a and 14b may be coupled to each other so as to surround the base 11.

In a region where the first and second covers 14a and 14b face each other, in some embodiments, a lamp part 16 may be provided that is formed over a predetermined range on the front or a side of the base cover 14 and is selectively turned on. For example, the lamp part 16 may provide a side repeater function. The lamp part 16 may also be provided at the rear of the base cover 14, may be mounted to a lower housing 111 or an upper housing 112, and may be mounted in a coupling region between the lower housing 111 and the upper housing 112. In addition, an imaging device (e.g., a camera) for photographing the surroundings of the vehicle 10 may be mounted to the base cover 14. For example, when the base cover 14 is provided with the camera, the camera may be mounted below the second cover 14b.

FIG. 5 shows perspective views illustrating a state in which the side mirror assembly illustrated in FIG. 3 is tilted. Referring to FIG. 5, the mirror housing 110 may be tilted within a predetermined angular range with respect to the base 11.

The mirror housing 110 being tilted may mean that the mirror housing 110 rotates about the second rotation axis RA2, which is arranged in a horizontal direction, from the state illustrated in panel (a) of FIG. 5 to the state illustrated in panel (b) of FIG. 5, thereby adjusting a vertical field-of-view angle. For example, tilting rotation may be performed so that upward or downward tilting of the mirror housing 110 facilitates securing a side and rear field of view according to the driver's seated eye level, or downward tilting may be performed automatically or selectively during parking or backing to facilitate checking the curb or a parking line on a parking-lot floor surface.

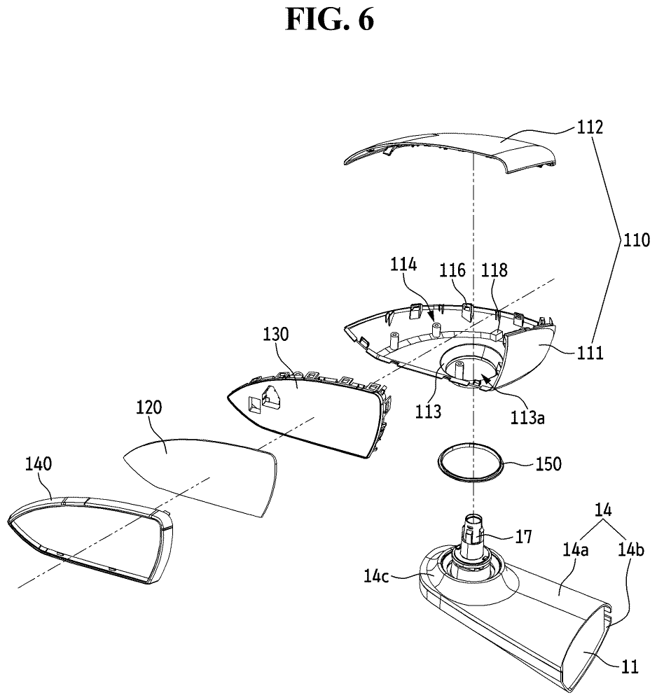

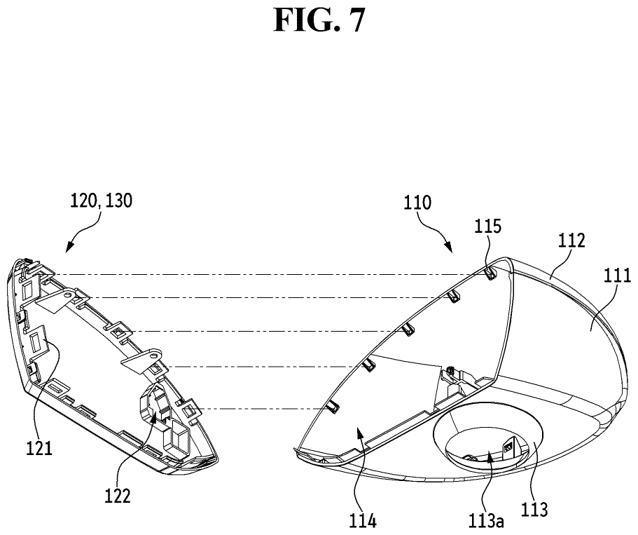

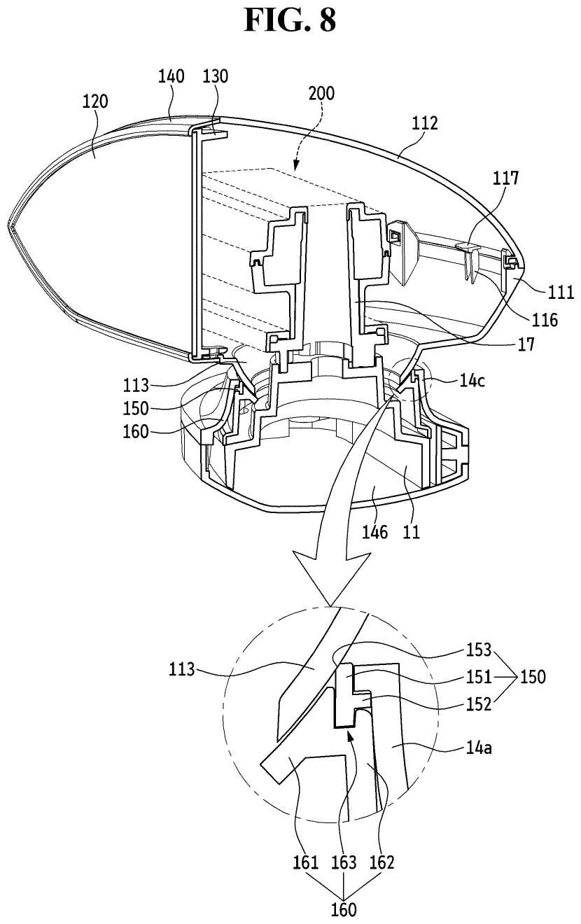

FIGS. 6 and 7 are exploded perspective views illustrating the side mirror assembly illustrated in FIG. 3 in a disassembled state, and FIG. 8 is a sectional view illustrating the internal structure of the side mirror assembly illustrated in FIG. 3.

Referring to FIGS. 6 to 8, the side mirror assembly 100 may include a mirror housing 110, a reflection part 120, a back plate 130, a bezel 140, and a drive device 200.

A base 11 may be formed of a metal, and a fixing unit 17 may be provided on the other side (e.g., outer side or distal side) of the base 11 so that the side mirror assembly 100 may be coupled. The fixing unit 17 may be fastened at the other end of the base 11 by three-point bolting, or may be formed integrally with the base 11.

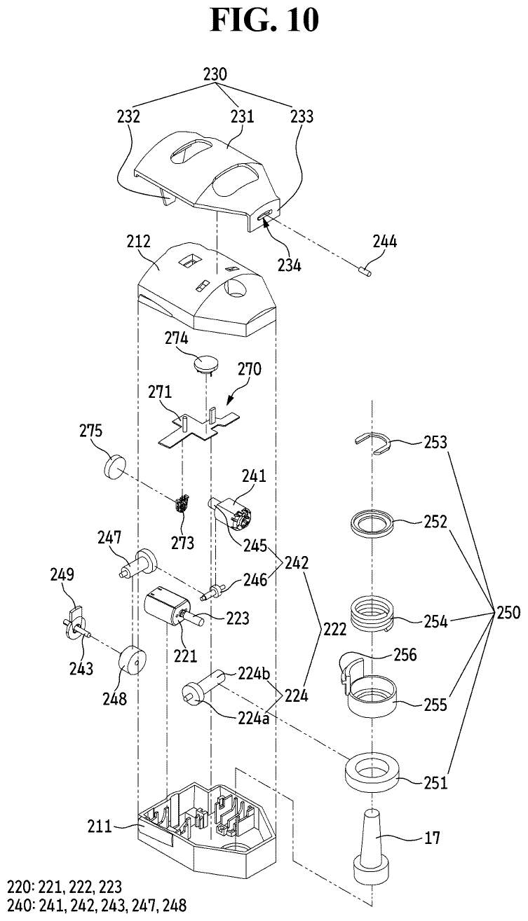

A fixing module 250 (see FIG. 10) of the drive device 200 may be coupled to the fixing unit 17, and the mirror housing 110 connected to the fixing module 250 may rotate about the first rotation axis RA1, formed at the center of the fixing unit 17.

The mirror housing 110 may include a lower housing 111 and an upper housing 112.

The lower housing 111 may be arranged so as to be rotatable relative to the fixing unit 17, which is fixed to the end of the base 11. An insertion portion 14c may be provided on one of the first cover 14a of the base cover 14 and the lower housing 111, and a connection portion 113 may be provided on the other. A through-hole 113a may be formed at the center of the connection portion 113 so that the fixing unit 17 may be inserted.

The insertion portion 14c may be formed integrally with the first cover 14a. Alternatively, the insertion portion 14c may be configured as a separate part attachable to or detachable from the first cover 14a and may be assembled in a coupling structure.

The first and second covers 14a and 14b are illustrated, by way of example, as being positioned above and below each other, but alternatively, may be arranged in a front-rear (or left-right) direction with respect to FIG. 6 to be assembled together. When the first and second covers 14a and 14b are arranged in the front-rear direction, half shapes of the insertion portion 14c may be provided in the first and second covers 14a and 14b, respectively, so that one insertion portion 14c is formed upon assembly, or one complete insertion portion 14c may be formed on either the first cover 14a or the second cover 14b.

The connection portion 113 may be formed on the lower housing 111 to protrude toward the insertion portion 14c formed on the first cover 14a.

The insertion portion 14c may be formed at a distal end of the first cover 14a to allow at least part of the connection portion 113 formed on the lower housing 111 to be inserted. The insertion portion 14c and the connection portion 113 may be arranged to face each other, and at least the outer circumferential surface of the connection portion 113 may be formed as a first curved surface corresponding to the folding or tilting radius of the mirror housing 110.

A first sealing member 150 may additionally be provided between the insertion portion 14c and the connection portion 113. The first sealing member 150 may be configured to wrap along an inner circumferential surface of the insertion portion 14c, and may provide sealing between the insertion portion 14c and the connection portion 113. The first sealing member 150 may be coupled inside the insertion portion 14c from the lower side of the first cover 14a in a direction in which the fixing unit 17 projects.

The first sealing member 150 may include a first member 151 and a second member 152. The first member 151 may be arranged such that a corner surface 153 at one end thereof, for example, an upper-left corner surface in FIG. 8, is in close contact with the outer circumferential surface (or the first curved surface) of the connection portion 113, and such that the other surface at the one end thereof (or an upper-right surface) is in contact with the inner circumferential surface of the insertion portion 14c. The first sealing member 150 may be formed of a soft material. For example, the first sealing member 150 may be formed of a soft rubber, silicone, or the like. By contacting the inner circumferential surface of the insertion portion 14c, the first sealing member 150 may block foreign matter such as dust from entering the interior. The second member 152 may protrude from the other side surface of the first member 151 and may be supported on the inner circumferential surface of the insertion portion 14c together with the first member 151.

A second sealing member 160 may additionally be provided below the first sealing member 150 between the insertion portion 14c and the connection portion 113. The second sealing member 160 may include a third member 161 and a fourth member 162. The second sealing member 160 may support the first sealing member 150 from below so that the first sealing member 150 is disposed between the insertion portion 14c and the connection portion 113 or maintains close contact with the connection portion 113.

The second sealing member 160 may be formed of a more rigid material than the first sealing member 150. For example, the second sealing member 160 may be formed as a molded article of rubber or a synthetic material relatively harder than the first sealing member 150.

The third member 161 may be provided inside the first member 151 so as to face the first curved surface, which is the outer circumferential surface of the connection portion 113. The surface of the third member 161 that faces the first curved surface of the connection portion 113 may be formed as a curved surface corresponding to the first curved surface.

The fourth member 162 may extend and be bent from the third member 161 to support the third member 161 from the base 11. In this case, on the upper surface of the fourth member 162 adjacent to the third member 161, a fastening groove 163 may be formed, which allows at least part of the other end of the first member 151 to be inserted thereto.

The fastening groove 163 may be provided along the circumferential direction of the first sealing member 150 on the upper surface of the fourth member 162.

Accordingly, while supporting the first sealing member 150, the second sealing member 160 may prevent the first sealing member 150 from being removed from between the connection portion 113 and the insertion portion 14c.

The first and second sealing members 150 and 160 may be integrally formed by an insert-molding method. In other words, the first and second sealing members 150 and 160 may be integrally formed, and the corner surface 153 of the first sealing member 150, which is a soft component, comes into close contact with the connection portion 113 to block external foreign matter from entering between the connection portion 113 and the base cover 14. When the first and second sealing members 150 and 160 are configured as an integral body, the first sealing member 150 may be arranged to contact the connection portion 113, and the second sealing member 160 may be arranged to be spaced apart by a predetermined distance from the connection portion 113, instead of directly contacting the connection portion 113.

In some embodiments, the first member 151 of the first sealing member 150 and the third member 161 of the second sealing member 160 may each be provided with a first projection that projects toward the outer circumferential surface of the connection portion 113. The first projection may project in one or more ring shapes along the circumferential direction of the first or third member 151 or 161. That is, the first projection may induce line contact between the first curved surface of the connection portion 113 and the first or second sealing member 150 or 160.

Alternatively, the first member 151 of the first sealing member 150 and the third member 161 of the second sealing member 160 may each be provided with second projections that project toward the outer circumferential surface of the connection portion 113. A plurality of second projections may project in a predetermined dot pattern toward the first curved surface of the connection portion 113 so as to support point contact.

The insertion portion 14c and the connection portion 113 may limit relative rotation of the mirror housing 110 within a predetermined angular range. Preferably, a lower portion of the lower housing 111 adjacent to the connection portion 113 may be designed not to contact an upper end of the insertion portion 14c.

In addition, the upper housing 112 may be coupled to cover the upper side of the lower housing 111. A plurality of hooks 117 may be provided at an edge region of the upper housing 112, and engaging portions 116 with which the hooks 117 engage may be provided at an edge region of the lower housing 111, so that the upper housing 112 and the lower housing 111 may be fastened to each other by a snap-fit coupling method. Alternatively, the upper housing 112 and the lower housing 111 may be coupled by a coupling method using projections and grooves or using screws. Accordingly, the drive device 200 of the side mirror assembly 100 may be installed in an internal accommodation space 114 of the mirror housing 110 in a state in which the lower housing 111 and the upper housing 112 are coupled.

At an opening of the mirror housing 110 in a state in which the lower housing 111 and the upper housing 112 are coupled to each other, the back plate 130 and the reflection part 120 may first be coupled to each other and may then be coupled to the mirror housing 110.

A detailed description of the coupling relationship between the lower housing 111 and the base 11 through the drive device 200 of the side mirror assembly 100 will be provided later.

The reflection part 120 may be disposed between the lower housing 111 and the upper housing 112 and may project, toward the driver, light reflected from the side or the rear of the vehicle 10.

The back plate 130 may be disposed inward of the reflection part 120 in the lower housing 111 or the upper housing 112 to closely support the rear surface of the reflection part 120. The back plate 130 may be provided with a plurality of engaging portions 121 to engage with hooks 115 provided along the periphery of an opening defined by the upper housing 112 and the lower housing 111, so that the back plate 130 and the mirror housing 110 may be fastened by a snap-fit coupling method.

The back plate 130 may be formed with a through-hole 122 (see FIG. 7) in which a lighting region is arranged so that, when changing lanes, the region may illuminate depending on distance information of surrounding vehicles to provide assistance to the driver.

The reflection part 120 and the back plate 130 may be attached to each other by double-sided tape. Alternatively, the back plate 130 and the reflection part 120 may be attached to each other by known attachment means other than double-sided tape.

The bezel 140 may closely contact the distal end of the mirror housing 110 while surrounding a front outer edge of the reflection part 120 and an outer edge region of the back plate 130. The bezel 140 may be fastened in a snap-fit coupling method together with the reflection part 120 from the front of the back plate 130.

Accordingly, the mirror housing 110, the reflection part 120, the back plate 130, and the bezel 140 may fold-rotate or tilt-rotate together about the fixing unit 17.

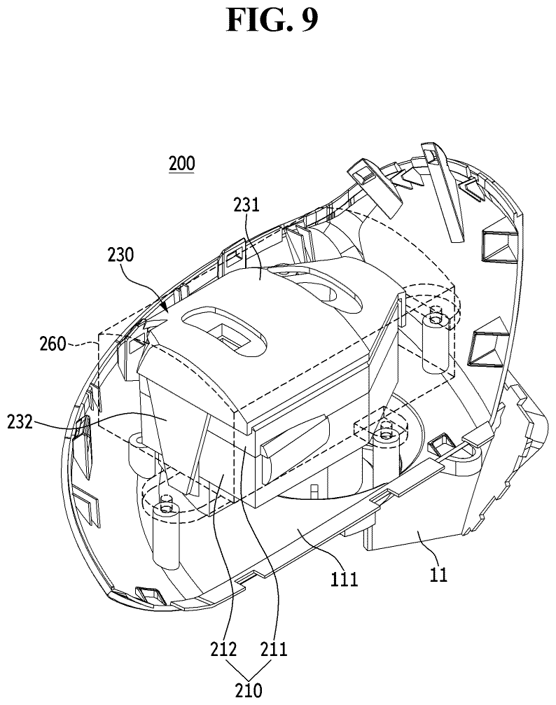

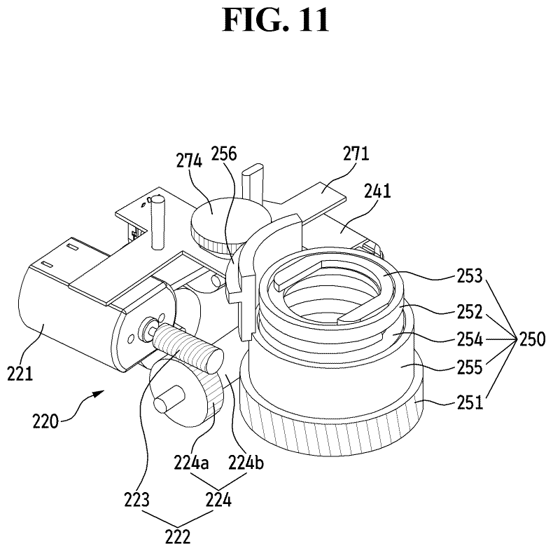

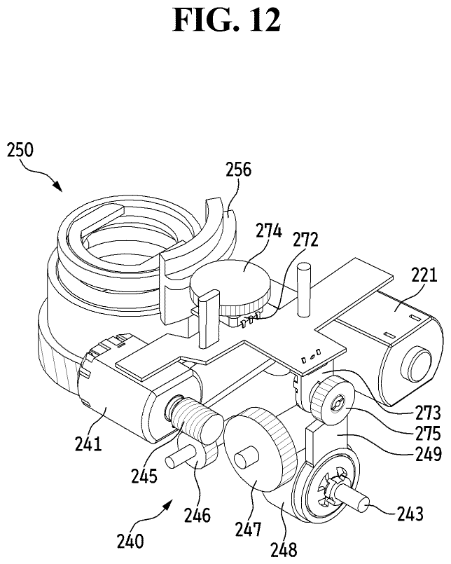

FIG. 9 is a perspective view illustrating a drive device for a side mirror assembly for a vehicle according to a first embodiment of the present disclosure, FIG. 10 is an exploded perspective view illustrating the drive device illustrated in FIG. 9 in a disassembled state, and FIGS. 11 and 12 are perspective views illustrating a state in which a motor housing of the drive device illustrated in FIG. 10 is removed for illustration purposes.

Referring to FIGS. 9 to 12, a side mirror assembly 100 according to the first embodiment of the present disclosure may include a drive device 200 for a vehicle side mirror.

The drive device 200 may include: a motor housing 210 provided inside a mirror housing 110 (see FIG. 6); a first drive unit 220 that participates in folding rotation of the mirror housing 110; a tilting-rotation unit 230; a second drive unit 240 that participates in tilting rotation of the tilting-rotation unit 230; and a fixing module 250 and a control module 270 that are provided on a fixing unit 17.

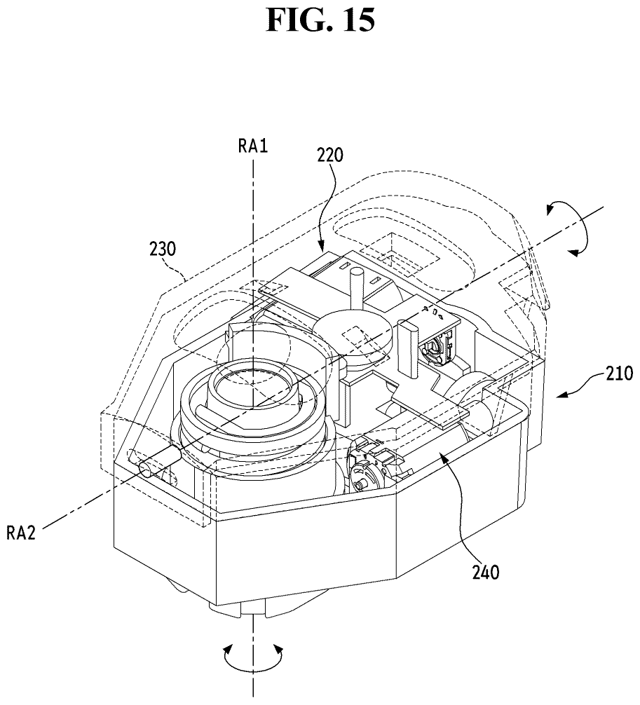

First, the motor housing 210 may include a lower case 211 and an upper case 212. The lower case 211 may be disposed inside the lower housing 111, and as the upper case 212 is coupled to the upper side of the lower case 211, the motor housing 210 may be formed. In this case, although the motor housing 210 is disposed inside the mirror housing 110, it may not be coupled to the mirror housing 110 but only to the fixing unit 17. For example, the first drive unit 220 may actuate the folding rotation of the mirror housing 110 by causing relative rotation of the motor housing 210 with respect to the fixing module 250 about a first rotation axis RA1 formed in the fixing unit 17 (see FIG. 15). The second drive unit 240 may provide relative rotation to the tilting-rotation unit 230 about a second rotation axis RA2 formed between the motor housing 210 and the tilting-rotation unit 230 (see FIG. 5), thereby providing tilting drive of the mirror housing 110.

The first drive unit 220 may include a first motor 221 and a first gear module 222, and may enable rotation via the final output of the first gear module 222 in accordance with rotation of the first motor 221. The first gear module 222 may include a first worm gear 223 and a first reduction gear 224. The first worm gear 223 may be coupled to the rotation shaft of the first motor 221. The first worm gear 223 may transmit the rotational force to the first reduction gear 224. The first reduction gear 224 may mesh with the first worm gear 223, and the rotation shaft of the first reduction gear 224 may be arranged in a direction different from that of the rotation shaft of the first worm gear 223. The first reduction gear 224 may be configured with a plurality of first gears 224a and a second gear 224b that provide a predetermined gear ratio and rotate together. Accordingly, the final output of the first gear module 222 may be delivered to the first reduction gear 224. A driven gear 251 of the fixing module 250 may mesh with the second gear 224b of the first reduction gear 224, and the motor housing 210 may rotate relative to the driven gear 251.

The tilting-rotation unit 230 may include a first cover 231, a second cover 232, and a third cover 233. The first cover 231 may be provided to cover the upper side of the upper case 212. The second cover 232 may extend from one side of the first cover 231 to face one side surface of the lower case 211. The third cover 233 may extend from the other side of the first cover 231 to face one side surface of the upper case 212. In this case, the one side surface of the lower case 211 and the one side surface of the upper case 212 may be arranged in opposite directions with respect to the motor housing 210. The third cover 233 may be formed with a slit 234 that is curved along the radius of rotation of the tilting-rotation unit 230. A portion of the second drive unit 240, to be described later, may be mounted in the slit 234.

The first cover 231 may be coupled to the upper case 212 or to the lower case 211. For example, as illustrated in FIG. 9, the drive device 200 may further include a fixing frame 260 disposed between the tilting-rotation unit 230 and an upper housing 112 to couple the tilting-rotation unit 230 to the mirror housing 110. After a central region of the fixing frame 260 is fastened to the upper side of the first cover 231 and an outer peripheral region of the fixing frame 260 is fastened and fixed to the lower housing 111, the tilting-rotation unit 230 may be arranged to be tiltable with respect to the motor housing 210 together with the mirror housing 110.

The second drive unit 240 may include a second motor 241, a second gear module 242, a first shaft 243, and a second shaft 244. The second gear module 242 may include a second worm gear 245 and a second reduction gear 246. The second worm gear 245 may be coupled to the rotation shaft of the second motor 241. The second worm gear 245 may transmit rotational force to the second reduction gear 246.

The second reduction gear 246 may mesh with the second worm gear 245, and the rotation shaft of the second reduction gear 246 may be arranged in a direction different from that of the rotation shaft of the second worm gear 245. The second reduction gear 246 may be configured with a plurality of gears that provide a predetermined gear ratio and rotate together.

The second drive unit 240 may further include a third reduction gear 247 that meshes with the second reduction gear 246. In this case, the second and third reduction gears 246 and 247 may provide different gear ratios. The third reduction gear 247 may transmit final output to the first shaft 243.

The fixing module 250 may elastically support the motor housing 210 on the fixing unit 17. The fixing module 250 may include the driven gear 251, a clip plate 252, a clip 253, an elastic member 254, and a sub gear 255.

The driven gear 251 may be fastened within the motor housing 210 so that the fixing unit 17 extends into the interior of the driven gear 251. As the driven gear 251 is coupled and fixed to the fixing unit 17, the driven gear 251 does not rotate, but the rotational force transmitted from the first reduction gear 224 to the driven gear 251 may cause the motor housing 210 to rotate relative to the driven gear 251, thereby producing the folding rotation. That is, the driven gear 251 may be fixed with respect to the fixing unit 17, and the first reduction gear 224 may rotate while remaining in mesh with the driven gear 251.

The clip plate 252 may be fixed at a distal end of the fixing unit 17 by the clip 253. The elastic member 254 may provide elastic support between the driven gear 251 and the clip plate 252.

The sub gear 255 may be provided to surround the outer side of the elastic member 254 and may be placed on the driven gear 251 so as to be rotatable with the driven gear 251. Gear teeth may be formed on the outer circumferential surface of the sub gear 255 so as to mesh with a portion of the control module 270, which will be described later, and the state of the folding rotation of the motor housing 210 with respect to the sub gear 255 may be transmitted to the control module 270.

The control module 270 may include a board 271, a first potentiometer 272 that detects rotation of the first drive unit 220, and a second potentiometer 273 that detects rotation of the second drive unit 240.

The first and second potentiometers 272 and 273 may each be mounted on the board 271. Each of the first and second potentiometers 272 and 273 may be implemented by a variable resistor that converts linear displacement or rotational displacement into a change in electrical resistance. The first and second potentiometers 272 and 273 may be configured as contact or non-contact types. In this embodiment, the first and second potentiometers 272 and 273 are described, by way of example, as contact types. In a contact-type potentiometer, a brush moves on a resistive element so that displacement can be measured according to rotation angle or number of rotations.

The first potentiometer 272 may be provided with a first gear 274 arranged to be rotatable on the board 271, and the first gear 274 may mesh with gear teeth 256 of the sub gear 255. Accordingly, the angle of the folding rotation of the motor housing 210 may be sensed based on the rotation angle of the first gear 274 with respect to the gear teeth 256 of the sub gear 255.

The second potentiometer 273 may be provided with a second gear 275 arranged to be rotatable on the board 271, and the second gear 275 may mesh with gear teeth formed on a tilting worm wheel 249. Accordingly, the angle of the tilting-rotation of the tilting-rotation unit 230 may be sensed based on the rotation angle of the second gear 275 in accordance with the rotation of the tilting worm wheel 249 about the first shaft 243.

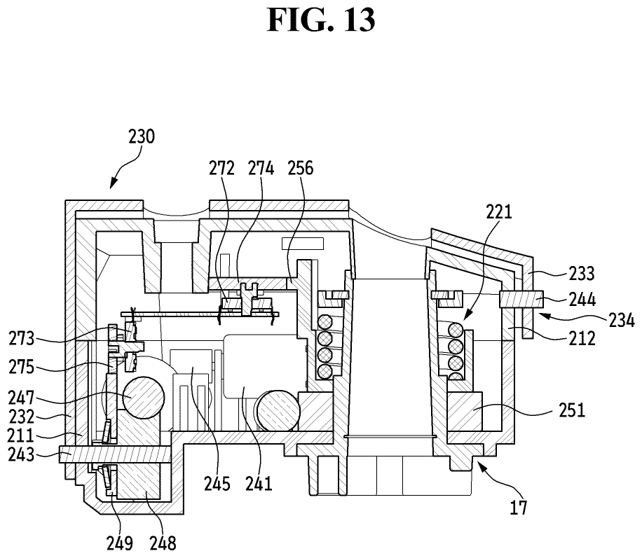

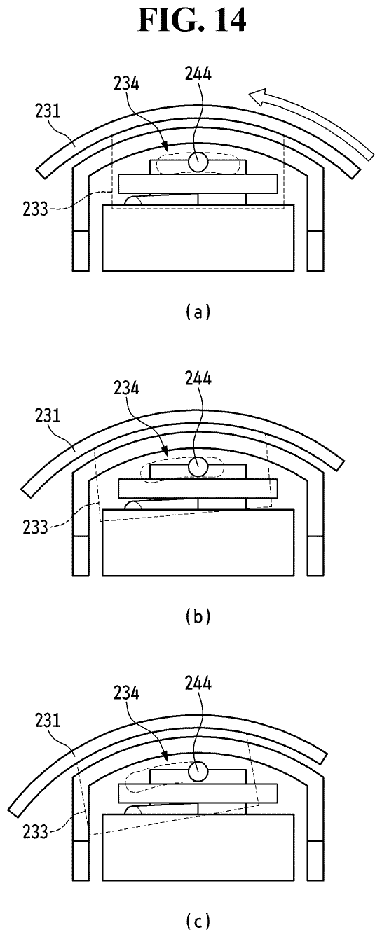

FIG. 13 is a reference view illustrating a coupled position of the tilting-rotation unit of the drive device illustrated in FIG. 10, and FIG. 14 shows reference views illustrating a process in which the tilting-rotation unit of the drive device of the side mirror assembly of FIG. 10 is tilted.

Referring to FIGS. 13 and 14, the first shaft 243 may penetrate one side surface of the lower case 211 to transmit rotational force for tilting rotation to the second cover 232.

A third worm gear 248 and the tilting worm wheel 249 may be coupled to the first shaft 243 so as to be rotatable together. The third worm gear 248 may mesh with the third reduction gear 247 and thereby transmit output to the first shaft 243. The tilting worm wheel 249 may be arranged so as to rotate in a limited manner within a predetermined angular range in accordance with rotation of the first shaft 243.

In this case, a distal end of the first shaft 243 may be coupled to the second cover 232, so that, in response to the rotation of the first shaft 243, the tilting-rotation unit 230 may rotate in a limited manner within a predetermined angular range.

The second shaft 244 may penetrate one side surface of the upper case 212 and be inserted into the slit 234 formed in the third cover 233. Accordingly, rotation or movement of the tilting-rotation unit 230 may be limited within a predetermined angular or length range based on the angle or length of the slit 234.

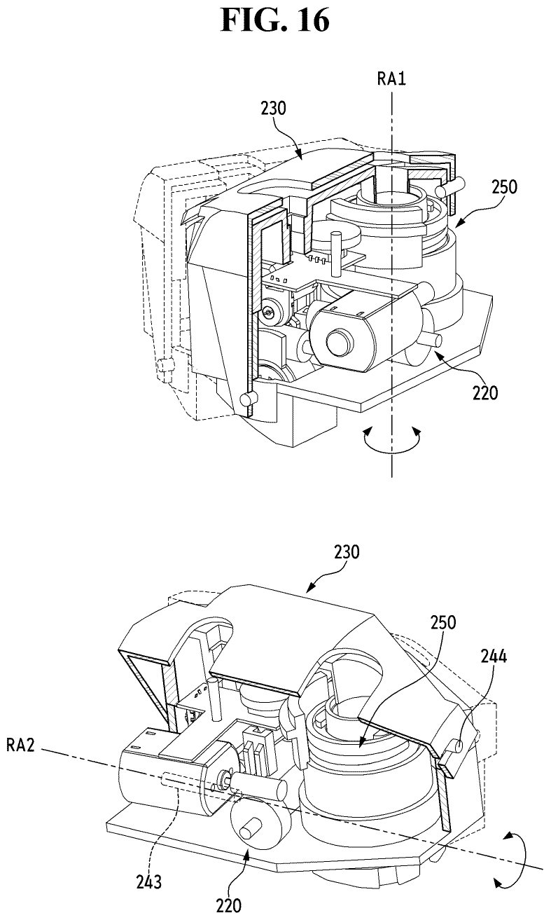

FIGS. 15 and 16 are reference views illustrating folding or tilting states of the drive device illustrated in FIG. 10.

Referring to FIGS. 15 and 16, the first rotation axis RA1, about which the mirror housing 110 or the motor housing 210 folds on the base 11 (see FIG. 8), may be arranged on a virtual extension line of the second rotation axis RA2, about which the tilting-rotation unit 230 tilts. For example, the second rotation axis RA2, formed at the center of rotation of the first shaft 243, may be arranged to intersect the first rotation axis RA1 in an axial direction.

That is, the motor housing 210 and the mirror housing 110 may rotate so as to be foldable together about the first rotation axis RA1, which is the center of rotation of the fixing unit 17. Since the second rotation axis RA2 lies in the motor housing 210, the mirror housing 110 may rotate so as to be tiltable together with the tilting-rotation unit 230 within a predetermined angular range with respect to the motor housing 210.

Furthermore, by designing the gear ratio of the first gear module 222 during folding rotation and the gear ratio of the second gear module 242 during tilting rotation to be at the same level, a sense of mismatch between folding speed and tilting speed may be prevented. For example, the gear ratio of the first gear module 222 may be 1500 to 1, and the gear ratio of the second gear module 242 may also be set to 1500 to 1, so that start and end times of folding rotation and tilting rotation become similar to each other.

Accordingly, in the side mirror assembly for a vehicle according to this embodiment, since the mirror and the mirror housing rotate together in accordance with folding or tilting, a bezel line at the outer edge of the mirror can be minimized, cost can be reduced by simplifying configurations of the first drive unit for folding the mirror housing and the second drive unit for tilting the mirror housing, and design flexibility can be enhanced through improvement of mirror design by optimizing components of the drive device.

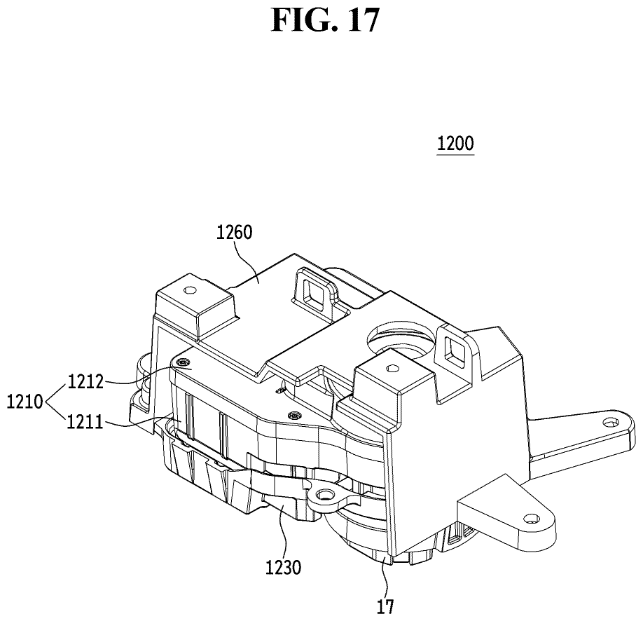

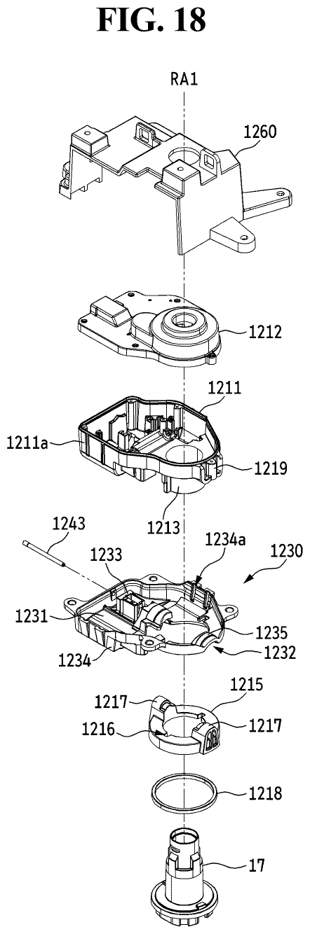

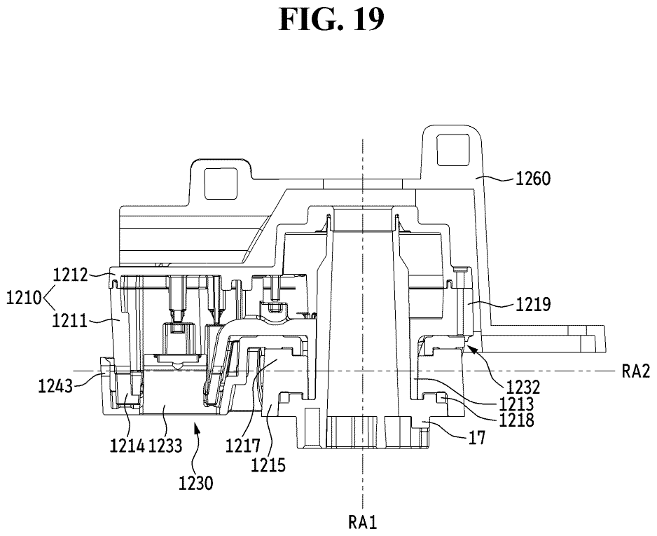

FIG. 17 is a perspective view illustrating a drive device for a side mirror assembly for a vehicle according to a second embodiment of the present disclosure, FIG. 18 is an exploded perspective view illustrating the drive device illustrated in FIG. 17 in a disassembled state, and FIG. 19 is a longitudinal cross-sectional view illustrating the drive device illustrated in FIG. 17.

Referring to FIGS. 17 to 19, a side mirror assembly 100 according to the second embodiment of the present disclosure may include a drive device 1200 for a vehicle side mirror.

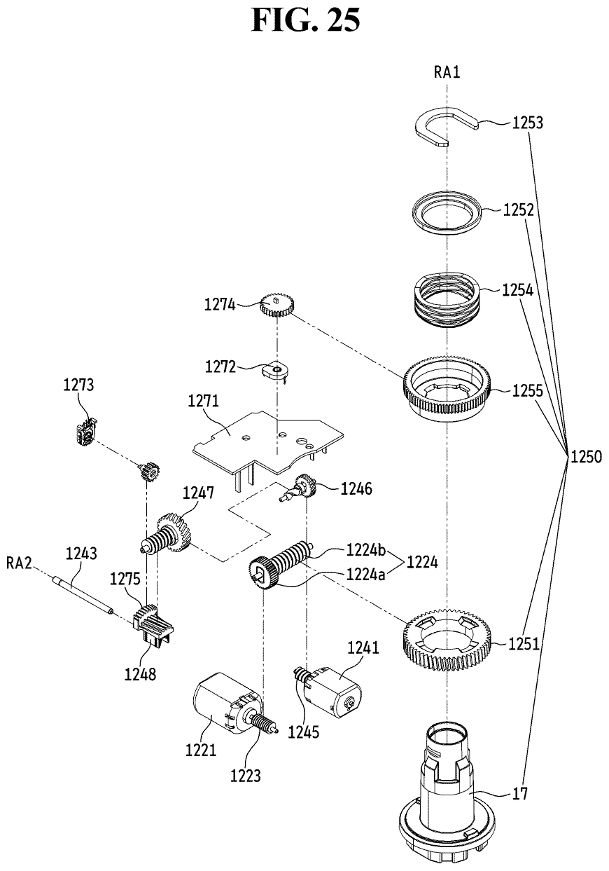

The drive device 1200 may include: a motor housing 1210 provided inside a mirror housing 110 (see FIG. 6); a first drive unit 1220 that participates in folding rotation of the mirror housing 110; a tilting-rotation unit 1230; a second drive unit 1240 that participates in tilting rotation of the tilting-rotation unit 1230; and a fixing module 1250 and a control module 1270 (see FIG. 25) that are provided on a fixing unit 17.

The motor housing 1210 may include a lower case 1211 and an upper case 1212.

The lower case 1211 may be disposed inside a lower housing 111, and an upper case 1212 may be coupled to the upper side of the lower case 1211, thereby forming the motor housing 1210. In this case, although the motor housing 1210 is disposed inside the mirror housing 110, it may not be coupled to the mirror housing 110 but only coupled to the fixing unit 17. For example, the first drive unit 1220 may cause folding rotation of the mirror housing 110 to provide relative rotation of the motor housing 1210 with respect to the fixing module 1250 about a first rotation axis RA1 formed on the fixing unit 17 (see FIG. 25), and the second drive unit 1240 may provide relative rotation to the tilting-rotation unit 1230 about a second rotation axis RA2 formed between the motor housing 1210 and the tilting-rotation unit 1230 (see FIG. 25), thereby causing tilting of the mirror housing 110.

The lower case 1211 may include a cylindrical portion 1213 and a tilting-shaft fastening portion 1214. The cylindrical portion 1213 may protrude downward from one side of the lower case 1211 and may be provided in a cylindrical shape to surround the fixing unit 17 when the fixing unit 17 is inserted at its center.

A support member 1215 may additionally be coupled around the cylindrical portion 1213. As the support member 1215 is coupled around the cylindrical portion 1213 with a portion of the tilting-rotation unit 1230 interposed between the lower case 1211 and the support member 1215, the support member 1215 may support one side of the tilting-rotation unit 1230.

The support member 1215 may include guide members 1216 that guide the correct orientation for coupling to the lower case 1211. The guide members 1216 may be formed as one or more projection-and-groove structures facing the lower side of the lower case 1211. In this embodiment, by way of example, one or more groove-type guide members 1216 arranged along a single straight line may be provided on the upper surface of the support member 1215. One or more projections 1213a having a shape corresponding to the guide members 1216 may be formed on the outer circumferential surface of the cylindrical portion 1213 of the lower case 1211. Accordingly, a coupling orientation of the support member 1215 to the lower case 1211 may be set through the guide members 1216. In addition, the guide members 1216 and the projections 1213a may remain engaged with each other along a folding rotation direction so that the support member 1215 and the cylindrical portion 1213 rotate together when the motor housing 1210 performs folding rotation.

The support member 1215 may also include a pair of support ends 1217 that protrude toward the bottom surface of the lower case 1211. The support ends 1217 may be spaced apart from each other along the axial direction of the second rotation axis RA2 around the cylindrical portion 1213 and may rotatably support one side of the tilting-rotation unit 1230 to be described later.

The support member 1215 may be provided so as to be rotatable with respect to the fixing unit 17 in accordance with folding rotation. In this case, a bushing 1218 may additionally be provided at a region where the support member 1215 and the fixing unit 17 contact each other.

The tilting-shaft fastening portion 1214 may support the other side of the tilting-rotation unit 1230 on the other side of the lower case 1211. The tilting-shaft fastening portion 1214 may receive a shaft 1243 provided on the rotation axis of the lower case 1211, i.e., the second rotation axis RA2, and the tilting-rotation unit 1230 may be fastened on the shaft 1243 so as to be rotatable about the second rotation axis RA2.

The tilting-rotation unit 1230 may be arranged to rotate relative to the motor housing 1210 about the second rotation axis RA2 (i.e., the tilting-rotation axis) formed at a lower center of the motor housing 1210. The tilting-rotation unit 1230 may rotate in a tilting direction by being driven by the second drive unit 1240. At this time, the tilting-rotation unit 1230 may perform tilting rotation about the second rotation axis RA2 together with the mirror housing 110 and the reflection part 120.

The tilting-rotation unit 1230 may include a bottom surface 1231, a first support 1232, a second support 1233, and a sidewall 1234. The bottom surface 1231 may be arranged to face the bottom surface of the lower case 1211 with a gap therebetween. The bottom surface 1231 and the lower case 1211 may be spaced apart from each other to allow relative rotation associated with the tilting rotation. The first and second supports 1232 and 1233 may be arranged on the bottom surface 1231 to be spaced apart from each other. The first support 1232 may support one side of the bottom surface 1231 with respect to the second rotation axis RA2, and the second support 1233 may support the other side of the bottom surface 1231 with respect to the second rotation axis RA2.

The first support 1232 may include a pair of support pieces 1235 that are spaced apart from each other along the second rotation axis RA2 with respect to the cylindrical portion 1213. Each of the support pieces 1235 may be arranged on a respective support end 1217 of the support member 1215 so as to be in surface contact with it.

The sidewall 1234 may be arranged to face both side surfaces of the lower case 1211 and surround the lower case 1211. Accordingly, the tilting-rotation unit 1230 may be arranged to be tiltable about the second rotation axis RA2 on the lower case 1211.

The tilting-rotation unit 1230 may also be fastened inside the mirror housing 110 together with a fixing frame 1260. Although the tilting-rotation unit 1230 is fastened only on the lower case 1211, with the fixing frame 1260 further provided, the tilting-rotation unit 1230 may be firmly fastened to the upper housing 112 and the back plate 130 via the fixing frame 1260. The fixing frame 1260 may perform tilting rotation about the second rotation axis RA2 together with the mirror housing 110 and may firmly support the structure in which the tilting-rotation unit 1230 rotates inside the mirror housing 110.

A detailed description of the fixing module 1250 and the control module 1270 will be provided later.

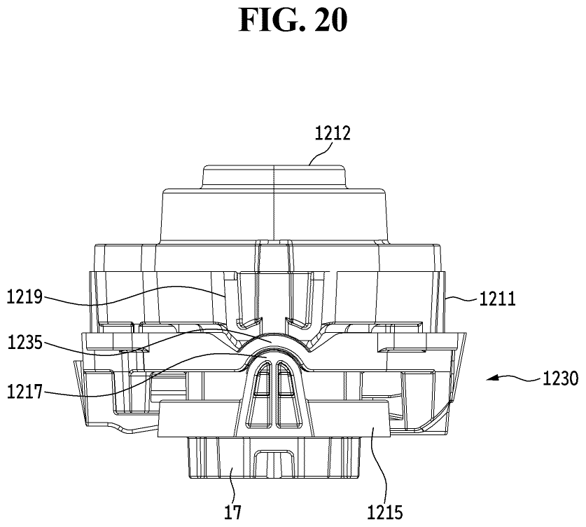

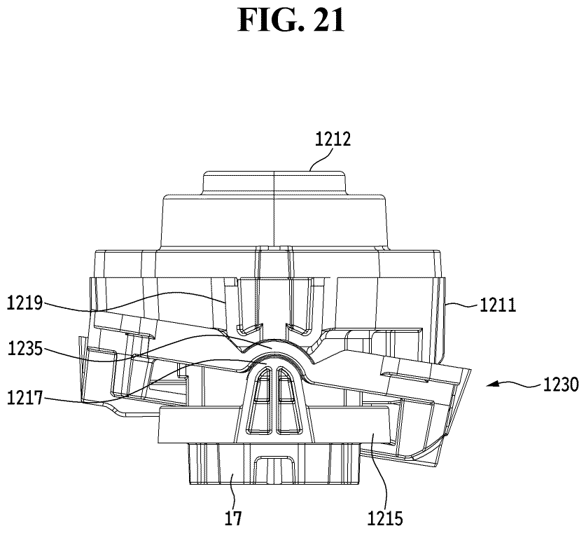

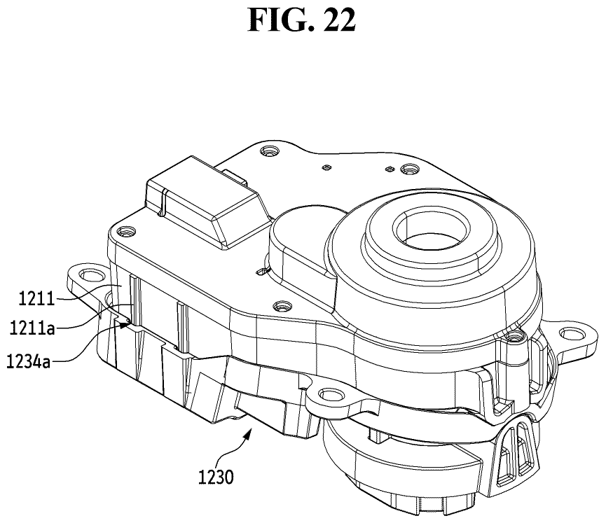

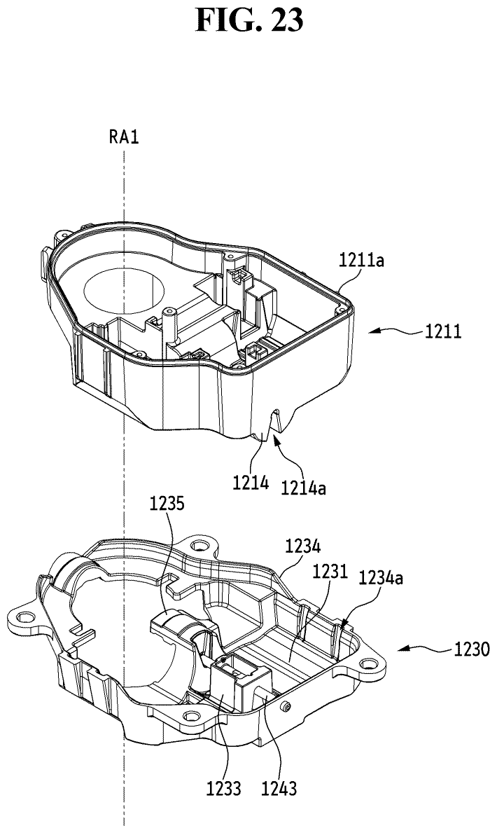

FIGS. 20 and 21 are perspective views illustrating a state in which the tilting-rotation unit of the drive device illustrated in FIG. 17 rotates, FIG. 22 is a perspective side view illustrating a state in which the tilting-rotation unit rotates with respect to the motor housing of the drive device illustrated in FIG. 17, and FIG. 23 is a reference view illustrating a coupled state between the lower case and the tilting-rotation unit at the second support of the drive device illustrated in FIG. 17.

Referring to FIGS. 20 to 23, the lower case 1211 may include a support guide 1219 that projects from one side surface of the lower case 1211. The support guide 1219 may be arranged to vertically overlap the support ends 1217 or the support pieces 1235. The lower surface of the support guide 1219 may be arranged to contact the upper surfaces of the support pieces 1235. In this case, the lower surface of the support guide 1219 and the upper surfaces of the support pieces 1235 may be formed as second curved surfaces to support relative rotation.

On the support guide 1219, first planes may be formed on both sides of the second curved surfaces that face the support pieces 1235. In this case, second planes that selectively contact the first planes may be formed on the support pieces 1235. The second planes may be formed on both sides of the second curved surfaces of the support pieces 1235. Accordingly, when the first planes and the second planes contact each other, the support guide 1219 and the support pieces 1235 may limit the rotation range of the tilting-rotation unit 1230. The contact surfaces of the support pieces 1235 and support ends 1217 may be formed as first curved surfaces facing each other, thereby implementing both a support structure and a fastening structure.

The second support 1233 may be spaced apart from the first support 1232 along the axial direction of the second rotation axis RA2 to support the other side of the bottom surface 1231. The second support 1233 may be fastened to the tilting-shaft fastening portion 1214 so that the shaft 1243 fastened to the tilting-shaft fastening portion 1214 is arranged to extend into the interior of the second support 1233, and may also be connected so as to be capable of performing the tilting rotation.

The tilting-rotation unit 1230 may have grooves 1234a formed inside the sidewall 1234, and projections 1211a may be formed on the side surface of the lower case 1211 facing the sidewall 1234. Alternatively, projections may be formed inside the sidewall 1234 and grooves may be formed on the side surface of the lower case 1211.

In this case, the projections 1211a and the grooves 1234a may be formed to correspond to each other so that they contact each other before the sidewall 1234 and the side surface of the lower case 1211 contact each other, thereby limiting the range of relative rotation of the tilting-rotation unit 1230 with respect to the lower case 1211. The projections 1211a and the grooves 1234a may be provided on both the lower case 1211 and the tilting-rotation unit 1230 so as to limit the rotation range of the tilting-rotation unit 1230 in both directions.

The tilting-shaft fastening portion 1214 may be formed with an undercut-shaped fastening groove 1214a such that both ends of the shaft 1243 are pressed and fixed. That is, the tilting-shaft fastening portion 1214 may be detachably coupled to the shaft 1243.

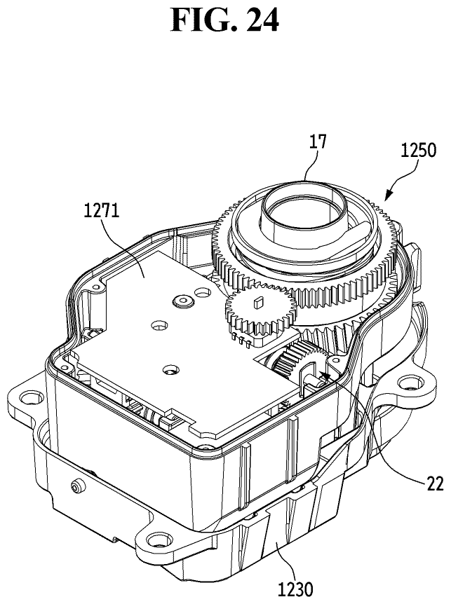

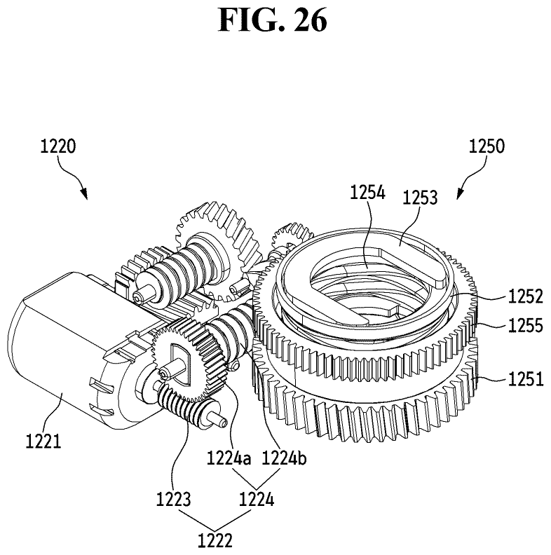

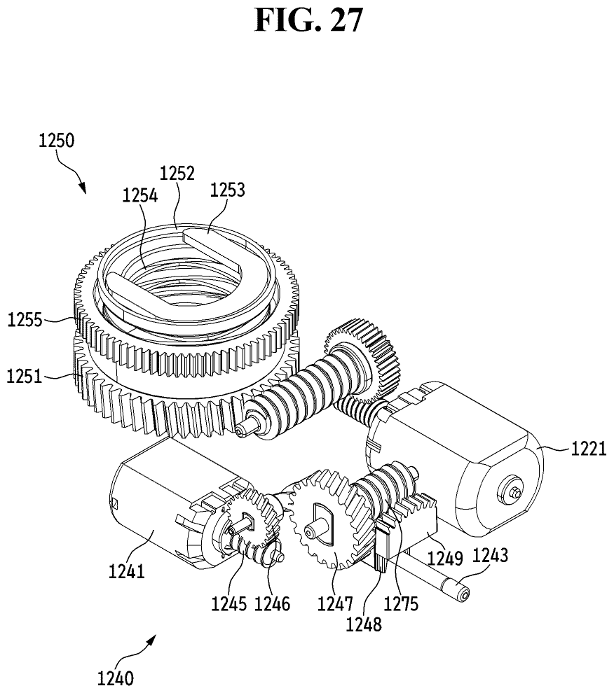

FIG. 24 is a reference view illustrating a state in which the upper case of the drive device illustrated in FIG. 17 is removed for illustration purposes, FIG. 25 is an exploded perspective view illustrating the first drive unit and the second drive unit of the drive device illustrated in FIG. 24, FIG. 26 is an enlarged perspective view illustrating the first drive unit of the drive device illustrated in FIG. 24, and FIG. 27 is an enlarged perspective view illustrating the second drive unit of the drive device illustrated in FIG. 25.

The first drive unit 1220 may include a first motor 1221 and a first gear module 1222, and may enable rotation via the final output of the first gear module 1222 in accordance with rotation of the first motor 1221.

The first gear module 1222 may include a first worm gear 1223 and a first reduction gear 1224. The first worm gear 1223 may be coupled to the rotation shaft of the first motor 1221. The first worm gear 1223 may transmit rotational force to the first reduction gear 1224.

The first reduction gear 1224 may mesh with the first worm gear 1223, and the rotation shaft of the first reduction gear 1224 may be arranged in a direction different from that of the rotation shaft of the first worm gear 1223. The first reduction gear 1224 may include a plurality of first gears 1224a and a second gear 1224b that provide a predetermined gear ratio and rotate together.

Accordingly, the final output of the first gear module 1222 may be delivered to the first reduction gear 1224. A driven gear 1251 of the fixing module 1250 may mesh with the second gear 1224b of the first reduction gear 1224, and the motor housing 1210 may rotate relative to the driven gear 1251.

The second drive unit 1240 may include a second motor 1241, a second gear module 1242, and a shaft 1243. The second gear module 1242 may include a second worm gear 1245 and a second reduction gear 1246. The second worm gear 1245 may be coupled to the rotation shaft of the second motor 1241. The second worm gear 1245 may transmit rotational force to the second reduction gear 1246.

The second reduction gear 1246 may mesh with the second worm gear 1245, and the rotation shaft of the second reduction gear 1246 may be arranged in a direction different from that of the rotation shaft of the second worm gear 1245. The second reduction gear 1246 may include a plurality of gears that provide a predetermined gear ratio and rotate together.

The second drive unit 1240 may further include a third reduction gear 1247 that meshes with the second reduction gear 1246. In this case, the second and third reduction gears 1246 and 1247 may provide different gear ratios. The third reduction gear 1247 may transmit final output to the shaft 1243 connected to a third worm gear 1248.

The fixing module 1250 may elastically support the motor housing 1210 on the fixing unit 17. The fixing module 1250 may include the driven gear 1251, a clip plate 1252, a clip 1253, an elastic member 1254, and a sub gear 1255.

The driven gear 1251 may be fastened within the motor housing 1210 so that the fixing unit 17 extends into the interior of the driven gear 1251. As the driven gear 1251 is coupled and fixed to the fixing unit 17, the driven gear 1251 may be prevented from rotating with respect to the fixing unit 17, but rotational force transmitted from the first reduction gear 224 to the driven gear 1251 may cause the motor housing 1210 to rotate relative to the driven gear 1251, thereby producing folding rotation. That is, the driven gear 1251 may be fixed to the fixing unit 17, and the first reduction gear 224 may rotate while remaining in mesh with the driven gear 1251.

The clip plate 1252 may be fixed at a distal end of the fixing unit 17 by the clip 1253. The elastic member 1254 may provide elastic support between the driven gear 1251 and the clip plate 1252.

The sub gear 1255 may be provided to surround the outer side of the elastic member 1254 and may be placed on the driven gear 1251. Gear teeth may be formed on the outer circumferential surface of the sub gear 1255 so as to mesh with a portion of the control module 1270, which will be described later, and the state of the folding rotation of the motor housing 1210 with respect to the sub gear 1255 may be transmitted to the control module 1270.

The control module 1270 may include a board 1271, a first potentiometer 1272 that detects rotation of the first drive unit 1220, and a second potentiometer 1273 that detects rotation of the second drive unit 1240.

The first and second potentiometers 1272 and 1273 may each be mounted on the board 1271. Each of the first and second potentiometers 1272 and 1273 may be implemented by a variable resistor that converts linear displacement or rotational displacement into a change in electrical resistance. The first and second potentiometers 1272 and 1273 may be configured as contact or non-contact types. In this embodiment, the first and second potentiometers 1272 and 1273 are described, by way of example, as contact types. In a contact-type potentiometer, a brush moves on a resistive element so that displacement can be measured according to rotation angle or number of rotations.

The first potentiometer 1272 may be provided with a first gear 1274 arranged to be rotatable on the board 1271, and the first gear 1274 may mesh with gear teeth 1256 of the sub gear 1255. Accordingly, the angle of the folding rotation of the motor housing 1210 may be sensed based on the rotation angle of the first gear 1274 relative to the gear teeth 1256 of the sub gear 1255.

The second potentiometer 1273 may be provided with a second gear 1275 arranged to be rotatable on the board 1271, and the second gear 1275 may mesh with gear teeth formed on a tilting worm wheel 1249. Accordingly, the angle of the tilting-rotation of the tilting-rotation unit 1230 may be sensed based on the rotation angle of the second gear 1275 relative to rotation of the tilting worm wheel 1249 about the shaft 1243.

The shaft 1243 may be coupled to both the third worm gear 1248 and the tilting worm wheel 1249 so as to be rotatable together. The third worm gear 1248 may mesh with the third reduction gear 1247 and thereby transmit output to the shaft 1243. The third worm gear 1248 and the tilting worm wheel 1249 may be integrally formed. The tilting worm wheel 1249 may be arranged so as to rotate in a limited manner within a predetermined angular range in accordance with rotation of the shaft 1243.

According to the drive device of this embodiment, by configuring the first drive unit for folding and the second drive unit for tilting as a single package, size reduction can be achieved, and cost can be decreased. Additionally, by packaging the drive device, freedom for mirror-design improvement can be secured. Moreover, the range over which the tilting-rotation unit performs tilting rotation with respect to the motor housing can be limited to a set range. Furthermore, by improving the coupling structure of the tilting-rotation unit around the drive device inside the mirror housing, a robust support structure can be provided for tilting rotation.

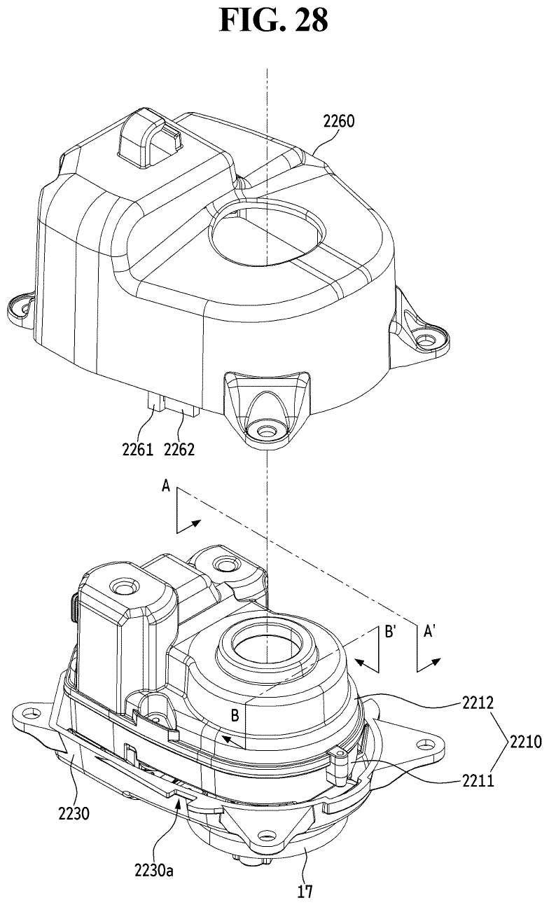

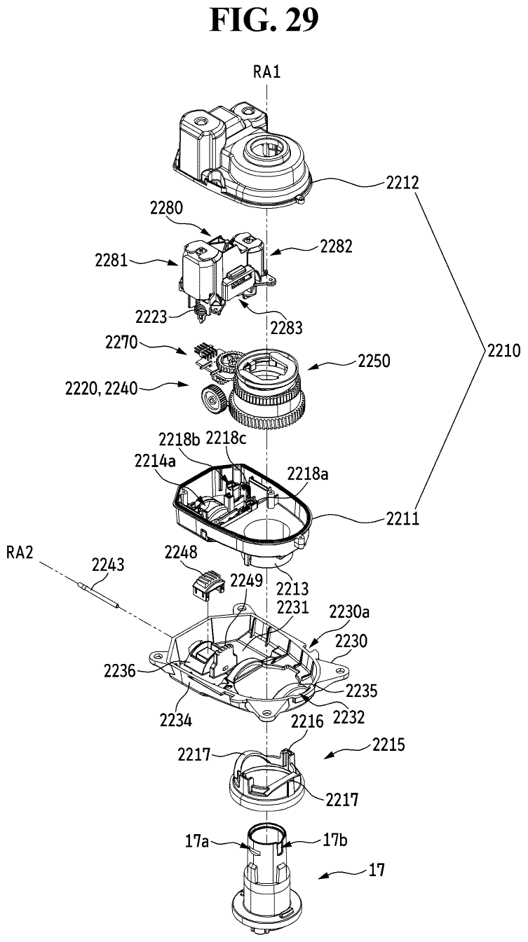

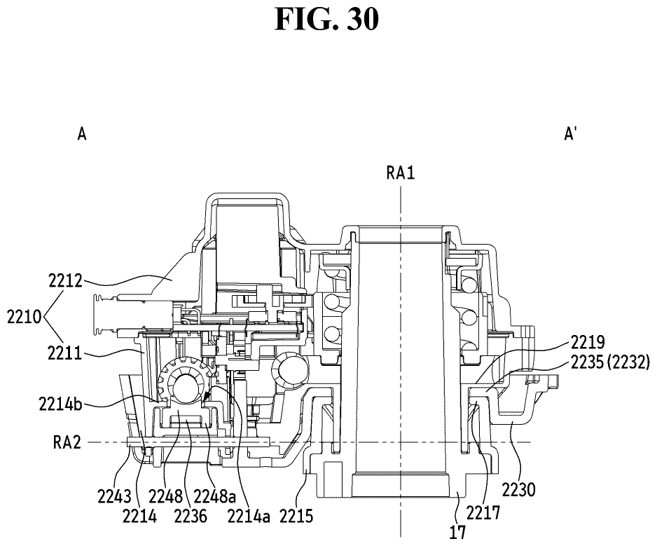

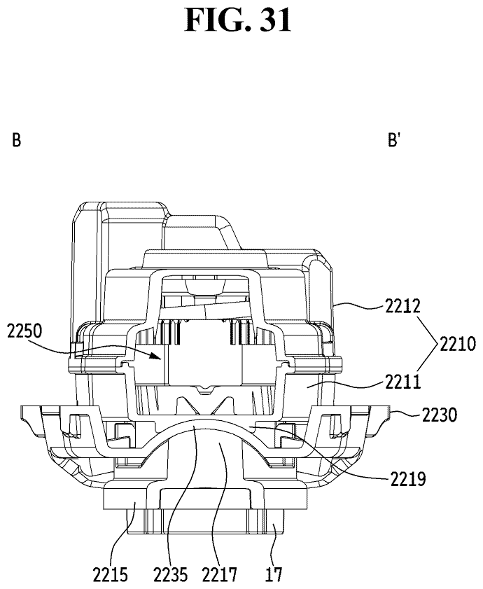

FIG. 28 is a perspective view illustrating a drive device for a side mirror assembly for a vehicle according to a third embodiment of the present disclosure, FIG. 29 is an exploded perspective view illustrating the drive device illustrated in FIG. 28 in a disassembled state, FIG. 30 is a longitudinal cross-sectional view illustrating an A-A′ section of the drive device illustrated in FIG. 28, and FIG. 31 is a longitudinal cross-sectional view illustrating a B-B′ section of the drive device illustrated in FIG. 28.

Referring to FIGS. 28 to 31, a side mirror assembly 100 according to the present disclosure may include a drive device 2000 for a vehicle side mirror.

The drive device 2000 may include: a motor housing 2210 provided inside a mirror housing 110 (see FIG. 6); a first drive unit 2220 that participates in folding rotation of the mirror housing 110; a tilting-rotation unit 2230; a support member 2215; a second drive unit 2240 that participates in tilting rotation of the tilting-rotation unit 2230; and a fixing module 2250 provided on a fixing unit 17, a control module 2270, and a motor installation unit 2280.

The motor housing 2210 may include a lower case 2211 and an upper case 2212. The lower case 2211 may be disposed inside a lower housing 111. As the upper case 2212 is coupled to the upper side of the lower case 2211, the motor housing 2210 may be formed. In this case, although the motor housing 2210 is disposed inside the mirror housing 110, it may not be coupled to the mirror housing 110 but only coupled to the fixing unit 17. For example, the first drive unit 2220 may drive folding rotation of the mirror housing 110 to provide relative rotation of the motor housing 2210 with respect to the fixing module 2250 about a first rotation axis RA1 formed on the fixing unit 17, and the second drive unit 2240 may drive tilting rotation of the tilting-rotation unit 2230 about a second rotation axis RA2 formed between the motor housing 2210 and the tilting-rotation unit 2230 to provide relative rotation of the mirror housing 110.

The lower case 2211 may include a cylindrical portion 2213, a tilting-shaft fastening portion 2214, a first mounting portion 2218a, a second mounting portion 2218b, and a third mounting portion 2218c.

The cylindrical portion 2213 may protrude downward from one side of the bottom surface of the lower case 2211 and may be formed in a hollow cylindrical shape to surround the fixing unit 17 when the fixing unit 17 is inserted at its center.

A first reduction gear 2224 to be described later may be mounted on the first mounting portion 2218a, a second reduction gear 2246 may be mounted on the second mounting portion 2218b, and a motor installation unit 2280 may be mounted on the third mounting portion 2218c. The first, second, and third mounting portions 2218a, 2218b, and 2218c may be formed inside the lower case 2211 so that assembly of the first reduction gear 2224, the second reduction gear 2246, a third reduction gear 2247, and the motor installation unit 2280 can be facilitated.

Around the cylindrical portion 2213, the support member 2215 may additionally be coupled via the fixing unit 17. The support member 2215 may be fastened around the cylindrical portion 2213 so that a portion of the tilting-rotation unit 2230 (or first support pieces 2235) is interposed between the lower case 2211 and the support member 2215, thereby supporting one side of the tilting-rotation unit 2230.

The support member 2215 may include guide members 2216 that guide the correct orientation for coupling to the lower case 2211. The guide members 2216 may be formed as one or more projection-and-groove structures facing the lower side of the lower case 2211. In this embodiment, by way of example, one or more groove-type guide members 2216 may be provided in-line on both sides of the support member 2215 so as to face each other. One or more first projections 2213a having a shape corresponding to the guide members 2216 may be formed on the outer circumferential surface of the cylindrical portion 2213 of the lower case 2211. Accordingly, a coupling orientation of the support member 2215 to the lower case 2211 may be set by the guide members 2216. In addition, the guide members 2216 and the first projections 2213a may be engaged with each other along the folding-rotation direction so that the support member 2215 and the cylindrical portion 2213 may rotate together when the motor housing 2210 folds.

The support member 2215 may further include a pair of support ends 2217 that project toward the bottom surface of the lower case 2211 (or toward the first support pieces 2235). The support ends 2217 may be arranged around the cylindrical portion 2213 and spaced apart from each other along the axial direction of the second rotation axis RA2 below the first support pieces 2235, and may rotatably support one side of the tilting-rotation unit 2230 to be described later.

During folding rotation, the support member 2215 may be arranged to be rotatable on the fixing unit 17. In this case, a bushing may additionally be provided at a region where the support member 2215 and the fixing unit 17 contact each other.

The tilting-shaft fastening portion 2214 may support the other side of the tilting-rotation unit 2230 at the other side of the lower case 2211. A shaft 2243, arranged on the second rotation axis RA2 of the lower case 2211, may be fastened to the tilting-shaft fastening portion 2214, and the tilting-rotation unit 2230 may be coupled on the shaft 2243 so as to be rotatable about the second rotation axis RA2.

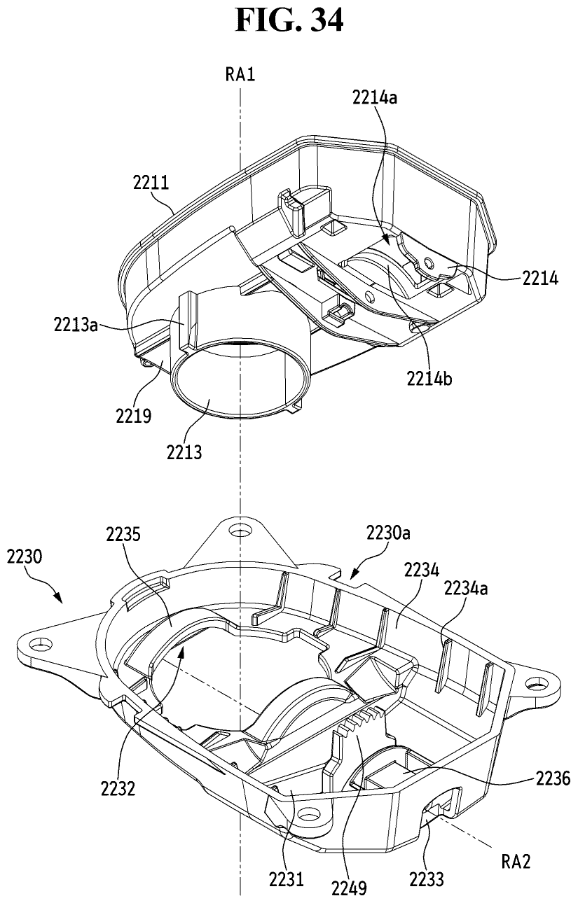

The tilting-rotation unit 2230 may be arranged to rotate relative to the motor housing 2210 about the second rotation axis RA2 (i.e., the tilting-rotation axis) formed at a lower center of the motor housing 2210. The tilting-rotation unit 2230 may rotate in a tilting direction by being driven by the second drive unit 2240. In this case, the tilting-rotation unit 2230 may perform tilting rotation about the second rotation axis RA2 together with the mirror housing 110 and a reflection part 120. The tilting-rotation unit 2230 may include a bottom surface 2231, a first support 2232, a second support 2233 (see FIG. 34), and a sidewall 2234.

The bottom surface 2231 may be arranged to face the bottom surface of the lower case 2211 with a gap therebetween. The bottom surface 2231 and the lower case 2211 may be spaced apart from each other to allow relative rotation associated with tilting rotation.

The first and second supports 2232 and 2233 may be arranged on opposite sides of the bottom surface 2231 to be spaced apart from each other. The first support 2232 may support one side of the bottom surface with respect to the second rotation axis RA2, and the second support 2233 may support the other side of the bottom surface 2231 with respect to the second rotation axis RA2.

The first support 2232 may include a pair of first support pieces 2235 that are spaced apart from each other along the second rotation axis RA2 with respect to the cylindrical portion 2213. Each of the first support pieces 2235 may be arranged on a respective support end 2217 of the support member 2215 so as to be in surface contact.

The sidewall 2234 may be arranged to face both side surfaces of the lower case 2211 and to surround the lower case 2211. Accordingly, the tilting-rotation unit 2230 may be arranged to be tiltable about the second rotation axis RA2 on the lower case 2211.

In addition, a tilting worm wheel 2249 may be provided on the bottom surface 2231 of the tilting-rotation unit 2230. The tilting worm wheel 2249 may provide rotation-amount data corresponding to tilting rotation of the tilting-rotation unit 2230 to a second potentiometer 2273 to be described later.

The bottom surface 2231 of the tilting-rotation unit 2230 may also be provided with a gear mounting portion 2236 adjacent to the tilting worm wheel 2249, in which a third worm gear 2248 to be described later is installed. The gear mounting portion 2236 may guide a mounting position such that a body portion 2248a of the third worm gear 2248 may be at least partially inserted and fixed at a set location. When the third worm gear 2248 is mounted on the gear mounting portion 2236, gear teeth formed on the upper side of the body portion 2248a may be exposed.

Guide grooves 2230a for guiding a coupling position with the mirror housing 110 may be formed on the sidewall 2234 of the tilting-rotation unit 2230. The guide grooves 2230a may have a recess structure into which ribs 118 (see FIG. 6) provided on the lower housing 111 are inserted, and may accurately guide an installation position of the tilting-rotation unit 2230. The guide grooves 2230a and the ribs 118 may allow pre-assembly of the tilting-rotation unit 2230 and the mirror housing 110, thereby improving assemblability.

The lower case 2211 may be formed with a first opening 2214a through which the gear teeth of the third worm gear 2248 coupled to the tilting-rotation unit 2230 are exposed into the interior of the lower case 2211. When the gear teeth enter the interior of the lower case through the first opening 2214a, a fixing end 2214b may be provided around the first opening 2214a of the lower case 2211 to press the upper surface of the body portion 2248a or the outer periphery of the gear teeth toward the gear mounting portion 2236. The fixing end 2214b may rigidly support the third worm gear 2248 between the gear mounting portion 2236 and the lower case 2211 to prevent movement.

The tilting-rotation unit 2230 may also be fastened inside the mirror housing 110 together with a fixing frame 2260. Although the tilting-rotation unit 2230 is fastened only on the lower case 2211, with the fixing frame 2260 further provided, the tilting-rotation unit 2230 may be fastened to at least one of the upper housing 112 or the back plate 130 via the fixing frame 2260. The fixing frame 2260 may perform tilting rotation about the second rotation axis RA2 together with the mirror housing 110 and may more firmly support the support structure in which the tilting-rotation unit 2230 rotates inside the mirror housing 110. The fixing frame 2260 may include hook members 2261 and guide projections 2262.

When the tilting-rotation unit 2230 and the fixing frame 2260 are coupled to each other, the hook members 2261 may be fastened to the sidewall 2234 of the tilting-rotation unit 2230 so that pre-assembly of the tilting-rotation unit 2230 and the fixing frame 2260 may be completed before they are fixed together inside the mirror housing 110.

The guide projections 2262 may be inserted into the guide grooves 2230a. The guide projections 2262 may guide the coupling position of the tilting-rotation unit 2230 to the fixing frame 2260. For example, the guide projections 2262 and the guide grooves 2230a may be arranged at different positions depending on whether the side mirror assembly 100 is for the left-side or right-side mirror of a vehicle, thereby preventing confusion between left-side mirror parts and right-side mirror parts and improving assemblability. The guide grooves 2230a may selectively receive the ribs 118 described above or the guide projections 2262, or a plurality of guide grooves may be formed at different positions to respectively receive the ribs 118 and the guide projections 2262.

A detailed description of the fixing module 2250, the control module 2270, and the motor installation unit 2280 will be provided later.

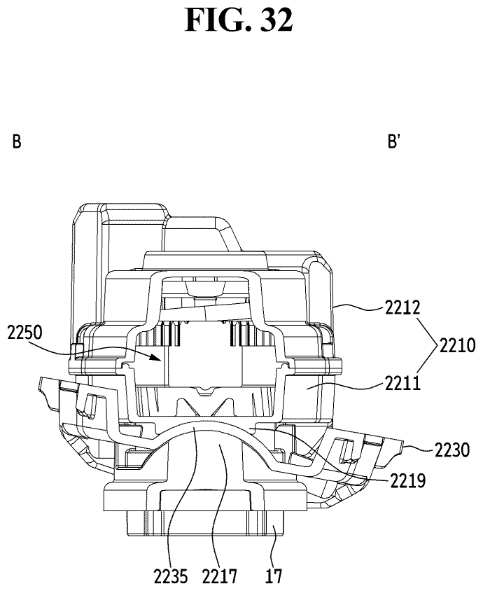

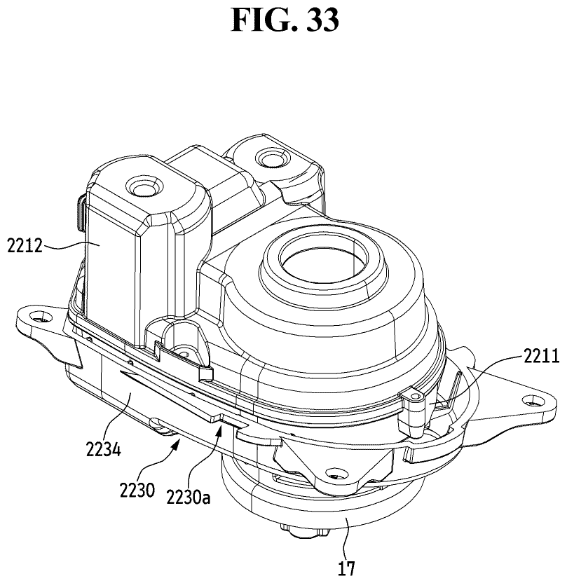

FIG. 32 is a longitudinal cross-sectional view illustrating a B-B′ section of the drive device illustrated in FIG. 28, FIG. 33 is a perspective view illustrating a state in which the tilting-rotation unit has performed tilting rotation with respect to the motor housing of the drive device illustrated in FIG. 28, and FIG. 34 is a reference view illustrating a coupled state between the lower case and the tilting-rotation unit at the second support of the drive device illustrated in FIG. 28.

Referring to FIGS. 32 to 34, the lower case 2211 may include a support guide 2219 that protrude from a lower portion of one side of the lower case 2211. The support guide 2219 may be arranged to vertically overlap the support ends 2217 or the first support pieces 2235. The lower surface of the support guide 2219 may be arranged to be in surface contact with the upper surfaces of the first support pieces 2235. In this case, the lower surface of the support guide 2219 and the upper surfaces of the first support pieces 2235 may be formed as second curved surfaces to support relative (or tilting) rotation.

The contact surfaces of the first support pieces 2235 and the support ends 2217 may be formed as first curved surfaces facing each other, thereby implementing both a support structure and a fastening structure.

The second support 2233 may be spaced apart from the first support 2232 along the axial direction of the second rotation axis RA2 to support the other side of the bottom surface 2231. The second support 2233 may be fastened to the tilting-shaft fastening portion 2214 so that a shaft 2243 fastened to the tilting-shaft fastening portion 2214 may be arranged to extend into the interior of the second support 2233, and may also be connected so as to allow tilting rotation.

The tilting-rotation unit 2230 may have second projections 2234a formed on the inner side of the sidewall 2234. The second projections 2234a may contact the side surface of the lower case 2211 as the tilting-rotation unit 2230 tilt-rotates. Alternatively, the second projections 2234a may be formed on the outer side of the lower case 2211. In this case, the second projections 2234a may limit the range of relative rotation of the tilting-rotation unit 2230 with respect to the lower case 2211.

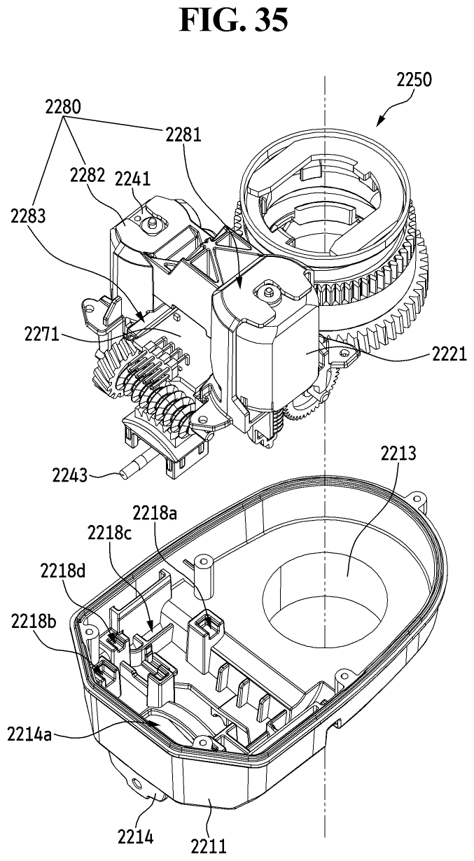

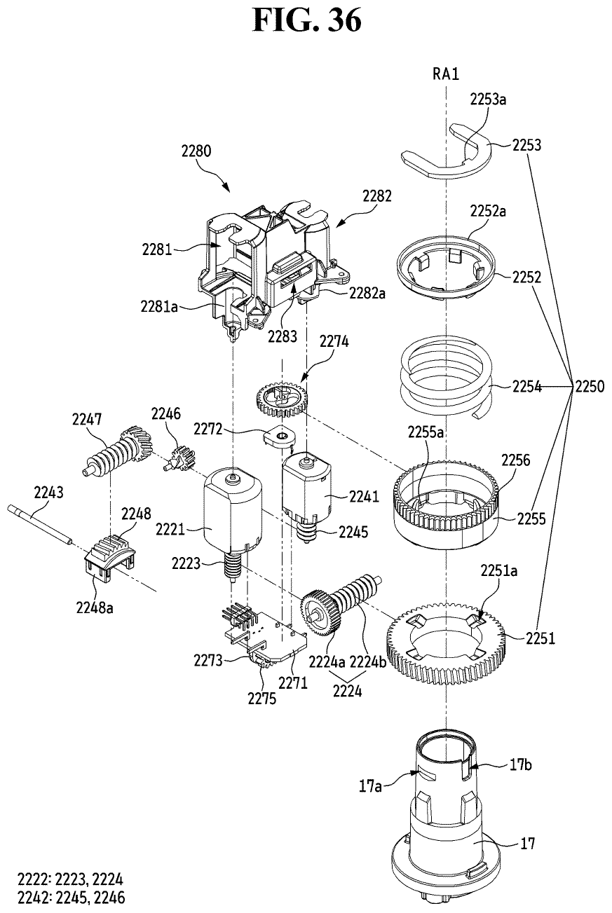

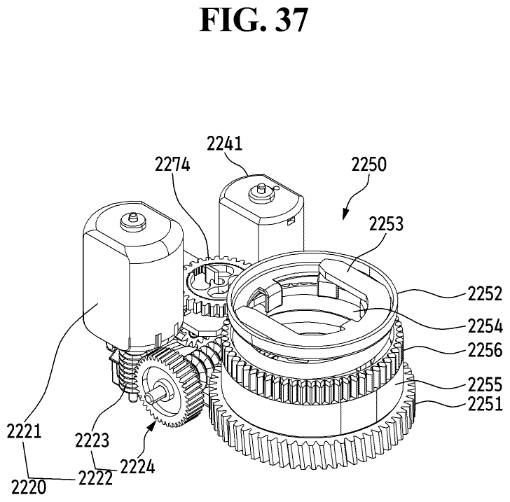

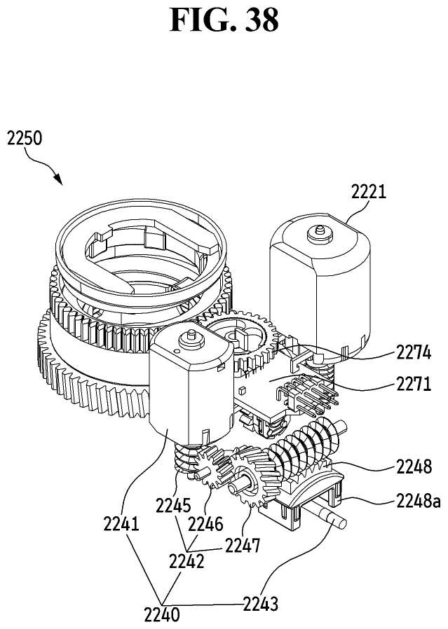

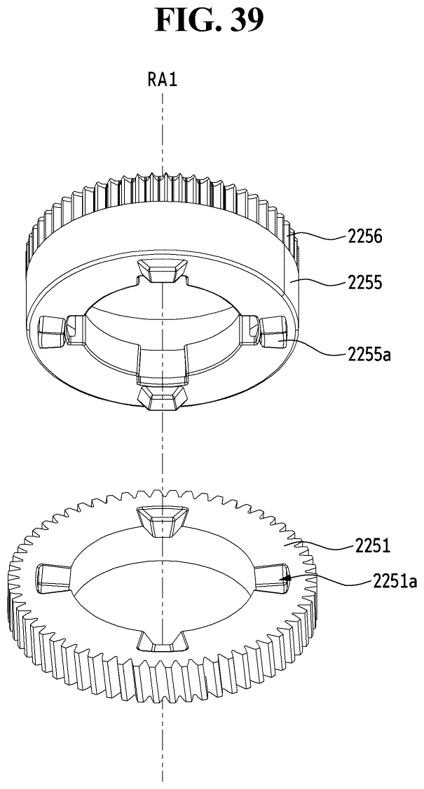

FIG. 35 is a reference view illustrating a state in which an upper case of the drive device illustrated in FIG. 28 is removed, FIG. 36 is an exploded perspective view illustrating the first and second drive units of the drive device illustrated in FIG. 35, FIG. 37 is an enlarged perspective view illustrating the first drive unit of the drive device illustrated in FIG. 36, FIG. 38 is an enlarged perspective view illustrating the second drive unit of the drive device illustrated in FIG. 36, and FIG. 39 is a perspective view illustrating the coupling between a sub gear and a driven gear of the drive device illustrated in FIG. 36.

Referring to FIGS. 35 to 39, the first drive unit 2220 may include a first motor 2221 and a first gear module 2222. In response to rotation of the first motor 2221, the first drive unit 2220 may enable folding rotation via the final output of the first gear module 2222.

The first gear module 2222 may include a first worm gear 2223 and a first reduction gear 2224. The first worm gear 2223 may be coupled to the rotation shaft of the first motor 2221. The first worm gear 2223 may transmit rotational force to the first reduction gear 2224.

The first reduction gear 2224 may mesh with the first worm gear 2223, and the rotation shaft of the first reduction gear 2224 may be arranged in a direction different from that of the rotation shaft of the first worm gear 2223. The first reduction gear 2224 may include a first gear 2224a and a second gear 2224b that provide a predetermined gear ratio and rotate together.

Accordingly, the final output of the first gear module 2222 may be delivered to the first reduction gear 2224. A driven gear 2251 of the fixing module 2250 may mesh with the second gear 2224b of the first reduction gear 2224, and the motor housing 2210 may rotate relative to the driven gear 2251 so that folding rotation occurs.

The second drive unit 2240 may include a second motor 2241, a second gear module 2242, and a shaft 2243. The second gear module 2242 may include a second worm gear 2245 and a second reduction gear 2246. The second worm gear 2245 may be coupled to the rotation shaft of the second motor 2241. The second worm gear 2245 may transmit rotational force to the second reduction gear 2246.

The second reduction gear 2246 may mesh with the second worm gear 2245, and the rotation shaft of the second reduction gear 2246 may be arranged in a direction different from that of the rotation shaft of the second worm gear 2245. The second reduction gear 2246 may include a plurality of gears that provide a predetermined gear ratio and rotate together.

The second drive unit 2240 may further include a third reduction gear 2247 that meshes with the second reduction gear 2246. In this case, the second and third reduction gears 2246 and 2247 may provide different gear ratios. The third reduction gear 2247 may deliver final output to a third worm gear 2248 to tilt-rotate the tilting-rotation unit 2230.

The fixing module 2250 may elastically support the motor housing 2210 on the fixing unit 17. The fixing module 2250 may include the driven gear 2251, a clip plate 2252, a clip 2253, an elastic member 2254, and a sub gear 2255.

The driven gear 2251 may be disposed within the motor housing 210 (see FIG. 29) so that the fixing unit 17 may extend into the interior of the driven gear 2251. Although the driven gear 2251 is coupled to and fixed on the fixing unit 17 and therefore does not rotate with respect to the fixing unit 17, rotational force transmitted from the first reduction gear 2224 to the driven gear 2251 may cause the motor housing 2210 to rotate relative to the driven gear 2251, thereby producing folding rotation. That is, the driven gear 2251 may be fixed to the fixing unit 17, and the first reduction gear 2224 may rotate while remaining in mesh with the driven gear 2251.

The clip plate 2252 may be coupled at a distal end of the fixing unit 17 by the clip 2253. The clip plate 2252 may be provided with a stepped portion 252a that surrounds the clip 2253 so as to prevent the clip 2253 from being removed after the clip 2253 is coupled to the fixing unit 17.

The clip 2253 may be coupled along a first fastening groove 17a formed at the distal end of the fixing unit 17. In this case, a second fastening groove 17b may be formed at a position on the distal end of the fixing unit 17 where the first fastening groove 17a is not formed. A fixing projection 2253a protruding from a central region of the clip 2253 may be inserted into the second fastening groove 17b. Accordingly, as the fixing projection 2253a is inserted into the second fastening groove 17b, the clip 2253 may be prevented from rotating about the first rotation axis RA1 at the distal end of the fixing unit 17.

The elastic member 2254 may provide elastic support between the sub gear 2255 and the clip plate 2252. That is, the elastic member 2254 may provide an elastic restoring force such that the sub gear 2255, with the position of the clip plate 2252 fixed by the clip 2253, is pressed (e.g., biased) toward the driven gear 2251.

The sub gear 2255 may be arranged to surround the outer side of the elastic member 2254 and may be placed on the driven gear 2251. Gear teeth 2256 may be formed on the outer circumferential surface of the sub gear 2255 so as to mesh with a portion of the control module 2270 to be described later, and the state of the folding-rotation of the motor housing 2210 with respect to the sub gear 2255 may be transmitted to the control module 2270.

The control module 2270 may include a board 2271, a first potentiometer 2272 that detects rotation of the first drive unit 2220, and a second potentiometer 2273 that detects rotation of the second drive unit 2240.

The first and second potentiometers 2272 and 2273 may each be mounted on the board 2271. Each of the first and second potentiometers 2272 and 2273 may be implemented by a variable resistor that converts linear displacement or rotational displacement into a change in electrical resistance. The first and second potentiometers 2272 and 2273 may be configured as contact or non-contact types. In this embodiment, the first and second potentiometers 2272 and 2273 are described, by way of example, as contact types. In a contact-type potentiometer, a brush moves on a resistive element so that displacement can be measured based on rotation angle or number of rotations.

The first potentiometer 2272 may be provided with a first gear 2274 arranged to be rotatable on the board 2271, and the first gear 2274 may mesh with gear teeth 2256 of the sub gear 2255. Accordingly, the folding-rotation angle of the motor housing 2210 may be sensed based on the rotation angle of the first gear 2274 relative to the gear teeth 2256 of the sub gear 2255.

The second potentiometer 2273 may be provided with a second gear 2275 arranged to be rotatable on the board 2271, and the second gear 2275 may mesh with gear teeth formed on the tilting worm wheel 2249. Accordingly, the tilting-rotation angle of the tilting-rotation unit 2230 may be sensed based on the rotation angle of the second gear 2275 relative to rotation of the tilting worm wheel 2249 about the shaft 2243. The tilting worm wheel 2249 may rotate in a limited manner within a predetermined angular range corresponding to the tilting-rotation range of the tilting-rotation unit 2230.

The motor installation unit 2280 may include a first mounting portion 2281, a second mounting portion 2282, and a third mounting portion 2283. The first mounting portion 2281 may be a region disposed on one side of the motor installation unit 2280 where the first motor 2221 is configured to be mounted, the second mounting portion 2282 may be a region disposed on the other side where the second motor 2241 is configured to be mounted, and the third mounting portion 2283 may be a region arranged between the first and second mounting portions 2281 and 2282 where the board 2271 is mounted.

In the motor installation unit 2280, the first and second mounting portions 2281 and 2282 may be formed to correspond to the sizes of the first and second motors 2221 and 2241, respectively, and may be formed in different sizes. In this embodiment, the first mounting portion 2281 is illustrated, by way of example, as being larger than the second mounting portion 2282.

The third mounting portion 2283 may be configured as a slot so that the board 2271 can be easily assembled or removed. Accordingly, since the board 2271 can be inserted into or removed from the third mounting portion 2283 in a sliding manner, improved assemblability of the board 2271 can be expected. The third mounting portion 2283 may provide a structure that connects the first and second mounting portions 2281 and 2282.

After the first and second motors 2221 and 2241 are respectively assembled to the first and second mounting portions 2281 and 2282 of the motor installation unit 2280, the motor installation unit 2280 may be installed inside the motor housing 2210 (see FIG. 28). The rotation shafts of the first and second motors 2221 and 2241 may be arranged in parallel along a direction in which the motor installation unit 2280 is coupled to the lower case 2211. For example, the rotation shafts of the first and second motors 2221 and 2241 may be arranged parallel to the folding rotation axis of the motor housing 2210, i.e., the first rotation axis RA1. Alternatively, the rotation shafts of the first and second motors 2221 and 2241 may be arranged to form a predetermined angle with the first rotation axis RA1. By installing the motor installation unit 2280 such that the rotation shafts of the first and second motors 2221 and 2241 are oriented generally perpendicular to the bottom surface of the lower case 2211, the required installation space can be significantly reduced compared with a structure in which the rotation shafts of the first and second motors 2221 and 2241 are arranged horizontally with respect to the bottom surface of the lower case 2211.

A lower end 2281a of the first mounting portion 2281 and a lower end 2282a of the second mounting portion 2282 may be fixed with at least portions thereof inserted into the third mounting portion 2218c of the lower case 2211. When the motor installation unit 2280 is inserted and installed in the third mounting portion 2218c, a first worm gear 2223 coupled to the rotation shaft of the first motor 2221 and a second worm gear 2245 coupled to the rotation shaft of the second motor 2241 may be arranged to mesh with the first reduction gear 2224 and a third reduction gear 2247, respectively. The lower case 2211 may also be provided with a fourth mounting portion 2218d in which the second reduction gear 2246 is installed between the second worm gear 2245 and the third reduction gear 2247.

When an external force is applied to the mirror housing 110 while the first motor 2221 is at rest, the driven gear 2251 may undergo relative rotation with respect to the sub gear 2255 about the first rotation axis RA1 on the fixing unit 17. This relative rotation can provide a configuration that allows manual rotation so as to prevent damage between the first drive unit 2220 and the driven gear 2251 even if the mirror housing 110 is forcibly rotated by an external force.

Recesses 2251a may be formed on one of the driven gear 2251 or the sub gear 2255, and third projections 2255a corresponding to the recesses 2251a may be provided on the other. In this embodiment, the recesses 2251a may be formed on the upper side of the driven gear 2251, and the third projections 2255a may be provided on the lower side of the sub gear 2255. The recesses 2251a and the third projections 2255a may be configured to contact each other along inclined surfaces in the folding-rotation direction. Accordingly, when an external force greater than a predetermined threshold is applied, the third projections 2255a may rise up the inclined surfaces of the respective recesses 2251a and be discharged therefrom. A plurality of recesses 2251a and a plurality of third projections 2255a may be arranged on the driven gear 2251 and the sub gear 2255, respectively, over a predetermined angular range.

Since the elastic member 2254 of the fixing module 2250 biases the sub gear 2255 toward the driven gear 2251, the recesses 2251a and the third projections 2255a may remain meshed with each other when folding rotation is electrically performed via the drive device 200. Here, when the first motor 2221 is at rest and the mirror housing 110 is rotated in the folding direction by an external force, the first drive unit 2220 and the driven gear 2251 may fold-rotate together about the first rotation axis RA1 on the fixing unit 17 while remaining in mesh with each other, and then, the meshing between the recesses 2251a and the third projections 2255a may be released so that the driven gear 2251 and the sub gear 2255 may become separated from each other. Since multiple recesses 2251a and multiple third projections 2255a are arranged along the folding-rotation direction, once one third projection 2255a is discharged from a corresponding recess 2251a, manual rotation may be continued until the one third projection 2255a is inserted into an adjacent recess 2251a.

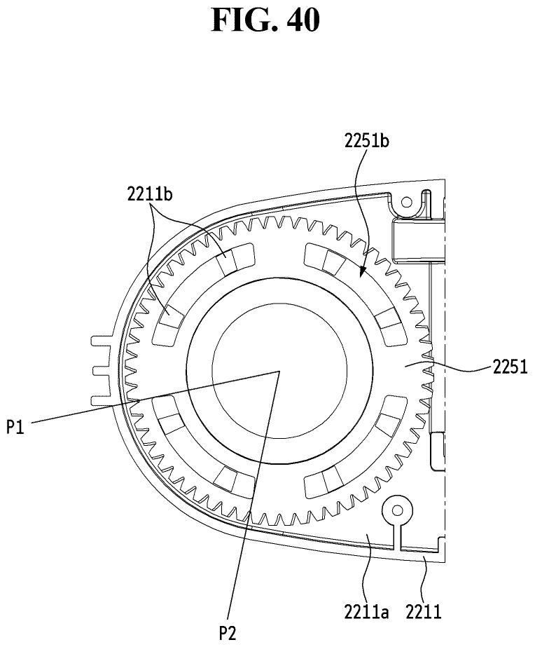

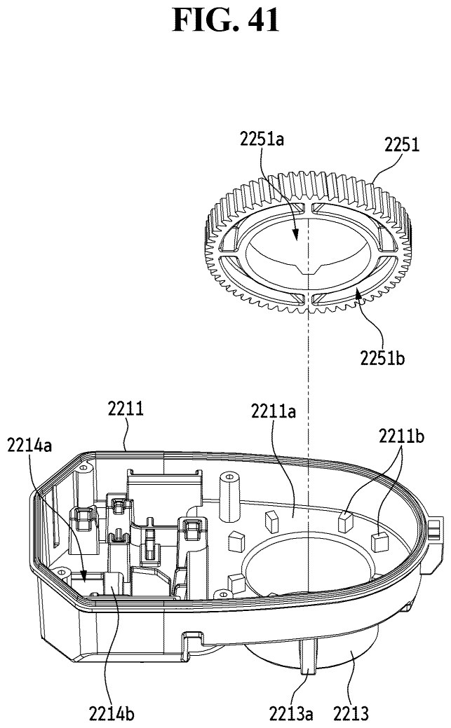

FIG. 40 is a perspective view illustrating another embodiment of the lower case and the driven gear of the drive device illustrated in FIG. 29, and FIG. 41 is a partially cutaway perspective view illustrating the lower case and the driven gear of the drive device illustrated in FIG. 40.

Referring to FIGS. 40 and 41, the lower case 2211 may include stoppers 2211b that protrude from an inner bottom surface 2211a of the lower case 2211 around the cylindrical portion 2213. A plurality of stoppers 2211b may be provided facing one another around the center of the cylindrical portion 2213. A pair of stoppers 2211b may constitute a unit stopper, and a plurality of unit stoppers may be arranged in multiple regions. In this case, the stoppers 2211b may be disposed at the same radial distance from the center of the cylindrical portion 2213. The spacing (angle) between two adjacent unit stoppers may be uniform. Each unit stopper (i.e., a pair of stoppers 2211b) may be implemented as a single integral body. For example, the single integral body may be extended along the circumferential direction having a constant radial distance from the center of the cylindrical portion 2213.

The stoppers 2211b may have a substantially rectangular prism shape. For example, the stoppers 2211b may limit the range of relative rotation with respect to the driven gear 2251.

The driven gear 2251 may include, on a surface facing the bottom surface 2211a of the lower case 2211, stopper grooves 2251b formed in its circumferential direction. A plurality of stopper grooves 2251b corresponding to the number of unit stoppers may be provided. The stopper grooves 2251b may be arranged at equal intervals or within equal angular ranges.

Electrically driven folding rotation may be performed from a first position P1, where one stopper 2211b abuts one side of a stopper groove 2251b, to a second position P2, where another stopper 2211b abuts the opposite side of the stopper groove 2251b. The folding-rotation range from the first position P1 to the second position P2 may correspond to the range of relative rotation between the lower case 2211 and the driven gear 2251.

For example, when the lower case 2211 rotates relative to the driven gear 2251 in one direction and abutment occurs between the stoppers 2211b and the stopper grooves 2251b, if a greater external force is applied in the same direction, the driven gear 2251 and the sub gear 2255 may be separated from each other so that manual rotation may be accommodated, as described above with reference to FIG. 39. Such a structure, in which electric rotation is limited, may be applied in regions where the folding/unfolding function of the side mirror assembly 100 is not actively used.

Accordingly, in the drive device for the side mirror assembly for a vehicle according to this embodiment, by mounting the first motor for folding, the second motor for tilting, and the board on a single motor installation unit, assemblability can be improved and installation space can be reduced. In addition, packaging of the drive device can increase freedom for mirror-design improvements. Moreover, unwanted movement of the third worm gear between the tilting-rotation unit and the lower case can be prevented. Furthermore, when an external force is applied to the mirror housing, manual folding rotation is allowed, thereby preventing damages to the first drive unit and the fixing module.

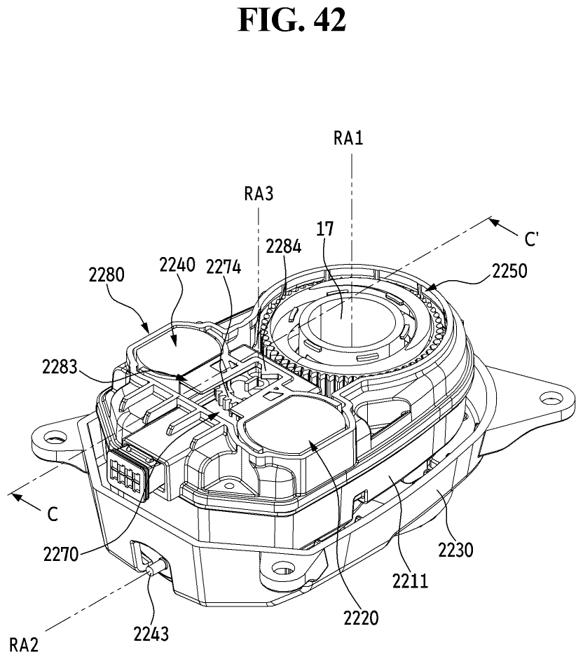

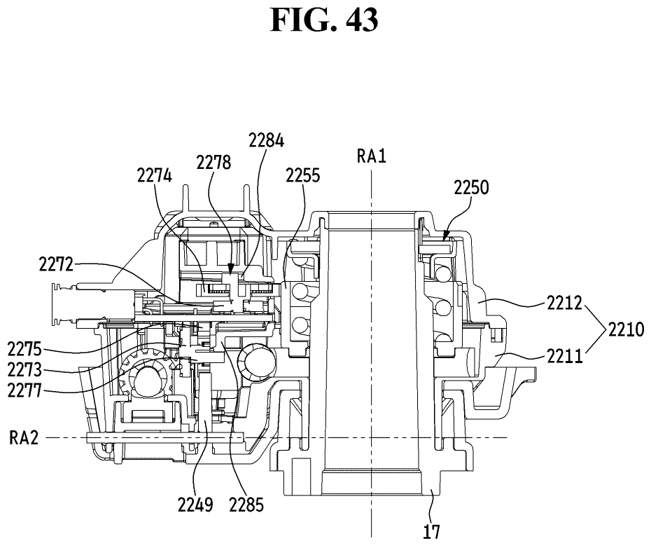

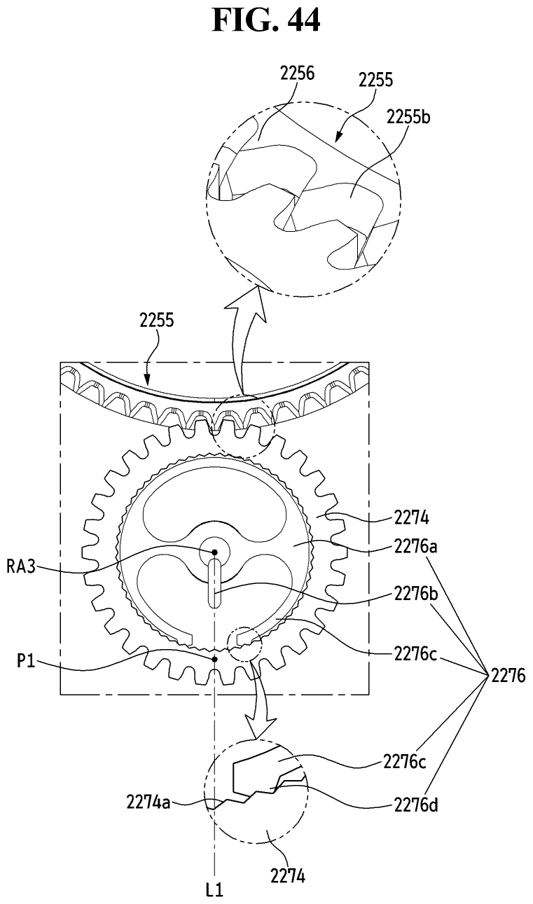

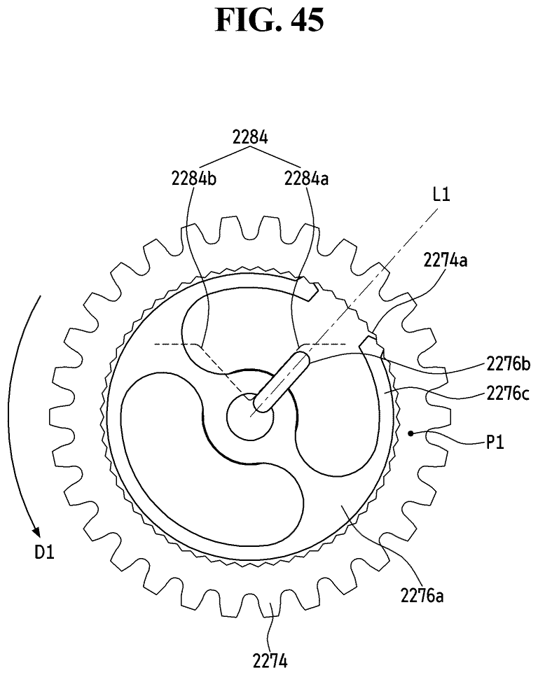

FIG. 42 is a cross-sectional perspective view illustrating a transverse section of the drive device illustrated in FIG. 28, FIG. 43 is a cross-sectional view illustrating a C-C′ section of the drive device illustrated in FIG. 42, FIG. 44 is a reference view illustrating a first potentiometer of the drive device illustrated in FIG. 42, and FIG. 45 is a reference view illustrating a process in which the first potentiometer of the drive device illustrated in FIG. 44 senses an initial position.

Referring to FIGS. 42 to 45, the control module 2270 of the drive device 2000 according to this embodiment may set initial positions for folding rotation and tilting rotation by detecting folding rotation of the motor housing 2210 and/or tilting rotation of the tilting-rotation unit 2230.

As described above, the control module 2270 may include the board 2271, the first potentiometer 2272 that detects rotation of the first drive unit 2220, and the second potentiometer 2273 that detects rotation of the second drive unit 2240. Since the functions and operation of each of the first and second potentiometers 2272 and 2273 are as previously described, redundant explanation will be omitted, and the detailed structures of the first and second potentiometers 2272 and 2273 will hereinafter be described.

The first and second potentiometers 2272 and 2273 may each be mounted on the board 2271, and the board 2271 may be detachably coupled to the third mounting portion 2283 of the motor installation unit 2280.

The first potentiometer 2272 may include the first gear 2274 and a first position-setting portion 2276. The first gear 2274 may mesh with the gear teeth 2256 of the sub gear 2255 and rotate relative to or revolve around the sub gear 2255 when the motor housing 2210 rotates about the first rotation axis RA1 (see FIG. 30). Referring to FIG. 44, the first position-setting portion 2276 may be disposed inside the first gear 2274. On the inner surface of the first gear 2274, a first tooth pattern 2274a of an internal-gear type may be formed in a region facing the outer circumferential surface of the first position-setting portion 2276.

The first position-setting portion 2276 may be provided on the first gear 2274 coaxially with the rotation axis of the first gear 2274, i.e., a third rotation axis RA3. That is, the first position-setting portion 2276 may be arranged to be rotatable relative to the first gear 2274.

The first position-setting portion 2276 may include a first rotor 2276a, a first contact portion 2276b, first leg portions 2276c, and first contact pieces 2276d. The first rotor 2276a may be arranged to rotate about the same rotation axis as the first gear 2274, i.e., the third rotation axis RA3, and may be at least partially accommodated within the first gear 2274. Most of the outer region of the first rotor 2276a may be configured not to contact the first gear 2274. The first rotor 2276a may be formed as a generally circular plate, and the first contact portion 2276b may be arranged adjacent to the third rotation axis RA3.

The first contact portion 2276b may project upward from a central region of the upper surface of the first rotor 2276a. The first contact portion 2276b may be arranged to contact a first stopper 2284 that will be described later.

The first leg portions 2276c may be arranged on both sides of a cutout portion along the circumferential direction of the first rotor 2276a. For example, the first leg portions 2276c may correspond to opposite sides of a break in a ring-like structure. Thus, a pair of first leg portions 2276c may be provided on respective sides of the cutout portion and may be arranged to be elastically bent from the outer circumferential surface of the first rotor 2276a.

The first contact pieces 2276d may be provided at distal ends of the respective first leg portions 2276c. The first contact pieces 2276d may protrude further from the outer circumferential surface of the first rotor 2276a to contact the first tooth pattern 2274a of the first gear 2274. Accordingly, when the first rotor 2276a rotates relative to the first gear 2274, the first contact pieces 2276d may elastically contact the first tooth pattern 2274a, and when the relative rotation stops, the first contact pieces 2276d may maintain the rotated state of the first rotor 2276a with respect to the first gear 2274.

The motor installation unit 2280 may include the first stopper 2284. The first stopper 2284 may be provided inside the third mounting portion 2283 of the motor installation unit 2280 (see FIG. 35).

The first stopper 2284 may be arranged within the radius of rotation of the first contact portion 2276b and may limit relative rotation of the first rotor 2276a with respect to the first gear 2274 as the first contact portion 2276b rotates. Referring to FIG. 45, the first stopper 2284 may have a substantially triangular profile, and may include a first contact surface 2284a configured to abut one surface of the first contact portion 2276b when the first rotor 2276a rotates in one direction, and a second contact surface 2284b configured to abut the other surface of the first rotor 2276a when the first rotor 2276a rotates in the opposite direction. The inner angle between the first and second contact surfaces 2284a and 2284b may be set to an acute angle. That is, the rotation range of the first contact portion 2276b may be limited by the inner angle between the first and second contact surfaces 2284a and 2284b. Alternatively, the inner angle between the first and second contact surfaces 2284a and 2284b may be a right or obtuse angle.

The sub gear 2255 that meshes with the first gear 2274 may be formed with chamfers 2255b. The chamfers 2255b may be formed at the leading ends of the respective gear teeth of the sub gear 2255, where engagement with the first gear 2274 begins, so that the width of the gear teeth of the sub gear 2255 is reduced toward the distal ends. Accordingly, meshing may be facilitated along the chamfers 2255b.

Referring to FIG. 44, the first contact portion 2276b may be arranged to face a virtual first point P1 defined on the first gear 2274. That is, a virtual straight line L1 connecting the center of rotation of the first gear 2274 and the longitudinal center of the first contact portion 2276b meets the first point P1. The state in which the center of the first contact portion 2276b and the first point P1 lie on the virtual straight line L1 is assumed to be a reference (base) position.

Unlike the state illustrated in FIG. 44, during assembly of the first potentiometer 2272, the first gear 2274 and the first position-setting portion 2276 may be placed at a position deviating from the reference position (i.e., not meeting the first point P1), as illustrated in FIG. 45. In this case, a position correction for placing the first gear 2274 and the first position-setting portion 2276 at the reference position may be performed after assembly of the first potentiometer 2272 is completed.

For the position correction, the first position-setting portion 2276 may need to be rotated relative to the first gear 2274 as illustrated in FIG. 45. For example, when the first gear 2274 rotates in one direction, the first contact portion 2276b contacts the first contact surface 2284a of the first stopper 2284. At this time, rotation of the first position-setting portion 2276 may be limited by the first stopper 2284, whereas the first gear 2274 may continue to rotate. Thus, only the first gear 2274 may rotate relative to the fixed first rotor 2276a, and when the rotation of the first gear 2274 is stopped at a position where the first contact portion 2276b meets the first point P1, position correction to the reference position may be completed.

Referring to FIG. 45, the position correction to the reference position may be performed by rotating the first gear 2274 in one direction (e.g., a clockwise direction). Alternatively, position correction to the reference position may also be performed by rotating the first gear 2274 in the opposite direction (e.g., a counterclockwise direction).

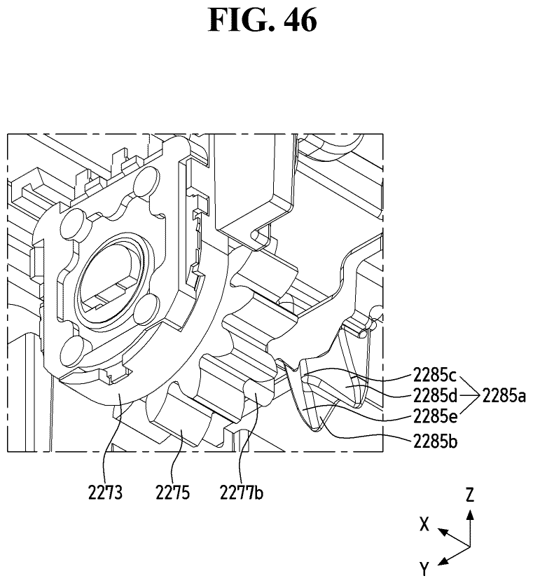

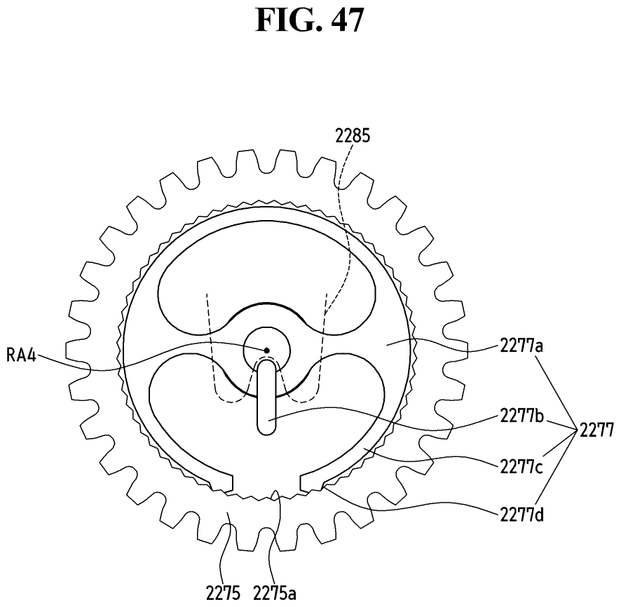

FIG. 46 is a reference view illustrating a state before the second potentiometer and a second stopper of the drive device illustrated in FIG. 41 are assembled, and FIG. 47 is a reference view illustrating a process in which the second potentiometer senses an initial position.

Referring to FIGS. 46 and 47, the second potentiometer 2273 may include the second gear 2275 and a second position-setting portion 2277. The second gear 2275 may mesh with the tilting worm wheel 2249 and rotate when the tilting-rotation unit 2230 (see FIG. 42) rotates about the second rotation axis RA2 with respect to the lower case 2211 (see FIG. 41). The second position-setting portion 2277 may be mounted inside the second gear 2275. On the inner surface of the second gear 2275, a second tooth pattern 2275a of an internal-gear type may be formed in a region facing the outer circumferential surface of the second position-setting portion 2277.

The second position-setting portion 2277 may be provided on the second gear 2275 coaxially with the rotation axis of the second gear 2275, i.e., a fourth rotation axis RA4. That is, the second position-setting portion 2277 may be arranged to be rotatable relative to the second gear 2275. The rotation axis of the first gear 2274, i.e., the third rotation axis RA3, and the fourth rotation axis RA4 may be arranged orthogonally.

The second position-setting portion 2277 may include a second rotor 2277a, a second contact portion 2277b, second leg portions 2277c, and second contact pieces 2277d. The structure of the second position-setting portion 2277 may be similar to that of the first position-setting portion 2276, and thus, a detailed description thereof will be omitted.

The motor installation unit 2280 may include a second stopper 2285. The second stopper 2285 may be provided inside the third mounting portion 2283 of the motor installation unit 2280 (see FIG. 35). The second stopper 2285 may include a projection member 2285a and a guide member 2285b.

The projection member 2285a may project toward the second contact portion 2277b along the axial direction of the second rotor 2277a and guide the operating position of the second contact pieces 2277d. That is, the projection member 2285a may function to allow the second contact portion 2277b to be smoothly inserted into the guide member 2285b. The projection member 2285a may include a tip portion 2285c, a first guide portion 2285d, and a second guide portion 2285e.

The tip portion 2285c may protrude convexly toward the center of rotation of the second rotor 2277a and set an entry direction when the second rotor 2277a first contacts the projection member 2285a. In other words, while contacting the tip portion 2285c, the second rotor 2277a may be guided to rotate and move toward either the first guide portion 2285d or the second guide portion 2285e.

The first guide portion 2285d may guide the second rotor 2277a from the tip portion 2285c toward the guide member 2285b when the second rotor 2277a rotates in one direction about its central axis, and the second guide portion 2285e may guide the second rotor 2277a from the tip portion 2285c toward the guide member 2285b when the second rotor 2277a rotates in the opposite direction. The first and second guide portions 2285d and 2285e may be formed so that their area or width increases from the apex of the tip portion 2285c along X- and Z-axis directions, and may be formed as inclined or curved surfaces.

The guide member 2285b may define a second reference range corresponding to the radius of rotation of the second contact portion 2277b as the second contact portion 2277b is assembled through the projection member 2285a. The guide member 2285b may extend downward on both sides in a “∧” shape by an amount corresponding to the rotation range of the second contact portion 2277b about the rotation axis of the second gear 2275, i.e., the fourth rotation axis RA4.

Accordingly, when the second contact portion 2277b is assembled with the second stopper 2285, no separate position adjustment is required, and the second contact portion 2277b can rotate into and be assembled with the guide member 2285b from any initial position.

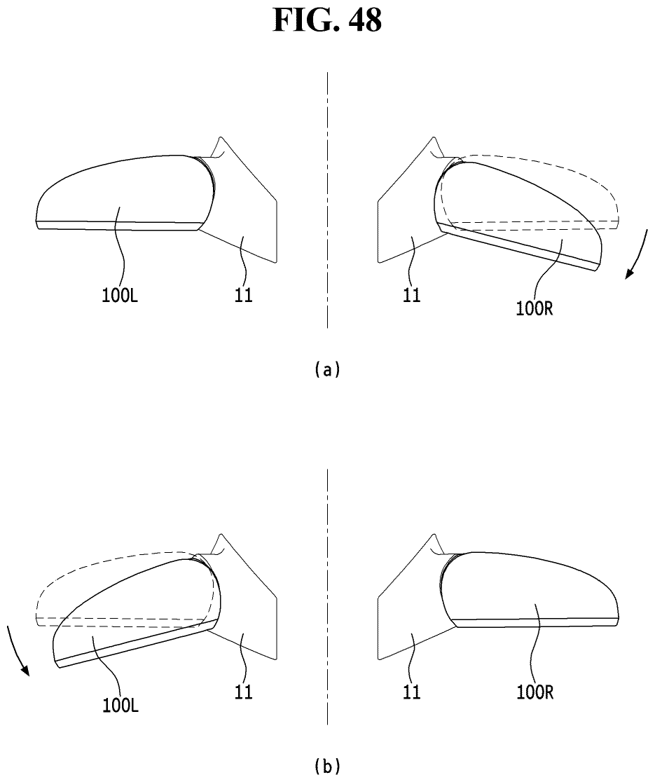

FIG. 48 shows reference views illustrating the side mirror assembly illustrated in FIG. 1. Panel (a) of FIG. 48 shows setting values for a side mirror assembly of a vehicle with the steering wheel on the left side (e.g., United States and Korea), and panel (b) of FIG. 48 shows setting values for a side mirror assembly of a vehicle with the steering wheel on the right side (e.g., Japan and the United Kingdom).

Referring to panel (a) of FIG. 48, since the driver is seated on the left side with respect to the traveling direction of the vehicle, the angle of a right-hand side mirror assembly 100R may be set to be rotated toward the driver. Referring to panel (b) of FIG. 48, since the driver is seated on the right side with respect to the traveling direction of the vehicle, the angle of a left-hand side mirror assembly 100L may be set to be rotated toward the driver.

Such setting values of the side mirror assembly of FIG. 1 may be automatically applied depending on power on/off, or on the vehicle's driving mode (P, R, N, or D), and may also be automatically set to a memory value configured by each driver.

Accordingly, in the drive device according to this embodiment, the base position of the first potentiometer and/or the second potentiometer can be corrected during assembly of the control module, the assemblability of the control module can be improved, and the application to stopper structures of various shapes and rotation ranges can be facilitated.

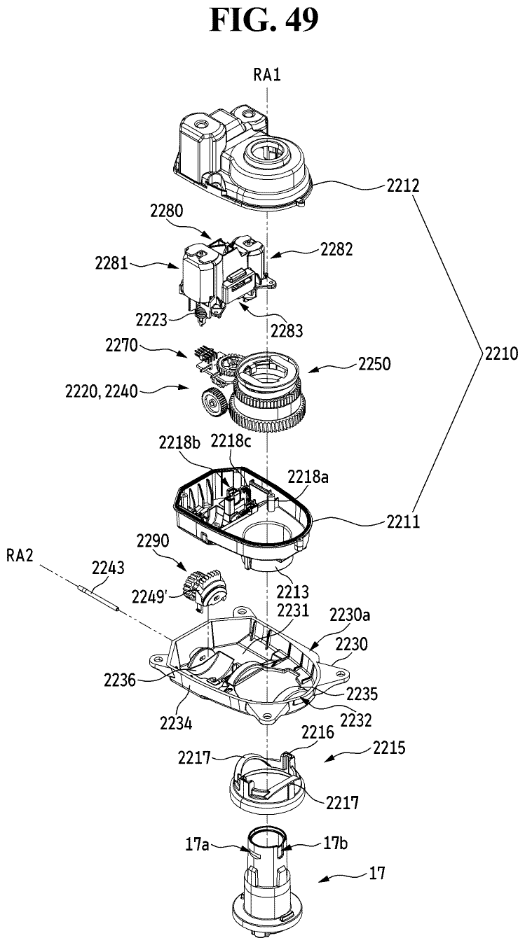

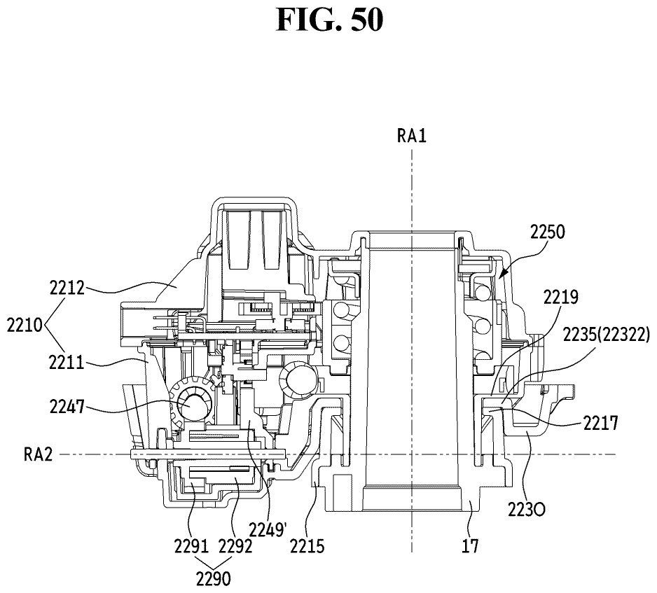

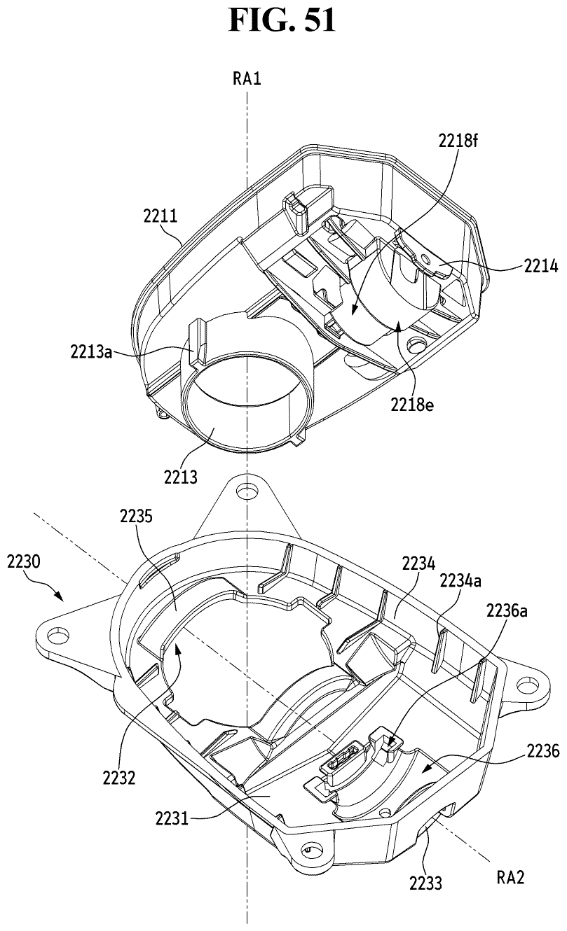

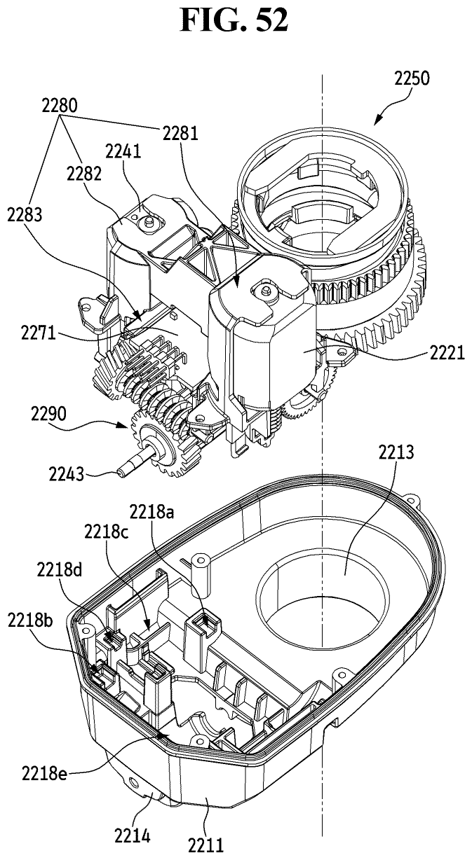

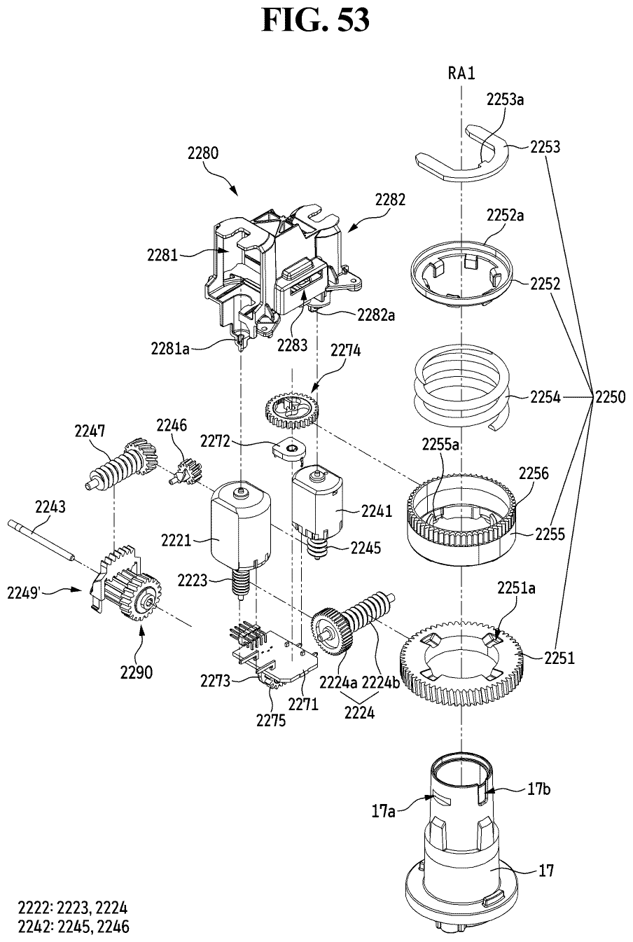

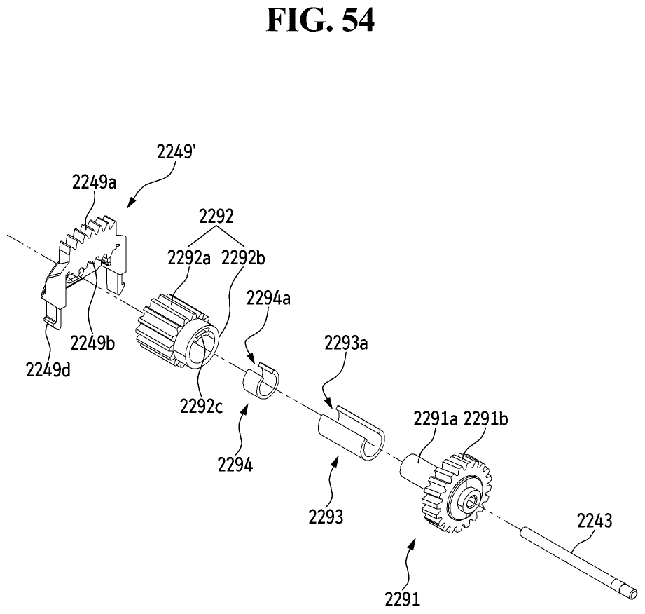

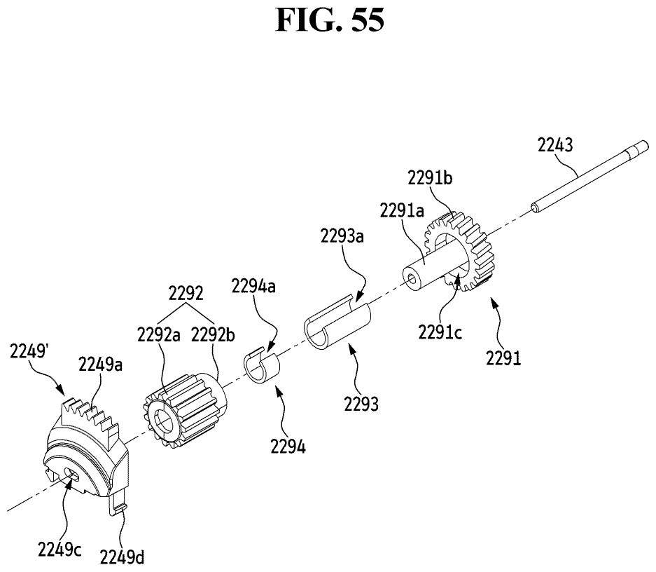

FIG. 49 is an exploded perspective view illustrating a drive device for a side mirror assembly for a vehicle according to a fourth embodiment of the present disclosure in a disassembled state, FIG. 50 is a longitudinal cross-sectional view illustrating the drive device illustrated in FIG. 49, FIG. 51 is a reference view illustrating a coupled state between a lower case and a tilting-rotation unit at a second support of the drive device illustrated in FIG. 49, FIG. is a reference view illustrating a state in which an upper case of the drive device illustrated in FIG. 49 is removed for illustration purposes, FIG. 53 is an exploded perspective view illustrating a first drive unit and a second drive unit of the drive device illustrated in FIG. 52, and FIGS. 54 and 55 are exploded perspective views illustrating a clutch unit of the drive device illustrated in FIG. 53. In the following description, identical reference numerals denote identical elements, and thus, repeated descriptions will be omitted.

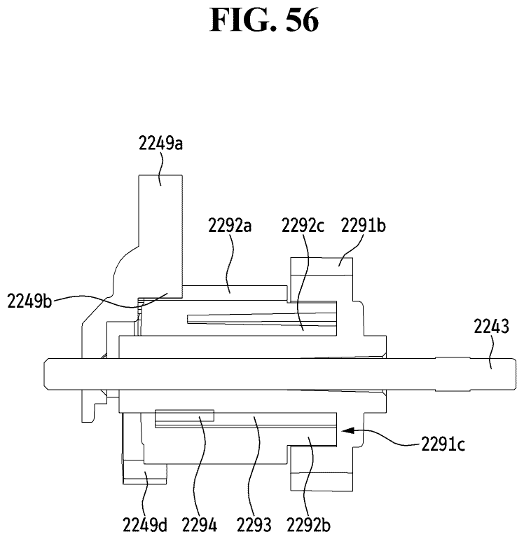

Referring to FIGS. 49 to 56, a lower case 2211 may be formed with a fourth installation portion 2218e in which a clutch unit 2290 to be described below is accommodated, and a second opening 2218f through which a tilting worm wheel 2249′ provided on a tilting-rotation unit 2230 extends into the interior of the lower case 2211.

A second potentiometer 2273 may be provided with a second gear 2275 arranged to be rotatable on a board 2271, and the second gear 2275 may mesh with a fifth gear portion 2249a formed on the tilting worm wheel 2249′. Accordingly, the tilting-rotation angle of the tilting-rotation unit 2230 may be sensed based on the rotation angle of the second gear 2275 relative to rotation of the tilting worm wheel 2249′ about a shaft 2243.

The tilting-rotation unit 2230 may be formed with a mounting groove 2236 on a bottom surface 2231 corresponding to the fourth installation portion 2218e. A mounting hole 2236a, into which the tilting worm wheel 2249′ is coupled, may be formed near the mounting groove 2236.

The clutch unit 2290 may include a third worm gear 2291, a clutch gear 2292, a clutch spring 2293, and a second support piece 2294. The clutch unit 2290 may transmit the rotational force of a second drive unit 2240 about a second rotation axis RA2 within the lower case 2211 to the tilting-rotation unit 2230 while preventing reverse transmission of rotational force from the tilting-rotation unit 2230 toward the second drive unit 2240. This can prevent damage to at least one power-transmission component provided between the second drive unit 2240 and the tilting-rotation unit 2230 when an external force is applied from outside.

The third worm gear 2291 may include a rotating body 2291a and a third gear portion 2291b. The rotating body 2291a may be arranged to surround the shaft 2243 and to be rotatable about the shaft 2243. The rotating body 2291a may be formed as a substantially hollow cylinder, and the third gear portion 2291b may be provided at one end thereof.

The third gear portion 2291b may project outward from one end of the rotating body 2291a to mesh with a third reduction gear 2247 of the second drive unit 2240. Accordingly, rotational force for tilting rotation transmitted to the third reduction gear 2247 may be transmitted to a clutch gear 2292 through the third worm gear 2291.

An insertion groove 2291c may be formed at one end of the third worm gear 2291 adjacent to the rotating body 2291a and the third gear portion 2291b. The insertion groove 2291c may be a ring-shaped groove formed along the outer circumferential surface of the rotating body 2291a inside the third gear portion 2291b. A portion of the clutch gear 2292 may be inserted into the insertion groove 2291c.

The clutch gear 2292 may include a fourth gear portion 2292a, an insertion body 2292b, and a projection piece 2292c. The fourth gear portion 2292a may be coupled to surround the rotating body 2291a. The second gear 2275 may mesh with the tilting worm wheel 2249′. Accordingly, the rotational force for tilting rotation, transmitted to the third worm gear 2291, may be transmitted to the tilting worm wheel 2249′ through the clutch gear 2292. The tilting worm wheel 2249′ may be coupled to the tilting-rotation unit 2230 so that the rotation force transmitted to the tilting worm wheel 2249′ may be delivered as the tilting-rotation force of the tilting-rotation unit 2230.

The insertion body 2292b may protrude integrally from one side of the fourth gear portion 2292a and may be at least partially inserted into the insertion groove 2291c together with the projection piece 2292c.

The projection piece 2292c may protrude along the direction of the second rotation axis RA2 within the fourth gear portion 2292a and the insertion body 2292b. For example, the projection piece 2292c may function as a key that fixes a pulley to a shaft. The projection piece 2292c may be arranged to contact or engage with the clutch spring 2293.

The clutch spring 2293 may be formed as a hollow cylindrical spring having an opening 2293a so that one side is open along the direction of the second rotation axis RA2. Thus, one cross section of the clutch spring 2293 may generally be “C”-shaped. The clutch spring 2293 may be fitted around and pressed against the outer circumferential surface of the rotating body 2291a. In this case, the clutch spring 2293 may be closely engaged with the rotating body 2291a through its elastic restoring force. When a rotational force greater than the elastic restoring force occurs while the clutch spring 2293 is in close contact with the rotating body 2291a, slip may occur on the rotating body 2291a, allowing relative rotation.

While being coupled to the rotating body 2291a, the clutch spring 2293 may be inserted into the clutch gear 2292, and the opening 2293a may be coupled to correspond to the projection piece 2292c.

The clutch unit 2290 may be arranged to be rotatable about the shaft 2243 along the second rotation axis RA2.

The second support piece 2294 may support the other end of the rotating body 2291a so as to prevent eccentricity, such that the inner circumferential surface of the fourth gear portion 2292a is concentric with the shaft 2243. Since the projection piece 2292c is provided inside the fourth gear portion 2292a, the second support piece 2294 may be formed with a second opening 2294a corresponding to the projection piece 2292c, and may be coupled with the clutch spring 2293 to support the rotating body 2291a to prevent eccentricity inside the clutch gear 2292. Alternatively, the second support piece 2294 may be formed integrally with the other end of the clutch spring 2293. The shaft 2243 may be inserted into the other end of the fourth gear portion 2292a of the clutch gear 2292 to pass through, and the other end of the fourth gear portion 2292a may be partially closed so that the second support piece 2294 cannot pass through.

The tilting worm wheel 2249′ may include a fifth gear portion 2249a provided on the outer upper side of the tilting worm wheel 2249′ and a sixth gear portion 2249b provided on the inner lower side of the tilting worm wheel 2249′. The tilting worm wheel 2249′ may be detachably coupled to the tilting-rotation unit 2230. The tilting worm wheel 2249′ may be arranged to pass through the lower side of the lower case 2211 so as to be exposed inside the lower case 2211.

The fifth gear portion 2249a may be arranged to mesh with the second gear 2275 connected to a second potentiometer 2273 so as to provide tilting-rotation information to the second potentiometer 2273.

The sixth gear portion 2249b may be arranged to mesh with the fourth gear portion 2292a of the clutch gear 2292. Below the sixth gear portion 2249b, the tilting worm wheel 2249′ may be formed with a shaft hole 2249c through which the shaft 2243 passes.

The tilting worm wheel 2249′ may be detachably coupled to the tilting-rotation unit 2230. In this case, fastening hooks 249d may be provided at both ends to be inserted into the tilting-rotation unit 2230.

Accordingly, when rotational force is generated in the third worm gear 2291, the clutch spring 2293 rotates, and the clutch gear 2292 also rotates because it locks with the clutch spring 2293 by the projection piece 2292c. When the clutch gear 2292 rotates, the tilting worm wheel 2249′ rotates, and as a result, the tilting-rotation unit 2230 may perform tilting rotation. Conversely, when an external force acts on the tilting-rotation unit 2230, the tilting worm wheel 2249′ rotates together and drives the clutch gear 2292. Since the third worm gear 2291 is in mesh with the second drive unit 2240 and cannot rotate, slip may occur between the clutch gear 2292 and the rotating body 2291a. That is, although due to interference with the projection piece 2292c, the clutch spring 2293 rotates together with the clutch gear 2292 as the clutch gear 2292 rotates, slip is allowed between the clutch gear 2292 and the rotating body 2291a so that they may rotate relative to each other. Thus, the clutch unit 2290 can prevent damage between the second drive unit 2240 and the tilting-rotation unit 2230 due to external force.

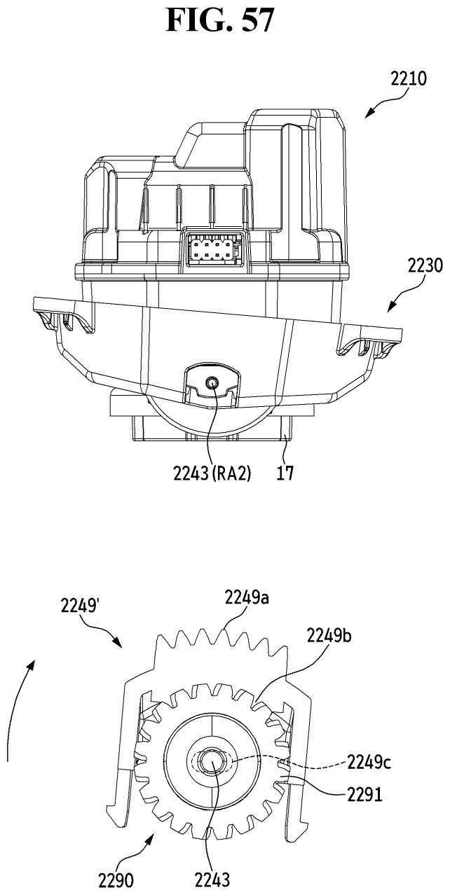

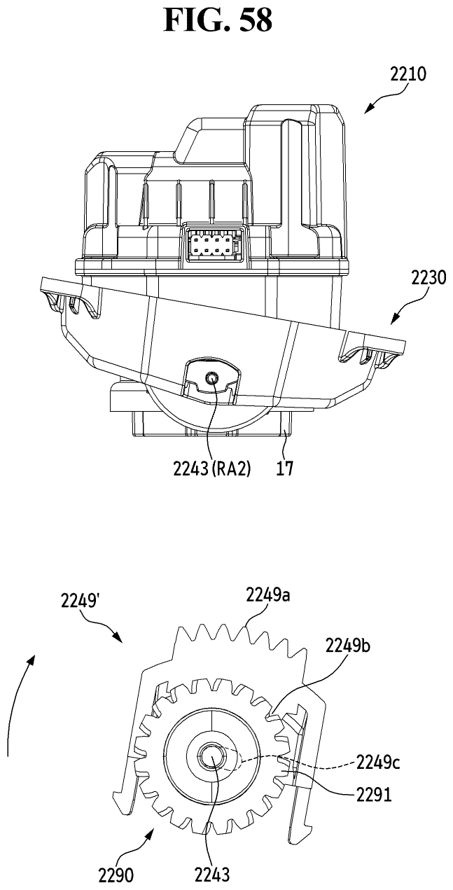

FIGS. 57 and 58 are reference views illustrating the clutch unit of FIG. 54 in an operating state.

Referring to FIGS. 57 and 58, the shaft hole 2249c of the tilting worm wheel 2249′ may be formed as an elongated slot. When the fourth and sixth gear portions 2292a and 2249b mesh and rotate relative to each other, the tilting worm wheel 2249′ may move while rotating along the slot direction of the shaft hole 2249c.

As illustrated in FIG. 57, when the clutch unit 2290 rotates, the fourth gear portion 2292a may mesh with the sixth gear portion 2249b, thereby rotating the tilting worm wheel 2249′. In this case, although the shaft 2243 passes through the shaft hole 2249c and is fixed in position on the lower case 2211, the tilting worm wheel 2249′ may undergo a predetermined horizontal movement.

As illustrated in FIG. 58, as the clutch unit 2290 rotates further from the state illustrated in FIG. 57, the tilting worm wheel 2249′ moves further to the right about the shaft 2243. At this time, the clutch unit 2290 may undergo only rotation about the shaft 2243.

The center of rotation of the tilting worm wheel 2249′ may be disposed above or below the shaft 2243, rather than on the shaft 2243. Therefore, when the clutch gear 2292 rotates, the tilting worm wheel 2249′ may experience horizontal movement together with rotation.

Accordingly, in the drive device of this embodiment, by providing a clutch unit on the path along which the tilting rotational force from the second drive unit is transmitted, damage to the second drive unit caused by external force can be prevented, and when an external force greater than a predetermined threshold is applied, manual rotation is enabled while the second drive unit is at rest.

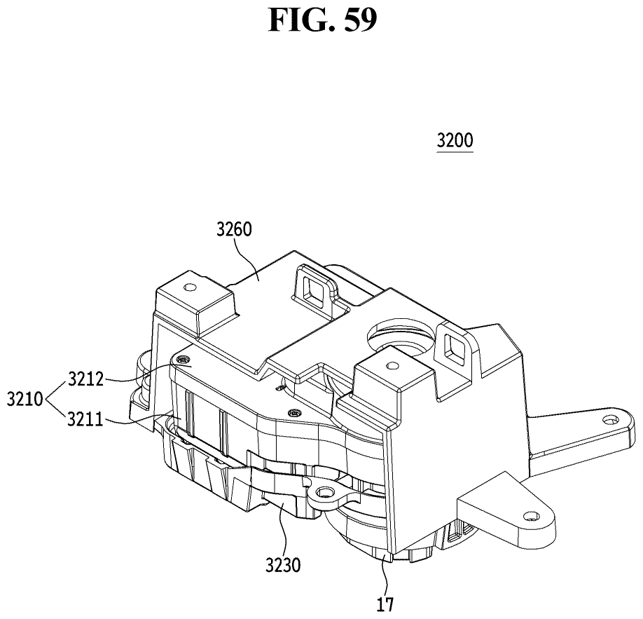

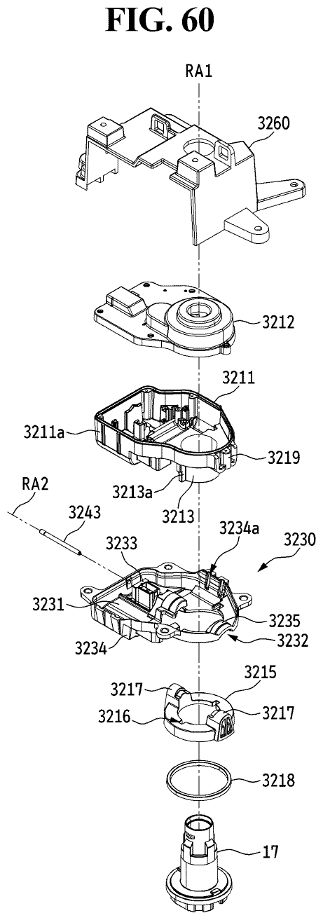

FIG. 59 is a perspective view illustrating a drive device for a frameless mirror assembly for a vehicle according to a fifth embodiment of the present disclosure, and FIG. 60 is an exploded perspective view illustrating the drive device illustrated in FIG. 59 in a disassembled state.

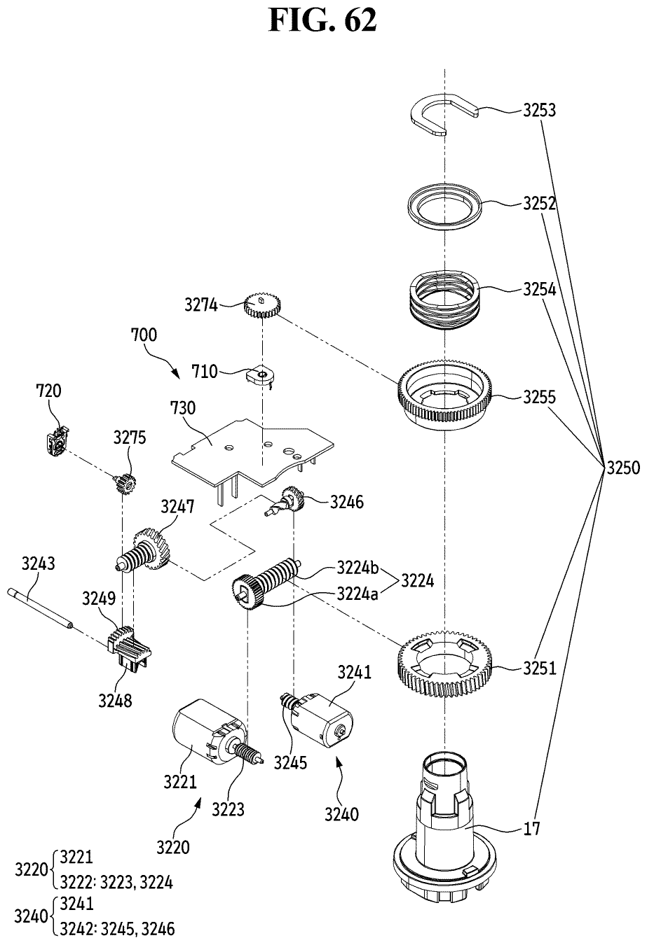

Referring to FIGS. 59 and 60, a frameless mirror assembly 100 for a vehicle may include a drive device 3200 for a vehicle side mirror. The drive device 3200 may include: a motor housing 3210 provided inside a mirror housing 110 (see FIG. 6); a first drive unit 3220 that participates in folding rotation of the mirror housing 110; a tilting-rotation unit 3230; a second drive unit 3240 that participates in tilting rotation of the tilting-rotation unit 3230; and a fixing module 3250 and a control module 700 (see FIG. 62) that are provided on a fixing part 17.

The motor housing 3210 may include a lower case 3211 and an upper case 3212. The lower case 3211 may be disposed inside a lower housing 111, and the upper case 3212 may be coupled to the upper side of the lower case 3211 to form the motor housing 3210. In this case, although the motor housing 3210 is disposed inside the mirror housing 110, it may be coupled not to the mirror housing 110 but only to the fixing part 17. For example, the first drive unit 3220 may drive folding rotation of the mirror housing 110 to provide relative rotation of the motor housing 3210 with respect to the fixing module 3250 about a first rotation axis RA1 formed on the fixing part 17, and the second drive unit 3240 may provide relative rotation to the tilting-rotation unit 3230 about a second rotation axis RA2 formed between the motor housing 3210 and the tilting-rotation unit 3230, thereby providing tilting drive of the mirror housing 110.

The lower case 3211 may include a cylindrical portion 3213 and a tilting-shaft fastening portion 3214. The cylindrical portion 3213 may protrude downward from one side of the lower case 3211 and may be formed in a cylindrical shape to surround the fixing part 17 when the fixing part 17 is inserted at its center.

A support member 3215 may additionally be fastened around the cylindrical portion 3213. As the support member 3215 is fastened around the cylindrical portion 3213 with a portion of the tilting-rotation unit 3230 interposed between the lower case 3211 and the support member 3215, the support member 3215 may support one side of the tilting-rotation unit 3230.

The support member 3215 may include guide members 3216 that guide the correct orientation for coupling to the lower case 3211. The guide members 3216 may be formed as one or more projection-and-groove structures facing the lower side of the lower case 3211. In this embodiment, by way of example, one or more groove-type guide members 3216 arranged along a straight line may be provided on the upper surface of the support member 3215. One or more projections 3213a having a shape corresponding to the guide members 3216 may be formed on the outer circumferential surface of the cylindrical portion 3213 of the lower case 3211. Accordingly, the coupling direction of the support member 3215 to the lower case 3211 may be set by the guide members 3216. In addition, the guide members 3216 and the projections 3213a may engage with each other along the folding-rotation direction so that the support member 3215 and the cylindrical portion 3213 may rotate together when the motor housing 3210 folds.

The support member 3215 may further include a pair of support ends 3217 that project toward the bottom surface of the lower case 3211. The support ends 3217 may be spaced apart from each other along the axial direction of the second rotation axis RA2 around the cylindrical portion 3213 and may rotatably support one side of the tilting-rotation unit 3230 to be described later.

The support member 3215 may be arranged to be rotatable on the fixing part 17 by the folding rotation. In this case, a bushing 3218 may additionally be provided at a region where the support member 3215 and the fixing part 17 contact each other.

The tilting-shaft fastening portion 3214 may support the other side of the tilting-rotation unit 3230 at the other side of the lower case 3211. A shaft 3243, arranged on the second rotation axis RA2 of the lower case 3211, may be fastened to the tilting-shaft fastening portion 3214, and the tilting-rotation unit 3230 may be coupled on the shaft 3243 so as to be rotatable about the second rotation axis RA2.

The tilting-rotation unit 3230 may be arranged to rotate relative to the motor housing 3210 about the second rotation axis RA2 (i.e., the tilting-rotation axis) formed at a lower center of the motor housing 3210. The tilting-rotation unit 3230 may rotate in a tilting direction by being driven by the second drive unit 3240. In this case, the tilting-rotation unit 3230 may perform tilting rotation about the second rotation axis RA2 together with the mirror housing 110 and a reflection part 120.

The tilting-rotation unit 3230 may include a bottom surface 3231, a first support 3232, a second support 3233, and a sidewall 3234. The bottom surface 3231 may be arranged to face the bottom surface of the lower case 3211 with a gap therebetween. The bottom surface 3231 and the lower case 3211 may be spaced apart from each other to allow relative rotation associated with tilting rotation.

A first support 3232 and a second support 3233 may be arranged on the bottom surface 3231 to be spaced apart from each other. The first support 3232 may support one side of the bottom surface with respect to the second rotation axis RA2, and the second support 3233 may support the other side of the bottom surface 3231 with respect to the second rotation axis RA2.

The first support 3232 may include a pair of support pieces 3235 that are spaced apart from each other along the second rotation axis RA2 with respect to the cylindrical portion 3213. The support pieces 3235 may be arranged on the respective support ends 3217 of the support member 3215 so as to be in surface contact.

The sidewall 3234 may be arranged to face both side surfaces of the lower case 3211 and to surround the lower case 3211. Accordingly, the tilting-rotation unit 3230 may be arranged to be tiltable about the second rotation axis RA2 on the lower case 3211.

The tilting-rotation unit 3230 may also be disposed inside the mirror housing 110 together with a fixing frame 3260. Although the tilting-rotation unit 3230 is fastened only on the lower case 3211, with the fixing frame 3260 further provided, the tilting-rotation unit 3230 may be firmly fastened to the upper housing 112 and the back plate 130 via the fixing frame 3260. The fixing frame 3260 may perform tilting rotation about the second rotation axis RA2 together with the mirror housing 110 and may more firmly support the structure in which the tilting-rotation unit 3230 rotates inside the mirror housing 110.

A detailed description will now be given of the fixing module 3250 and the control module 700.

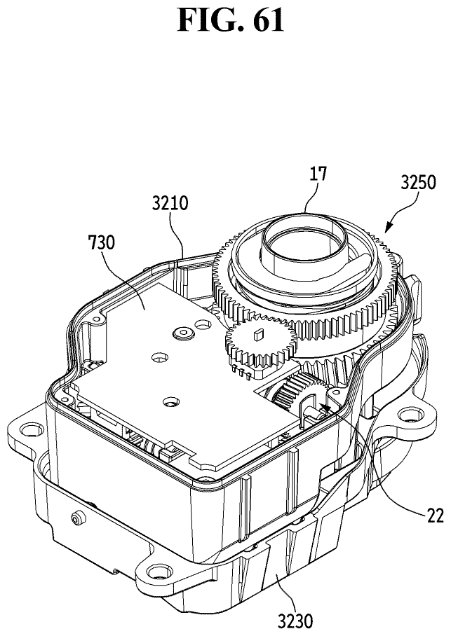

FIG. 61 is a reference view illustrating a state in which the upper case of the drive device illustrated in FIG. 59 is removed for illustration purposes, and FIG. 62 is an exploded perspective view illustrating the first and second drive units of the drive device illustrated in FIG. 61.

Referring to FIGS. 61 and 62, the first drive unit 3220 may include a first motor 3221 and a first gear module 3222. Accordingly, the first drive unit 3220 may enable folding rotation via the final output of the first gear module 3222 in response to rotation of the first motor 3221.

The first gear module 3222 may include a first worm gear 3223 and a first reduction gear 3224. The first worm gear 3223 may be coupled to the rotation shaft of the first motor 3221. The first worm gear 3223 may transmit rotational force to the first reduction gear 3224.

The first reduction gear 3224 may mesh with the first worm gear 3223, and the rotation shaft of the first reduction gear 3224 may be arranged in a direction different from that of the rotation shaft of the first worm gear 3223. The first reduction gear 3224 may include a plurality of first gears 3224a and a second gear 3224b that provide a predetermined gear ratio and rotate together.

Accordingly, the final output of the first gear module 3222 may be delivered to the first reduction gear 3224. A driven gear 3251 of the fixing module 3250 may mesh with the second gear 3224b of the first reduction gear 3224, and the motor housing 3210 may rotate relative to the driven gear 3251 so that folding rotation may occur.

The second drive unit 3240 may include a second motor 3241, a second gear module 3242, and a shaft 3243. The second gear module 3242 may include a second worm gear 3245 and a second reduction gear 3246. The second worm gear 3245 may be coupled to the rotation shaft of the second motor 3241. The second worm gear 3245 may transmit rotational force to the second reduction gear 3246.

The second reduction gear 3246 may mesh with the second worm gear 3245, and the rotation shaft of the second reduction gear 3246 may be arranged in a direction different from that of the rotation shaft of the second worm gear 3245. The second reduction gear 3246 may include a plurality of gears that provide a predetermined gear ratio and rotate together.

The second drive unit 3240 may further include a third reduction gear 3247 that meshes with the second reduction gear 3246. In this case, the second and third reduction gears 3246 and 3247 may provide different gear ratios. The third reduction gear 3247 may transmit final output to the shaft 3243 connected to a third worm gear 3248.

The fixing module 3250 may elastically support the motor housing 3210 on the fixing part 17. The fixing module 3250 may include the driven gear 3251, a clip plate 3252, a clip 3253, an elastic member 3254, and a sub gear 3255.

The driven gear 3251 may be disposed within the motor housing 3210 so that the fixing part 17 extends into the interior of the motor housing 3210. Although the driven gear 3251 is coupled to and fixed on the fixing part 17 and therefore does not rotate with respect to the fixing part 17, rotational force transmitted from the first reduction gear 3224 to the driven gear 3251 may cause the motor housing 3210 to rotate relative to the driven gear 3251, thereby producing folding rotation. That is, the driven gear 3251 may be fixed to the fixing part 17, and the first reduction gear 3224 may rotate while remaining in mesh with the driven gear 3251.

The clip plate 3252 may be fixed at a distal end of the fixing part 17 by the clip 3253. The elastic member 3254 may provide elastic support between the driven gear 3251 and the clip plate 3252.

The sub gear 3255 may be arranged to surround the outer side of the elastic member 3254 and may be disposed on the driven gear 3251. Gear teeth may be formed on the outer circumferential surface of the sub gear 3255 so as to mesh with a portion of the control module 700, which will be described later, and the state of the folding-rotation of the motor housing 3210 with respect to the sub gear 3255 may be transmitted to the control module 700.

The control module 700 may include a first potentiometer 710 that detects rotation of the first drive unit 3220, a second potentiometer 720 that detects rotation of the second drive unit 3240, and a board 730.

The first and second potentiometers 710 and 720 may each be mounted on the board 730. Each of the first and second potentiometers 710 and 720 may be implemented by a variable resistor that converts linear displacement or rotational displacement into a change in electrical resistance. The first and second potentiometers 710 and 720 may be of a contact or non-contact type. In this embodiment, the first and second potentiometers 710 and 720 are described, by way of example, as contact types. In a contact-type potentiometer, a brush moves on a resistive element so that displacement can be measured according to rotation angle or number of rotations.

The first potentiometer 710 may be provided with a first gear 3274 arranged to be rotatable on the board 730, and the first gear 3274 may mesh with gear teeth 3256 of the sub gear 3255. Accordingly, the folding-rotation angle of the motor housing 3210 may be sensed based on the rotation angle of the first gear 3274 relative to the gear teeth 3256 of the sub gear 3255.

The second potentiometer 720 may be provided with a second gear 3275 arranged to be rotatable on the board 730, and the second gear 3275 may mesh with gear teeth formed on a tilting worm wheel 3249. Accordingly, the tilting-rotation angle of the tilting-rotation unit 3230 may be sensed based on the rotation angle of the second gear 3275 relative to rotation of the tilting worm wheel 3249 about the shaft 3243.

The shaft 3243 may be coupled to both the third worm gear 3248 and the tilting worm wheel 3249 so as to be rotatable together. The third worm gear 3248 may mesh with the third reduction gear 3247 and thereby transmit output to the shaft 3243. The third worm gear 3248 and the tilting worm wheel 3249 may be integrally formed. The tilting worm wheel 3249 may be arranged so as to rotate in a limited manner within a predetermined angular range in accordance with rotation of the shaft 3243.

A description will now be given of a control device that controls operation of the frameless mirror assembly according to an embodiment of the present disclosure.

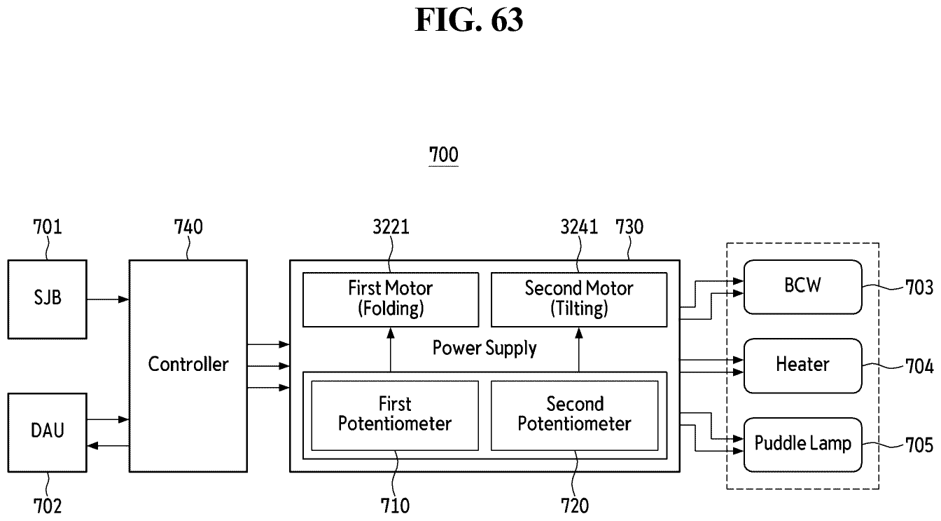

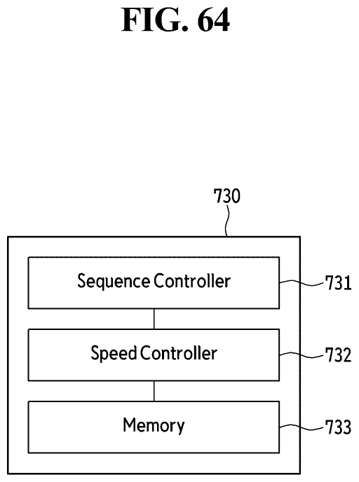

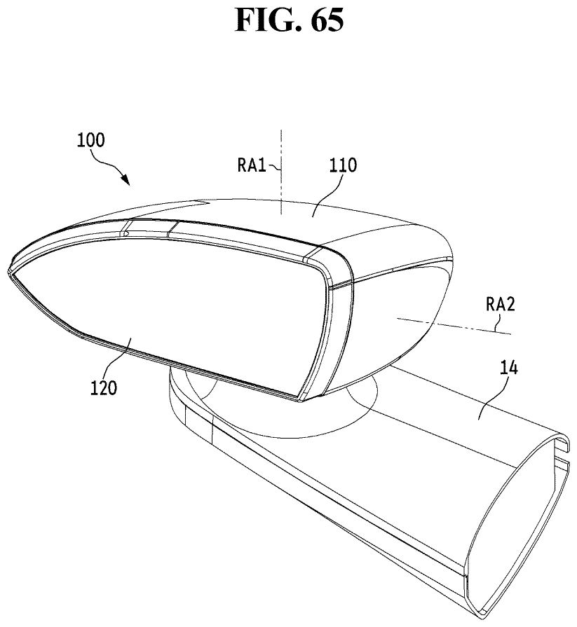

FIG. 63 is a block diagram illustrating a control device for a frameless mirror assembly for a vehicle according to an embodiment of the present disclosure, FIG. 64 is a block diagram illustrating the configuration of a control module of the control device illustrated in FIG. 63, and FIG. 65 is a reference view illustrating a first rotation axis and a second rotation axis of a frameless mirror of FIG. 63.

Referring to FIGS. 63 to 65, a frameless mirror assembly 100 for a vehicle may include a control device for a vehicle side mirror. Here, the control device may correspond to a control module 700 arranged inside a mirror housing 110, and may also be referred to simply as the control module 700.

The control device may include a controller 740 and the control module 700. The controller 740 and the control module 700 may be installed together inside a motor housing 3210 (see FIGS. 59 and 61).

First, the controller 740 may be configured to receive power from a smart junction box (SJB) 701 installed in the vehicle. The SJB 701 may distribute power from the battery of the vehicle to each required component of the vehicle, and may transmit and receive information with the control module 700 and various sensors via controller area network (CAN) communication. The controller 740 may also be configured to receive a user control signal from a door area unit (DAU) 702 via CAN or local interconnect network (LIN) communication.

The control module 700 may include a first potentiometer 710, a second potentiometer 720, and a board 730. The functions and operation of the first and second potentiometers 710 and 720 are as described above, and detailed descriptions thereof will be omitted.

The board 730 may include a sequence controller 731, a speed controller 732, and a memory 733.

The sequence controller 731 and the speed controller 732 may, for example, be implemented as control logic stored in the memory 733 or as printed circuit board (PCB) circuitry. The sequence controller 731 may be configured to determine the drive order of a first drive unit 3220 (or first motor 3221) and a second drive unit 3240 (or second motor 3241) and control the first and second drive units 3220 and 3240 to drive sequentially in the determined drive order.

The speed controller 732 may be configured to use pulse width modulation (PWM) control logic to allow fine adjustment of the rotation angle of the first drive unit 3220 about a first rotation axis RA1 or of the position of the motor housing 210 (see FIG. 11).

The board 730 may selectively supply power to at least one of: a blind-spot collision warning (BCW) unit 703, a heater 704 for a frameless mirror, a puddle light 705, and a turn signal.

The speed controller 732 may also be configured to control the voltages supplied to the first and second drive units 3220 and 3240 according to external temperature. That is, when power is applied to the vehicle, a temperature sensor mounted outside the vehicle may detect the current outside temperature. By comparing the detected temperature with a reference temperature, the voltage supplied to each of the first and second drive units 3220 and 3240 may be adjusted.

For example, when the reference temperature is set to 25° C. and the current ambient temperature deviates from a set range, the speed controller 732 may be configured to supply a high or low voltage depending on whether the ambient temperature is low or high. The memory 733 may store, in a lookup table format, reference temperature data and reference current value data, and the speed controller 732 may be configured to compare the reference temperature with the current temperature and variably supply a voltage based on the result of the comparison to each of the first and second drive units 3220 and 3240.

Hereinafter, sequence control and speed control of the first and second drive units 3220 and 3240 via the control module 700 will be described.

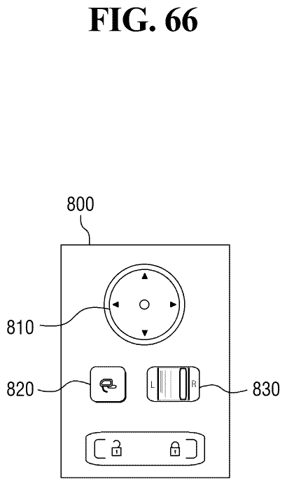

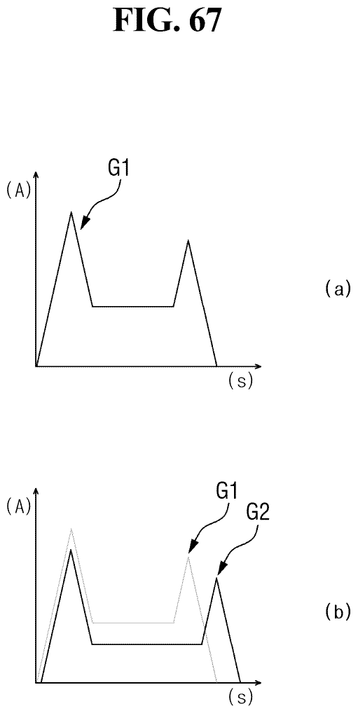

FIG. 66 is a reference view illustrating a frameless mirror switch provided on a driver's side door of a vehicle, and FIG. 67 shows graphs illustrating a difference in rotation time according to folding or fine tilting about the first rotation axis using the control device illustrated in FIG. 63.

FIGS. 66 and 67 schematically illustrate a switch 800 for controlling a frameless mirror (i.e., an outside mirror), provided on the driver-side door of a vehicle. Referring to FIGS. 66 and 67, the switch 800 may include a fine-tilting switch 810, a folding switch 820, and a mirror-selection switch 830.

In a frameless mirror, unlike in a conventional side-mirror structure, the reflection part 120 (see FIG. 3) rotates together with the mirror housing 110 (see FIG. 3) with essentially no relative motions between the reflection part 120 and the mirror housing 110. Therefore, the reflection part 120 and the mirror housing 110 can perform folding or tilting rotation simultaneously.

In this embodiment, control may be performed such that as compared to when rotating from a first position, corresponding to a fully unfolded position, to a second position, corresponding to a fully folded position, via operation of the folding switch 820, the frameless mirror may be configured to rotate more slowly from the first position to a position between the first and second positions for fine tilting (i.e., adjustment) via operation of the fine-tilting switch 810.

Here, “fine tilting” means rotation in the folding or unfolding direction about the first rotation axis RA1 (see FIG. 65), but at a much slower speed than when rotating to the fully folded second position or the fully unfolded first position. To avoid confusion between folding and fine tilting about the first rotation axis RA1 and tilting about the second rotation axis RA2 (see FIG. 65), the rotation axis serving as the center of rotation will be stated together below.

Preferably, folding and fine tilting about the first rotation axis RA1 may be set by default to operate separately from, or sequentially after, tilting about the second rotation axis RA2. This setting may prevent friction or operational interference that may occur if folding and tilting operate simultaneously.

By assigning different speeds for full folding and fine tilting as described above, the speed controller 732 (see FIG. 64) may allow a user (e.g., a driver) to make a finer, more stable and delicate adjustment of the frameless mirror during fine tilting.

In FIG. 67, the speeds of full folding and fine tilting are represented as different applied voltages. Panel (a) of FIG. 67 shows a first graph G1 of voltage versus time during ordinary full folding, and panel (b) of FIG. 67 shows a second graph G2 of voltage versus time for fine tilting. For comparison, the first graph G1 is reproduced in panel (b) of FIG. 67.

The second graph G2 for fine tilting indicates that a relatively lower voltage is supplied and it takes more time to reach the same position (or angle) compared with the first graph G1 for full folding. Since a single first drive unit performs both full folding and fine tilting about the first rotation axis RA1 (see FIG. 65), this approach is advantageous in that it can distinctly identify the difference between the speeds of full folding and fine tilting where such a speed difference is inevitable.

Along with the speed difference between full folding and fine tilting, additional effects can be obtained by varying speed during the process of full folding or full unfolding.

For example, the speed controller 732 (see FIG. 64) may be configured to control the speed of folding rotation to gradually decrease before completion of full folding during folding rotation from the first position to the second position. Similar to a power window that decreases its closing speed to provide a soft close that reduces impact noise and vibration and yields a premium feel, gradually slowing rotation of the frameless mirror before the frameless mirror becomes fully folded can provide a smoother, more refined stop and thereby reduce impact noise and vibration while offering a more premium actuation feel. Likewise, during unfolding, the speed controller may be configured to decrease the unfolding rotation speed before the mirror reaches the fully unfolded first position.

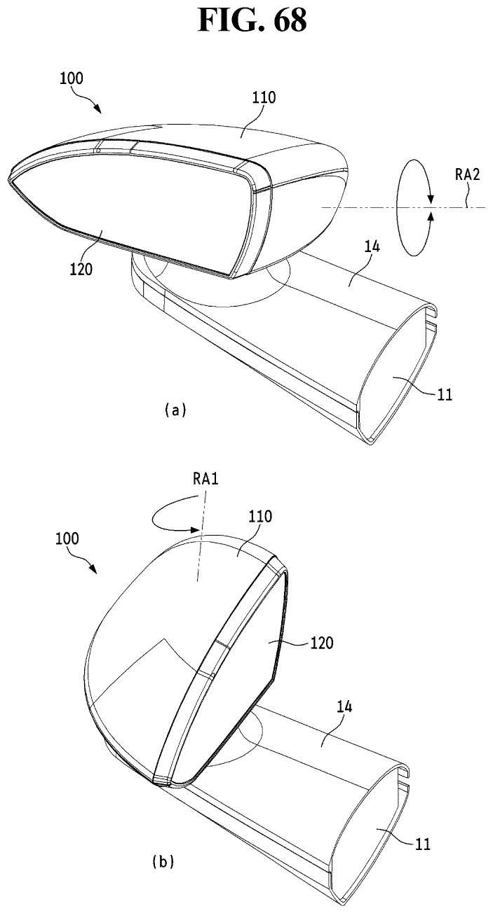

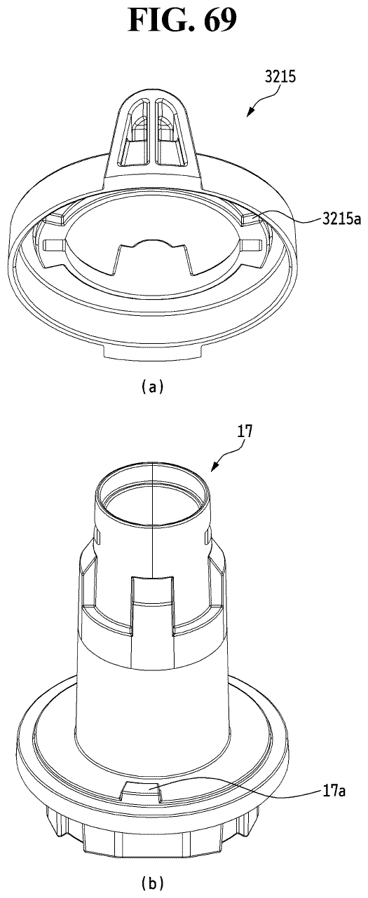

FIG. 68 shows reference views illustrating a state in which the frameless mirror rotates to an unfolded or folded state using the control device of FIG. 63, and FIG. 69 shows reference views illustrating a stopper of FIG. 62 that limits rotation of the frameless mirror in the folding or unfolding direction.

Panel (a) of FIG. 68 illustrates a state in which tilting about the second rotation axis RA2 is performed with the frameless mirror unfolded, and panel (b) of FIG. 68 illustrates a fully folded state of the frameless mirror. The sequence controller 731 (see FIG. 64) may be configured to set the control sequence of the first and second drive units 3220 and 3240, and such settings may be stored in the memory 733 (see FIG. 64).

For example, after the frameless mirror is fully folded from the first position to the second position about the first rotation axis RA1, the sequence controller 731 may be configured to limit or prevent tilting rotation about the second rotation axis RA2. In other words, in the fully folded state of the frameless mirror, the frameless mirror may preferably maintain a constant direction and angle. The angle to which the frameless mirror faces in its fully folded state may be adjusted within a set range. The first and second positions may also be customized, and once settings are completed, the settings information may be stored in the memory 733 (see FIG. 64).

In addition, the sequence controller 731 may be configured to control the frameless mirror to return from the state of being tilted about the second rotation axis RA2 before fold-rotating to the fully folded second position. That is, the sequence controller 731 may allow tilting or fine tilting in the unfolded state, limits tilting or fine tilting in the folded state, and also limits full folding in the state where the frameless mirror is excessively tilted from the fully unfolded state.

The memory 733 (see FIG. 64) may store the rotational position of the frameless mirror based on information provided by the first potentiometer 710 and/or the second potentiometer 720.

For example, the support member 3215 may be arranged to be rotatable relative to the fixing part 17, and a stopper provided between the lower side of the support member 3215 and the fixing part 17 may limit rotation in the folding and unfolding directions about the first rotation axis RA1. The stopper may include first stepped portions 17a formed at equal intervals on the outer circumferential surface of the fixing part 17, and second stepped portions 3215a provided on the lower side of the support member 3215 so as to respectively interfere with the first stepped portions 17a during folding or unfolding rotation.

The memory 733 may store scan information corresponding to the time during which the frameless mirror rotates or the change in voltage during rotation, after the frameless mirror rotates to its maximum in either the folding or unfolding direction so that the first stepped portions 17a contact the second stepped portions 3215a on one side thereof, and then rotates to its maximum in the opposite direction so that the first stepped portions 17a contact the second stepped portions 3215a on the other side thereof. Accordingly, the memory unit 733 may store, based on the scan information, both the first position, which is the unfolding position of the frameless mirror, and the second position, which is the position of the frameless mirror fully folded from the first position. The memory unit 733 may also store precise position information for the tilting center of the frameless mirror at the first position, as well as information on user-customized individual tilting angles at the first position.

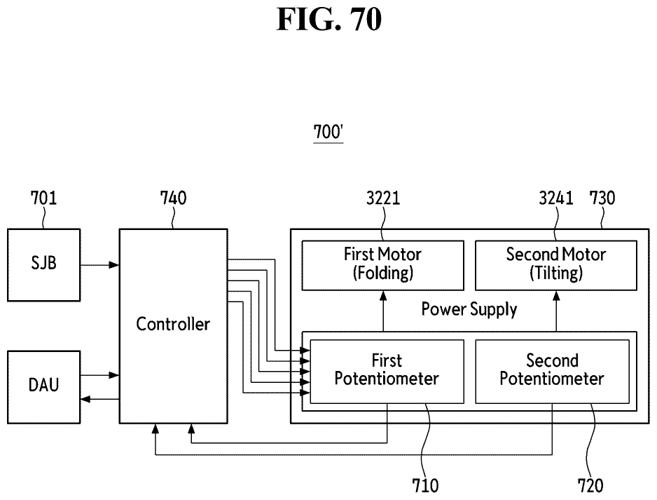

FIG. 70 is a block diagram illustrating a control device for a side mirror assembly for a vehicle according to another embodiment of the present disclosure.

Referring to FIG. 70, the control device according to another embodiment of the present disclosure may include a controller 740′ and a control module 700′. The controller 740′ may be installed on a vehicle, outside a frameless mirror, so that power and control signals may be provided from the vehicle.

The control module 700′ may include a first potentiometer 710, a second potentiometer 720, and a board 730. The first and second potentiometers 710 and 720 may provide measured voltages to the controller 740′ installed in the vehicle.

In this case, the board 730 may be controlled by a control signal provided by the controller 740′ or by another control device (e.g., an electronic control unit (ECU)) of the vehicle and may be used as a dummy board.

According to the aforementioned embodiments of the present disclosure, optimized functions for the frameless mirror can be provided, the number of actuators can be reduced by enabling simultaneous folding and tilting of the mirror housing and the frameless mirror, folding rotation and tilting rotation can be independently performed while controlling the speeds for folding rotation and fine tilting, and a consistent folded appearance can be maintained while allowing customization for folding and tilting.

While specific embodiments have been illustrated and described to exemplify the technical spirit of the present disclosure, the present disclosure is not limited to the above-described specific configurations and operations. Various modifications can be made without departing from the scope of the present disclosure. Accordingly, such modifications should also be regarded as falling within the scope of the present disclosure, which is defined by the claims set forth below.

What is claimed is:

1. A side mirror assembly for a vehicle, comprising:
a reflection member;
a controller configured to receive power and a control signal from the vehicle; and
a control module configured to, in response to the control signal from the controller, drive a first drive unit to fold-rotate the reflection member about a first rotation axis arranged vertically, or to drive a second drive unit to tilt-rotate the reflection member about a second rotation axis arranged horizontally,
wherein the control module includes a first potentiometer that detects rotation of the first drive unit, a second potentiometer that detects rotation of the second drive unit, and a board on which the first potentiometer and the second potentiometer are mounted,
wherein the board supplies, to the first drive unit and the second drive unit, power or a control signal provided by the controller, and
wherein the first potentiometer and the second potentiometer provide measured voltages to the controller.

2. The side mirror assembly of claim 1, wherein the board includes:
a sequence controller configured to determine a drive sequence of the first drive unit and the second drive unit;
a speed controller configured to control a speed of a first motor provided in the first drive unit and a second motor provided in the second drive unit; and
a memory configured to store a rotational position of the reflection member based on information provided by the first potentiometer and/or the second potentiometer.

3. The side mirror assembly of claim 2, wherein the speed controller is configured to rotate the reflection member at a slower speed during fine tilting about the first rotation axis from a first position, which is an unfolded position, to a position between the first position and a second position, which is a folded position, compared with a speed at which the speed controller rotates the reflection member from the first position to the second position.

4. The side mirror assembly of claim 2, wherein the speed controller is configured to control a rotation speed associated with folding or unfolding to gradually decrease before completion of folding rotation from a first position, which is an unfolded position, to a second position, which is a folded position, or before completion of unfolding rotation from the second position to the first position.

5. The side mirror assembly of claim 2, wherein the sequence controller is configured to limit tilting rotation about the second rotation axis in a state that the reflection member is at a folded position.

6. The side mirror assembly of claim 2, wherein the sequence controller is configured to restore the reflection member from a tilted state to a neutral state with respect to the second rotation axis prior to fold-rotating the reflection member about the first rotation axis to a folded position.

7. The side mirror assembly of claim 2, wherein scan information is stored in the memory, wherein the scan information is obtained by fully rotating the reflection member in one direction among a folding direction and an unfolding direction and subsequently fully rotating the reflection member in an opposite direction while recording time required for said rotation or changes in voltage during said rotation of the reflection member, and
wherein, based on the scan information, a first position, which corresponds to a predetermined unfolded position of the reflection member, and a second position, which corresponds to a fully folded position are stored in the memory.

8. The side mirror assembly of claim 2, wherein a reference temperature range and reference electric current value information are stored in the memory, and
wherein, in response to a current temperature deviating from the reference temperature range, the speed controller is configured to variably supply a voltage to the first drive unit or the second drive unit based on a temperature change around the vehicle.

9. The side mirror assembly of claim 1, wherein the board controls to selectively supply power to at least one of a blind-spot collision warning (BCW) lamp, a heater for the reflection member, a puddle light, or a turn signal.

10. A side mirror assembly for a vehicle, comprising:
a base having a first side connected to the vehicle and including a fixing part at a second side thereof with a folding rotation axis provided at a center of the fixing part;
a motor housing including a lower case and an upper case, the motor housing being configured to rotate relative to the fixing part;
a tilting-rotation unit configured to rotate relative to the motor housing about a tilting rotation axis provided at a lower side of the motor housing;
a motor installation unit including, at a first side thereof, a first drive unit that enables a fold-rotation of the motor housing with respect to the fixing part, and at a second side thereof, a second drive unit that enables a tilt-rotation of the tilting-rotation unit with respect to the motor housing;
a control module configured to detect the fold-rotation of the motor housing and/or the tilt-rotation of the tilting-rotation unit and to set respective initial positions for the fold-rotation and/or the tilt-rotation;
a mirror housing including a reflection part, the mirror housing accommodating the motor housing therein; and
a fixing frame coupled to the mirror housing and the tilting-rotation unit.

11. The side mirror assembly of claim 10, wherein the control module includes:
a board detachably mounted to the motor installation unit;
a first potentiometer that is disposed on the board and detects relative rotation of the motor housing with respect to the fixing part during the fold-rotation via the first drive unit; and
a second potentiometer that is disposed on the board and detects relative rotation of the tilting-rotation unit with respect to the motor housing during the tilt-rotation via the second drive unit.

12. The side mirror assembly of claim 11, wherein the motor installation unit includes:
a first stopper that limits, via the first potentiometer, a first reference range for the fold-rotation; and
a second stopper that limits, via the second potentiometer, a second reference range for the tilt-rotation.

13. The side mirror assembly of claim 12, wherein the first potentiometer includes:
a first gear that detects the fold-rotation when the motor housing rotates relative to the fixing part about the folding rotation axis and transmits the fold-rotation to the first potentiometer; and
a first position-setting portion disposed on the first gear and configured to rotate together with the first gear until the first position-setting portion abuts the first stopper.

14. The side mirror assembly of claim 13, wherein the first position-setting portion includes:
a first rotor arranged to be rotatable about a same rotation axis as the first gear;
a first contact portion that protrudes adjacent to a rotation axis of the first rotor and configured to selectively contact the first stopper within the first reference range as the first rotor rotates;
first leg portions that extend along an outer circumferential surface of the first rotor on both sides of a cutout formed in the outer circumferential surface and face toward the cutout; and
first contact pieces that protrude radially outward from distal ends of the first leg portions to contact a tooth pattern formed on an inner circumferential surface of the first gear.

15. The side mirror assembly of claim 14, wherein the first position-setting portion is configured such that the first gear and the first rotor rotate together until the first contact portion abuts the first stopper, and
wherein, in response to the first contact portion abutting the first stopper, rotation of the first rotor is restricted, and only the first gear continues rotating to a set position, thereby allowing to set the first reference range.

16. The side mirror assembly of claim 14, wherein the first stopper includes: a first contact surface configured to be contacted by a first surface of the first contact portion; and a second contact surface configured to be contacted by a second surface of the first contact portion, and
wherein an interior angle between the first contact surface and the second contact surface is an acute angle.

17. The side mirror assembly of claim 13, wherein a sub gear is provided on the fixing part to mesh with the first gear and provide an amount of the fold-rotation while rotating relative thereto, and
wherein chamfers are formed at tips of gear teeth of the sub gear in a direction in which the first gear is engaged.

18. The side mirror assembly of claim 13, wherein the second potentiometer includes:
a second gear that detects the tilt-rotation when the tilting-rotation unit rotates relative to the motor housing about the tilting rotation axis and transmits the tilt-rotation to the second potentiometer; and
a second position-setting portion disposed on the second gear and configured to rotate together with the second gear until the second position-setting portion abuts the second stopper.

19. The side mirror assembly of claim 18, wherein the second stopper includes:
a projection member that protrudes toward a second contact portion along a rotation-axis direction of a second rotor arranged to be rotatable about a same axis as the second gear, the projection member guiding an operating position of a second contact piece that protrudes to contact a second internal gear formed on an inner circumferential surface of the second gear; and
a guide member configured to define a second reference range corresponding to a radius of rotation of the second contact portion, as the second contact portion is assembled through the projection member.

20. The side mirror assembly of claim 19, wherein the projection member includes:
a tip portion arranged convexly toward a center of rotation of the second rotor;
a first guide portion configured to guide from the tip portion toward the guide member when the second rotor rotates in a first direction about its central axis; and
a second guide portion configured to guide from the tip portion toward the guide member when the second rotor rotates in a second direction.
